(19) United States
(12) Patent Application Publication
(10) Pub. No.: US 2023/0311130 A1
(43) Pub. Date: Oct. 5, 2023

(54) STREAMLINED ASSAY PREPARATION

(71) Applicant: Lucira Health, Inc., Emeryville, CA (US)

(72) Inventors: Clay Reber, Oakland, CA (US); Kelly Lewis Brezoczky, Los Gatos, CA (US); Thomas Brezoczky, Los Gatos, CA (US); Frank B. Myers, III, Richmond, CA (US); Debkishore Mitra, Fremont, CA (US); Tark Abed, Emeryville, CA (US); Alexander N. Dzigurski, Emeryville, CA (US); Bron Davis, Emeryville, CA (US)

(21) Appl. No.: 18/024,245

(22) PCT Filed: Sep. 4, 2021
(86) PCT No.: PCT/US2021/049178

§ 371 Date: Mar. 1, 2023

Related U.S. Application Data
(60) Provisional application No. 63/075,086, filed on Sep. 4, 2020.

(51) Int. Cl. B01L 7/00; B01L 3/00

(52) U.S. Cl. CPC B01L 7/52; B01L 3/5029; B01L 2200/025; B01L 2200/0621; B01L 2300/0672; B01L 2300/0832; B01L 2300/087

(57) ABSTRACT

The present disclosure provides assay and method for using assay for streamlined assay preparation and testing. These assay are useful for pathogen (e.g., viral or bacterial) detection. The present disclosure also provides assay assemblies and means to prevent or minimize the formation of bubbles when using puncturing elements in fluidic devices or chambers.

### CROSS-REFERENCE TO RELATED APPLICATIONS

This application claims priority to and the benefit of U.S. Provisional Patent Application No. 63/075,086, filed on Sep. 4, 2020, the entire contents of which are incorporated by reference herein for all purposes.

### STATEMENT REGARDING FEDERALLY SPONSORED RESEARCH OR DEVELOPMENT

This invention was made with government support under Contract No. HHSO100201800017C awarded by the Biomedical Advanced Research and Development Authority (BARDA). The government has certain rights in the invention.

### BACKGROUND

Typically, the detection of pathogenic microorganisms and viral infections in individuals is a multi-step process that is lengthy, cumbersome, and requires skilled technicians. The conventional methods for detection and identification of pathogenic microorganisms face key challenges that span high device manufacturing costs, complex manufacturing processes, and lengthy processing times from sample collection to diagnosis, inadequate accessibility to testing, and poor portability. The use of disposable or minimally reusable systems for disease testing is appealing for at-home testing, resource-poor settings or community hospitals without access to a central laboratory, but the auxiliary systems required for read-out are typically expensive and dedicated, which limit their disposability.

Conventional detection and identification of pathogenic microorganisms typically includes collecting the sample (also referred to as “specimen”), which often requires a skilled clinician (or technician), transporting the sample to a suitable laboratory facility or other testing site, such as national, regional, or state testing laboratories, and then testing the sample for the pathogenic microorganism of interest or a marker thereof. Inherent in this identification and detection process is the need to transport the specimen(s) back to a laboratory, thereby adding time and risk to the entire process. Transportation to a suitable diagnostic laboratory carries the risk of contamination, accidental exposure of the specimen or of the people handling the specimen during transport, and damage to the specimen (e.g., due to environmental changes) that renders it untestable or compromise the test integrity. These conventional testing methods often involve significant time delay between sampling and receipt of the test results, which is especially problematic when rapid diagnosis and/or large-scale testing is imperative (e.g., highly contagious diseases). In certain instances, the time delay is compounded with inconclusive test results, requiring even more time to retest and obtain a diagnosis. It makes repeated testing difficult. In certain instances, due to the lengthy, multi-step process that these convention testing methods utilize, non-receipt of test results by the patient is a recurring problem.

Thus, there is a clear need in the art for more streamlined, simple-to-use, viral detection/testing tools and products. These tools and products should be easily accessible to and useable by lay-persons so that rapid diagnosis and treatment is made available to a larger proportion of the population.

In the development of fluidic chambers for biological and chemical assay systems, and particularly for systems including fluidic chambers having nano- or micro-liter volumes, a key challenge is keeping manufacturing costs low while configuring the systems to prevent formation of air bubbles within channels. The formation of air bubbles in low-cost fluidic devices is a recurring problem in the design of widely-accessible fluidic testing devices. Furthermore, conventional, low-cost manufacturing techniques restrict the ability to shape the geometry of fluidic chambers to prevent formation of air bubbles during filling of the fluidic chambers with a liquid. The presence of air bubbles in the channels of these devices can interfere with analysis of assay products and compromise the test integrity

Common contributors to bubble formation in these fluidic devices include, but are not limited to, changes in temperature, channel geometry, hydrophobic properties of components, flow-focusing, and configurations of connectors, adaptors, and valves. All of these factors play a significant role in bubble formation and accumulation and make it challenging to address in a cost-effective manner. Various bubble trapping and bubble minimization systems have been designed and investigated in the art. However, the fabrication process for such systems remains relatively complex and, in many cases, the design geometry presents constraints that are not easily adaptable to all types of fluidic (especially microfluidic) applications.

### SUMMARY

The subject disclosure provides streamlined assay assemblies and methods of use that are useful for rapid detection of pathogenic microorganisms. The assemblies are designed, for example, for portability, single-use, and at-home testing. In various embodiments, reagent loading (insertion, addition, etc.), sample elution, and assay initiation has been condensed to a single step. Further, in various embodiments, the assay assembly comprises a single-use consumable (sample collection tube) and a separate reusable base unit, which allows for simplified and more-cost effective device usage, and maintains separation between the electronic components and liquid sample and amplicon-containing components. Additionally, the inventors of the present disclosure have demonstrated significant improvement in sample elution through the use of rotating sample collectors-in-tube and agitator features on the inner surface of sample collection tubes.

Through the use of various integrated bi-stable locking mechanisms and optional additional features, the assemblies disclosed herein allow for a streamlined sample collection, assay preparation, and assay initiation with multiple steps performed in parallel.

The subject disclosure also provides a sample collector cap, which is a cap comprising a sample collector or which is a cap having a sample collector affixed to the cap. The sample collector cap is applicable to several of the assay assemblies disclosed herein and contributes to the streamlined nature of the assay assembly. Through the use of the sample collector cap, sample elution and assay initiation can be combined for a streamlined detection process. The sample collector cap also minimizes the risk of contamination by reducing the duration of time within which the sample is handled and within which the sample eluate is located within the sample collection tube under non-isolated conditions (e.g., exposure to the external environment of the sample collection tube).

In some embodiments of the present invention, it is also contemplated that the described sample collector can be replaced with a cap that does not have an affixed sample collection portion and handle (sample collection handle). In such embodiments, a sample collection portion and handle (e.g. swab) is used to collect the biological sample and inserted into the sample collection tube for elution prior to close the sample collection tube with the cap.

The subject disclosure also provides assemblies for bubble-free puncturing that utilize, for example, interference fitting components or Luer-like fitting components, a breakable seal separating a puncturing element and a sample collection channel, as well as an orientation of the sample collection tube and puncturing element that enables gravitational fluidic movement.

In one aspect, the present disclosure provides an assay assembly, the assembly comprising:
a. a sample collection tube comprising:
   a first chamber;
   a breakable seal or valve; and
   a test cartridge comprising a sample inlet and one or more reaction chambers;
b. a base unit comprising:
   a heating element; and
   a power supply; and
c. a sample collector comprising:
   a handle comprising a cap that is operatively coupleable with the sample collection tube; and
   a sample collection portion.

In one aspect, the present disclosure provides an assay assembly, the assembly comprising: a sample collection tube comprising: a first chamber; a breakable seal or valve; and a test cartridge comprising a sample inlet and one or more reaction chambers; a base unit comprising: a heating element; and a power supply; and a sample collector comprising: a handle comprising a cap that is operatively coupleable with the sample collection tube; and a sample collection portion.

In some embodiments, the assay assembly further comprises a bi-stable locking mechanism having at least one first state and at least one second state; wherein the first state of the bi-stable locking mechanism comprises the first chamber and the test cartridge coupled in the first stable state, and wherein the at least one second state of the bistable locking mechanism is responsive to the sample collector being operatively coupled with the sample collection tube and wherein the at least one second state of the bistable locking mechanism comprises the first chamber being operatively coupled to the test cartridge in the second stable state; and a fluidic coupling mechanism, wherein responsive to the sample collector operatively coupling the first chamber and the test cartridge in the second stable state, the fluidic coupling mechanism is configured to place the first chamber of the sample collection tube in fluidic communication with the test cartridge.

In some embodiments, the sample collection tube further comprises a sample collection tube holder, wherein the sample collection tube holder is configured to operatively couple the first chamber and the test cartridge in a first stable state and in a second stable state. In some embodiments, the sample collection tube comprises the breakable seal. In some embodiments, the sample collection tube comprises the valve. In some embodiments, the first chamber of the sample collection tube comprises a first sub-container and a second sub-container, wherein the first sub-container and the test cartridge are sealed from one another by a breakable seal, wherein when the sample collector is operatively coupled to the sample collection tube in the second stable state, the sample collection portion of the sample collector is located within the first sub-container and breaks the breakable seal, thereby placing the first sub-container in fluidic communication with the test cartridge of the sample collection tube.

In some embodiments, the first chamber of the sample collection tube comprises a first sub-container and a second sub-container, wherein the first sub-container and the test cartridge are sealed from one another by a breakable seal, wherein the test cartridge comprises a puncturing element, wherein when the sample collector is operatively coupled to the sample collection tube in the second stable state, the puncturing element breaks the breakable seal thereby placing the first sub-container in fluidic communication with the test cartridge of the sample collection tube.

In some embodiments, the cap of the sample collector is a snap-on cap that is operatively coupleable with the sample collection tube, the fluidic coupling mechanism comprises (i) a breakable seal of the sample collection tube and a puncturing element of the test cartridge or (ii) an actuable valve of the sample collection tube, the at least one first state of the bistable locking mechanism comprises the snap-on cap not being operatively coupled to the sample collection tube, the at least one second state of the bistable locking mechanism comprises the snap-on cap being operatively coupled to the sample collection tube, the coupling of the sample collection tube and the test cartridge in the first stable state comprises: (i) the puncturing element of the test cartridge not breaking the breakable seal of the sample collection tube or (ii) not actuating the actuable valve, and the operative coupling of the sample collection tube and the test cartridge in the second stable state comprises: (i) the puncturing element of the test cartridge breaking the breakable seal of the sample collection tube or (ii) actuating the actuable valve, thereby placing the first chamber of the sample collection tube in fluidic communication with the test cartridge.

In some embodiments, the test cartridge comprises a twist feature, the fluidic coupling mechanism comprises: (i) a breakable seal of the first chamber and a puncturing element of the test cartridge or (ii) an actuable valve of the first chamber, the at least one first state of the bistable locking mechanism comprises the twist feature not being twisted, the at least one second state of the bistable locking mechanism comprises the twist feature being twisted, the operative coupling of the first chamber or the first sub-container and the test cartridge in the first stable state comprises: (i) the puncturing element of the test cartridge not breaking the breakable seal of first chamber or (ii) not actuating the actuable valve, and the operative coupling of the first chamber or the first sub-container and the test cartridge in the second stable state comprises: (i) the puncturing element of the test cartridge breaking the breakable seal of the first chamber or (ii) actuating the actuable valve, thereby placing the first chamber of the sample collection tube in fluidic communication with the test cartridge.

In some embodiments, the cap of the sample collector is a twist-on cap that is operatively coupleable with the sample collection tube, the fluidic coupling mechanism comprises: (i) a breakable seal of the first chamber or the first sub-container and a puncturing element of the test cartridge or (ii) an actuable valve, the at least one first state of the bistable locking mechanism comprises the twist-on cap not being operatively coupled to the sample collection tube, the at least one second state of the bistable locking mechanism comprises the twist-on cap being operatively coupled to the first chamber or the first sub-container, the operative coupling of the first chamber or the first sub-container and the test cartridge in the first stable state comprises: (i) the puncturing element of the test cartridge not breaking the breakable seal of the first chamber or the first sub-container or (ii) not actuating the actuable valve, and the operative coupling of the first chamber or the first sub-container and the test cartridge in the second stable state comprises: (i) the puncturing element of the test cartridge breaking the breakable seal of the first chamber or the first sub-container or (ii) actuating the actuable valve, thereby placing the first chamber of the sample collection tube in fluidic communication with the test cartridge.

In some embodiments, responsive to the bistable locking mechanism being in the at least one second state such that the twist-on cap is operatively coupled to the sample collection tube, the twist-on cap seals the sample collection tube. In some embodiments, responsive to the bistable locking mechanism being in the at least one second state such that the twist-on cap is operatively coupled to the sample collection tube and the sample collection portion of the sample collector is located within the first chamber of the sample collection tube, the sample collection portion of the sample collector breaks the breakable seal of the sample collection tube, thereby placing the first chamber of the sample collection tube in fluidic communication with the test cartridge.

In some embodiments, the bi-stable locking mechanism comprises a key feature of the first chamber or the first sub-container and a threaded feature of the test cartridge, the key feature and the threaded feature operatively couplable with one another, the fluidic coupling mechanism comprises: (i) a breakable seal of the first chamber or the first sub-container and a puncturing element of the test cartridge or (ii) an actuable valve, the at least one first state comprises the key feature of the first chamber or the first sub-container not being operatively coupled to the threaded feature of the test cartridge, the at least one second state comprises the key feature of the first chamber or the first sub-container being operatively coupled to the threaded feature of the test cartridge, the operative coupling of the sample collection tube and the test cartridge in the first stable state comprises: (i) the puncturing element of the test cartridge not breaking the breakable seal of the first chamber or the first sub-container or (ii) not actuating the actuable valve, and the operative coupling of the sample collection tube and the test cartridge in the second stable state comprises: (i) the puncturing element of the test cartridge breaking the breakable seal of the first chamber or the first sub-container or (ii) actuating the actuable valve, thereby placing the first chamber of the sample collection tube in fluidic communication with the test cartridge.

In another aspect, the present disclosure provides an assay assembly, the assembly comprising:
b. a sample collection tube comprising:
   a first chamber;
   a breakable seal or valve; and
   a test cartridge comprising a sample inlet and one or more reaction chambers;
c. a base unit comprising:
   a heating element; and
   a power supply;
d. a cap; and
e. a bi-stable locking mechanism having at least one first state and at least one second state;
wherein the first state of the bi-stable locking mechanism comprises the first chamber and the test cartridge coupled in the first stable state, and wherein the second state of the bistable locking mechanism is responsive to the cap being operatively coupled with the sample collection tube and wherein the second state of the bistable locking mechanism comprises the first chamber being operatively coupled to the test cartridge in the second stable state; and
b. a fluidic coupling mechanism, wherein responsive to the sample collector operatively coupling the first chamber and the test cartridge in the second stable state, the fluidic coupling mechanism is configured to place the first chamber of the sample collection tube in fluidic communication with the test cartridge.

In some embodiments, the bi-stable locking mechanism comprises a twist feature of the first chamber or the first sub-container, the fluidic coupling mechanism comprises (i) a breakable seal of the first chamber or the first sub-container and a puncturing element of the test cartridge or (ii) an actuable valve, the at least one first state comprises the twist feature not being twisted, the at least one second state comprises the twist feature being twisted, the operative coupling of the first chamber or the first sub-container and the test cartridge in the first stable state comprises: (i) the puncturing element of the test cartridge not breaking the breakable seal of the first chamber or the first sub-container or (ii) not actuating the actuable valve, and the operative coupling of the first chamber or the first sub-container and the test cartridge in the second stable state comprises: (i) the puncturing element of the test cartridge breaking the breakable seal of the first chamber or the first sub-container or (ii) actuating the actuable valve, thereby placing the first chamber of the sample collection tube in fluidic communication with the test cartridge.

In some embodiments, responsive to the bistable locking mechanism being in the second state, the twist feature of the sample collection tube is capable of being twisted, thereby operatively coupling the sample collection tube and the test cartridge in the second stable state, thereby breaking the breakable seal of the sample collection tube with the puncturing element of the test cartridge, and thereby placing the first chamber of the sample collection tube in fluidic communication with the test cartridge.

In some embodiments, the assay assembly further comprises a sample collector comprising a breakable sample collection portion, and wherein: the sample collection tube and the cap each comprise an opening sized to fit the sample collection portion of the sample collector, wherein in the at least one first state in which the cap is not operatively coupled to the sample collection tube and the at least one second state in which the cap is operatively coupled to the sample collection tube, the opening of the sample collection tube and the opening of the cap are aligned to receive the sample collection portion of the sample collector within the first chamber of the sample collection tube, an interior portion of the cap comprises a blade, and responsive to the at least one second state in which the cap is operatively coupled to the sample collection tube, the blade is configured to dislocate the sample collection portion from the sample collector and into the first chamber of the sample collection tube.

In some embodiments, the first chamber of the sample collection tube comprises an agitator feature. In some embodiments, the first sub-container of the first chamber comprises an agitator feature. In some embodiments, the agitator feature is one or more selected from the following group: ribs, fins, tabs, ridges, wipers, brushes, and beads. In some embodiments, the agitator feature is a rib. In some embodiments, the first chamber of the sample collection tube comprises a plurality of agitator features. In some embodiments, the first sub-container of the first chamber comprises a plurality of agitator features. In some embodiments, the plurality of agitator features is at least 4 agitator features. In some embodiments, the total number of agitator features in the first chamber or the first sub-container is 4. In some embodiments, the total number of agitator features in the first chamber or the first sub-container is between 4 and 8. In some embodiments, the plurality of agitator features is at least 8 agitator features. In some embodiments, the total number of agitator features in the first chamber or the first sub-container is 8. In some embodiments, the mixing efficiency increases with the number of agitator features in the first chamber or the first sub-container. In some embodiments, the mixing efficiency increases with the number of agitator features in the first chamber or in the first sub-container. In some embodiments, the mixing efficiency is increased when the total number of agitator features in the first chamber or in the first sub-container is between 1 and 8 relative to a first chamber or first sub-container having no agitator features.

In some embodiments, the sample collection portion of the sample collector is offset from an axis of rotation of the twist-on cap, such that, during rotation of the twist-on cap about the axis of rotation, the sample collection portion rotates off the axis of rotation of the sample handle and maximizes volume contact. In some embodiments, the handle of the sample collector is offset from the center of the twist-on cap, such that the sample collection portion rotates outside of the center axis of the twist-on cap. In some embodiments, the sample collection portion rotates in contact with the inner walls of the first chamber or the first sub-container. In some embodiments, the handle of the sample collector is offset from the center of the twist-on cap, such that the sample collection portion rotates outside of the center axis of the twist-on cap, and wherein the sample collection portion rotates and maintains in contact with at least one of the agitator features of the first chamber or the first sub-container.

In some embodiments, the agitator features form a concave agitator tube.

In some embodiments, the base unit further comprises one or more selected from the following: a camera, a printed circuit board, an electronic display, one or more sensors, one or more light pipes, a light source, and a control unit.

In some embodiments, the base unit comprises a base unit engagement holder, wherein the base unit engagement holder is configured to operatively couple the sample collection tube and base unit in a third stable state. In some embodiments, the operative coupling of the sample collection tube and the base unit in the third stable state is reversible.

In some embodiments, an exterior surface of the sample collection tube comprises alignment features, the base unit engagement holder comprises a shelf having gaps configured to align with and sized to fit the alignment features of the sample collection tube, and responsive to the alignment features of the sample collection tube aligning with the gaps in the shelf of the base unit engagement holder, the base unit engagement holder operatively couples the sample collection tube and the base unit in the third stable state.

In some embodiments, the exterior surface of the sample collection tube comprises notches, and the base unit engagement holder comprises hooks positioned, optionally below a shelf having gaps in the base unit engagement holder, wherein the hooks are configured to interlock with the notches of the sample collection tube, and responsive to the notches of the sample collection tube aligning with the hooks of the base unit engagement holder, the base unit engagement holder operatively couples the sample collection tube and the base unit in the third stable state.

In some embodiments, the base unit engagement holder comprises one or more snap features, the exterior surface of the sample collection tube has a mating feature configured to couple with the one or more snap features, and responsive to the snap features of the base unit engagement holder tube aligning with the mating feature of the sample collection tube, the base unit engagement holder operatively couples the sample collection tube and the test cartridge in the third stable state. In some embodiments, the one or more snap features is one or more cantilever snap features. In some embodiments, the one or more snap features is one or more annular snap features. In some embodiments, the one or more snap features is one or more torsion snap features.

In some embodiments, the base unit engagement holder comprises a detent configured to operatively couple the sample collection tube and the base unit engagement holder in the third stable state.

In some embodiments, an exterior surface of the sample collection tube comprises an alignment feature, the base unit engagement holder comprises a shelf configured to align with and sized to fit the alignment features of the sample collection tube and allow sliding of the alignment feature of the sample collection tube under the shelf of the base unit engagement holder, the base unit engagement holder or the exterior surface of the sample collection tube has a sliding lock, and responsive to the alignment feature of the sample collection tube sliding under the shelf of the base unit engagement holder, the base unit engagement holder operatively couples the sample collection tube and the base unit in the third stable state.

In some embodiments, the base unit engagement holder comprises a push lock, the exterior surface of the sample collection tube comprises a mating feature configured to align with and sized to engage with the push lock, and responsive to the mating feature of the sample collection tube sliding operatively connecting to the push lock of the base unit engagement holder, the base unit engagement holder operatively couples the sample collection tube and the base unit in the third stable state.

In another aspect, the present disclosure provides an assay assembly, the assembly comprising:
a. a sample collection tube comprising a first chamber;
b. a test cartridge comprising:
   a sample inlet,
   one or more reaction chambers, and
   a sample collection tube holder, wherein the sample collection tube holder is configured to operatively couple the sample collection tube and the test cartridge in a first stable state and in a second stable state;
c. a bi-stable locking mechanism having at least one first state and at least one second state,
   wherein the first state of the bi-stable locking mechanism comprises the sample collection tube holder operatively coupling the sample collection tube and the test cartridge in the first stable state, and the second state of the bistable locking mechanism comprises the sample collection tube holder operatively coupling the sample collection tube and the test cartridge in the second stable state; and
d. a fluidic coupling mechanism, wherein responsive to the sample collection tube holder operatively coupling the sample collection tube and the test cartridge in the second stable state, the fluidic coupling mechanism is configured to place the first chamber of the sample collection tube in fluidic communication with the sample inlet of the test cartridge.

In some embodiments, the bi-stable locking mechanism comprises a snap-on cap that is operatively coupleable with the sample collection tube, the fluidic coupling mechanism comprises (i) a breakable seal of the sample collection tube and a puncturing element of the test cartridge or (ii) an actuable valve of the sample collection tube, the at least one first state of the snap-on cap comprises the snap-on cap not being operatively coupled to the sample collection tube, the at least one second state of the snap-on cap comprises the snap-on cap being operatively coupled to the sample collection tube, the operative coupling of the sample collection tube and the test cartridge in the first stable state comprises: (i) the puncturing element of the test cartridge not breaking the breakable seal of the sample collection tube or (ii) not actuating the actuable valve, and the operative coupling of the sample collection tube and the test cartridge in the second stable state comprises: (i) the puncturing element of the test cartridge breaking the breakable seal of the sample collection tube or (ii) actuating the actuable valve, thereby placing the first chamber of the sample collection tube in fluidic communication with the sample inlet of the test cartridge.

In some embodiments, the bi-stable locking mechanism comprises a twist feature of the test cartridge, the fluidic coupling mechanism comprises: (i) a breakable seal of the sample collection tube and a puncturing element of the test cartridge or (ii) an actuable valve of the sample collection tube, the at least one first state of the twist feature comprises the twist feature not being twisted, the at least one second state of the twist feature comprises the twist feature being twisted, the operative coupling of the sample collection tube and the test cartridge in the first stable state comprises: (i) the puncturing element of the test cartridge not breaking the breakable seal of the sample collection tube or (ii) not actuating the actuable valve, and the operative coupling of the sample collection tube and the test cartridge in the second stable state comprises: (i) the puncturing element of the test cartridge breaking the breakable seal of the sample collection tube or (ii) actuating the actuable valve, thereby placing the first chamber of the sample collection tube in fluidic communication with the sample inlet of the test cartridge.

In some embodiments, the bi-stable locking mechanism comprises a twist-on cap that is operatively coupleable with the sample collection tube, the fluidic coupling mechanism comprises: (i) a breakable seal of the sample collection tube and a puncturing element of the test cartridge or (ii) an actuable valve, the at least one first state of the twist-on cap comprises the twist-on cap not being operatively coupled to the sample collection tube, the at least one second state of the twist-on cap comprises the twist-on cap being operatively coupled to the sample collection tube, the operative coupling of the sample collection tube and the test cartridge in the first stable state comprises: (i) the puncturing element of the test cartridge not breaking the breakable seal of the sample collection tube or (ii) not actuating the actuable valve, and the operative coupling of the sample collection tube and the test cartridge in the second stable state comprises: (i) the puncturing element of the test cartridge breaking the breakable seal of the sample collection tube or (ii) actuating the actuable valve, thereby placing the first chamber of the sample collection tube in fluidic communication with the sample inlet of the test cartridge.

In some embodiments, the twist-on cap comprises a handle of a sample collector, the sample collector comprises the handle and a sample collection portion, and responsive to the twist-on cap being in the at least one second state such that the twist-on cap is operatively coupled to the sample collection tube, the sample collection portion of the sample collector is located within the first chamber of the sample collection tube.

In some embodiments, the twist-on cap includes a first attachment element and the sample collection tube includes a second attachment element that is operatively coupleable with the first attachment element. In some embodiments, the first attachment element comprises threading and the second attachment element comprises reciprocating threading configured to slidably receive the threading. In some embodiments, the reciprocating threading of the sample collection tube is configured to slidably receive ½ to 10 complete rotations of the threading of the twist-on cap. In some embodiments, the reciprocating threading of the sample collection tube is configured to slidably receive at least 3 complete rotations of the threading of the twist-on cap to reach the at least one second state such that the twist-on cap is operatively coupled to the sample collection tube. In some embodiments, the reciprocating threading of the sample collection tube is configured to slidably receive at least 5 complete rotations of the threading of the twist-on cap to reach the at least one second state such that the twist-on cap is operatively coupled to the sample collection tube. In some embodiments, the reciprocating threading of the sample collection tube is configured to slidably receive 3 to 5 complete rotations of the threading of the twist-on cap to reach the at least one second state such that the twist-on cap is operatively coupled to the sample collection tube. In some embodiments, the number of complete rotations of the threading of the twist-on cap increases the elution efficiency relative to an sample collection tube configured to receive fewer complete rotations to reach the at least one second state.

In some embodiments, responsive to the twist-on cap being in the at least one second state such that the twist-on cap is operatively coupled to the sample collection tube, the twist-on cap seals the sample collection tube.

In some embodiments, responsive to the twist-on cap being in the at least one second state such that the twist-on cap is operatively coupled to the sample collection tube and the sample collection portion of the sample collector is located within the first chamber of the sample collection tube, the sample collection portion of the sample collector breaks the breakable seal of the sample collection tube, thereby placing the first chamber of the sample collection tube in fluidic communication with the sample inlet of the test cartridge.

In some embodiments, the breakable seal is proximal to an outlet of the sample collection tube such that, responsive to the sample collection portion of the sample collector breaking the breakable seal, the sample collection portion is proximal to the outlet of the sample collection tube, thereby maximizing sample content from the sample collection portion proximal to the outlet of the sample collection tube.

In some embodiments, the first chamber of the sample collection tube comprises a first sub-container and a second sub-container, the first sub-container and the second sub-container sealed from one another by a second breakable seal on the first sub-container, and wherein responsive to the twist-on cap being in the at least one second state such that the twist-on cap is operatively coupled to the sample collection tube and the sample collection portion of the sample collector is located within the first chamber of the sample collection tube, the sample collection portion of the sample collector breaks the second breakable seal of the sample collection tube, thereby placing the first sub-container of the sample collection tube in fluidic communication with the second sub-container of the sample collection tube.

In some embodiments, the sample collection portion of the sample collector is offset from an axis of rotation of the twist-on cap, such that, during rotation of the twist-on cap about the axis of rotation, the sample collection portion rotates off the axis of rotation of the sample handle and maximizes volume contact.

In some embodiments, the first chamber of the sample collection tube contains agitator features. In some embodiments, the agitator features are any one or more of: ribs, fins, tabs, ridges, wipers, brushes, and beads.

In some embodiments, the bi-stable locking mechanism comprises a key feature of the sample collection tube and a threaded feature of the test cartridge, the key feature and the threaded feature operatively couplable with one another, the fluidic coupling mechanism comprises: (i) a breakable seal of the sample collection tube and a puncturing element of the test cartridge or (ii) an actuable valve, the at least one first state comprises the key feature of the sample collection tube not being operatively coupled to the threaded feature of the test cartridge, the at least one second state comprises the key feature of the sample collection tube being operatively coupled to the threaded feature of the test cartridge, the operative coupling of the sample collection tube and the test cartridge in the first stable state comprises: (i) the puncturing element of the test cartridge not breaking the breakable seal of the sample collection tube or (ii) not actuating the actuable valve, and the operative coupling of the sample collection tube and the test cartridge in the second stable state comprises: (i) the puncturing element of the test cartridge breaking the breakable seal of the sample collection tube or (ii) actuating the actuable valve, thereby placing the first chamber of the sample collection tube in fluidic communication with the sample inlet of the test cartridge.

In some embodiments, the sample collection tube is configured to be inverted for operative coupling to the test cartridge, such that the cap operatively coupled to the sample collection tube and forming the key feature operatively couples to the test cartridge. In some embodiments, the cap at least in part comprises the breakable seal.

In some embodiments, an end of the sample collection tube opposite the cap operatively coupled to the sample collection tube comprises a knob configured to enable twisting of the sample collection tube operatively coupled to the test cartridge.

In some embodiments, the bi-stable locking mechanism comprises a twist feature of the sample collection tube, the fluidic coupling mechanism comprises a breakable seal of the sample collection tube and a puncturing element of the test cartridge, the at least one first state of the twist feature comprises the twist feature not being twisted, the at least one second state of the twist feature comprises the twist feature being twisted, the operative coupling of the sample collection tube and the test cartridge in the first stable state comprises the puncturing element of the test cartridge not breaking the breakable seal of the sample collection tube, and the operative coupling of the sample collection tube and the test cartridge in the second stable state comprises the puncturing element of the test cartridge breaking the breakable seal of the sample collection tube, thereby placing the first chamber of the sample collection tube in fluidic communication with the sample inlet of the test cartridge.

In some embodiments, the bi-stable locking mechanism further comprises a cap that is operatively coupleable with the sample collection tube, the at least one first state of the cap comprises the cap not being operatively coupled to the sample collection tube, and the at least one second state of the cap comprises the cap being operatively coupled to the sample collection tube.

In some embodiments, responsive to the cap being in the at least one second state such that the cap is operatively coupled to the sample collection tube, the twist feature of the sample collection tube is capable of being twisted, thereby placing the twist feature in the at least one second state, thereby operatively coupling the sample collection tube and the test cartridge in the second stable state, thereby breaking the breakable seal of the sample collection tube with the puncturing element of the test cartridge, and thereby placing the first chamber of the sample collection tube in fluidic communication with the sample inlet of the test cartridge.

In some embodiments, the cap comprises a lockout release mechanism (for example, a lockout release arm, hinge, etc.) configured to prevent the cap from transitioning from the at least one second state in which the cap is operatively coupled to the sample collection tube (or test cartridge) to the at least one first state in which the cap is not operatively coupled to the sample collection tube (or test cartridge). For example, in certain embodiments, the lockout release mechanism is a ratchet-like lever affixed to that cap such that the cap can move in one direction (e.g., unrestricted one-way movement) to allow coupling of the cap to the sample collection tube, but prevents movement in the opposite direction once the cap is coupled (e.g., twisted on, snap shut, slid-on) to the sample collection tube or test cartridge. In certain embodiments, the lockout mechanism utilizes a snap-fit mechanism (e.g., a cantilever snap feature (e.g., permanent cantilever snap-features) affixed to the cap and/or the sample collection tube where it engages with the cap). In some embodiments, responsive to the cap being in the at least one second state such that the cap is operatively coupled to the sample collection tube, the cap seals the sample collection tube.

In some embodiments, the cap comprises a lockout release arm configured to prevent the cap from transitioning from the at least one second state in which the cap is operatively coupled to the sample collection tube to the at least one first state in which the cap is not operatively coupled to the sample collection tube.

In some embodiments, in the at least one second state, the cap is operatively coupled to the sample collection tube, and the cap seals the sample collection tube.

In some embodiments, the assay assembly further comprises a sample collector comprising at least a breakable sample collection portion, and wherein: the sample collection tube and the cap each comprise an opening sized to fit the sample collection portion of the sample collector, responsive to the cap being positioned between the at least one first state in which the cap is not operatively coupled to the sample collection tube and the at least one second state in which the cap is operatively coupled to the sample collection tube, the opening of the sample collection tube and the opening of the cap are aligned to receive the sample collection portion of the sample collector within the first chamber of the sample collection tube, an interior portion of the cap comprises a blade, and responsive to the cap being in the at least one second state in which the cap is operatively coupled to the sample collection tube, the blade is configured to dislocate the sample collection portion from the sample collector and into the first chamber of the sample collection tube.

In some embodiments, the first chamber of the sample collection tube comprises a flared volume. In some embodiments, the assay assembly further comprises a cap that is operatively coupleable with the sample collection tube, and wherein: the cap comprises a portion of a sample collector, the sample collector comprises a handle and a sample collection portion, and responsive to the cap being operatively coupled to the sample collection tube, the sample collection portion of the sample collector is located within the first chamber of the sample collection tube. In some embodiments, the portion of the sample collector comprising the cap is one of the handle of the sample collector and a flange of the sample collector.

In some embodiments, responsive to the cap being operatively coupled to the sample collection tube, the cap seals the sample collection tube. In some embodiments, the sample collector is flexible such that the sample collector can bend within the flared volume of the first chamber.

In some embodiments, the assay assembly further comprises a housing having a flared volume, and wherein the housing comprises a space sized to receive the sample collection tube. In some embodiments, the housing further comprises one or more spaces sized to receive one or more power sources.

In some embodiments, the sample collection tube further comprises: an outlet port, the outlet port sealed from the first chamber by the breakable seal, the test cartridge further comprises a fluid transfer mechanism comprising: an interface, wherein the outlet port of the sample collection tube is configured to receive the interface of the fluid transfer mechanism; and a channel formed in the interface, the channel comprising a first end and a second end, the channel having a length and at least one diameter, the first end comprising an inlet, and the second end comprising an outlet in fluidic communication with the second chamber of the test cartridge, the puncturing element comprises a hollow cylinder having an inner diameter, an outer diameter, and a length, a first segment of the puncturing element includes a first portion of the length of the hollow cylinder, a second segment of the puncturing element includes a second portion of the length of the hollow cylinder, the outer diameter of the hollow cylinder is equivalent to the at least one diameter of the channel in the interface, the first segment of the puncturing element is embedded within at least a portion of the length of the channel, thereby forming a single effective diameter of the channel along the length of the channel, the single effective diameter equivalent to the inner diameter of the hollow cylinder of the puncturing element, the second segment of the puncturing element extends beyond the inlet of the channel, and operatively coupling the sample collection tube and the test cartridge in the second stable state comprises the outlet port receiving the interface of the fluid transfer mechanism such that at least one portion of the interface has a diameter that is equivalent to a diameter of at least one portion of the outlet port and such that the at least one portion of the interface is located within the at least one portion of the outlet port, thereby fluidically sealing the outlet port with the interface and breaking the breakable seal of the sample collection tube with the second segment of the puncturing element, thereby placing the first chamber of the sample collection tube in fluidic communication with the channel of the fluid transfer mechanism and thus with the second chamber of the test cartridge.

In some embodiments, the at least one portion of the interface of the fluid transfer mechanism having the diameter that is equivalent to the diameter of the outlet port comprises more than one portion.

In some embodiments, the diameter of the interface of the fluid transfer mechanism increases along the length of the channel from the first end to the second end, and the at least one portion of the interface of the fluid transfer mechanism that has the diameter that is equivalent to the diameter of the outlet port comprises a portion of the interface of the fluid transfer mechanism that is proximal to the second end of the channel.

In some embodiments, at least one of the interface of the fluid transfer mechanism and the outlet port comprises a deformable material. In some embodiments, the at least one portion of the interface having the diameter that is equivalent to the diameter of the outlet port is positioned such that the interface fluidically seals the outlet port prior to the puncturing element breaking the breakable seal of the sample collection tube.

In some embodiments, the least one diameter of the channel formed in the interface comprises more than one diameter, the portion of the length of the channel in which the first segment of the puncturing element is embedded has a first diameter that is equivalent to the outer diameter of the hollow cylinder comprising the puncturing element, and additional portions of the length of the channel have a second diameter that is equivalent to the inner diameter of the hollow cylinder comprising the puncturing element, thereby forming the single effective diameter of the channel along the length of the channel, the single effective diameter equivalent to the inner diameter to the hollow cylinder of the puncturing element.

In some embodiments, the interface comprises a hydrophobic material. In some embodiments, the puncturing element comprises a hydrophilic material. In some embodiments, the outlet port comprises a hydrophobic material. In some embodiments, the breakable seal comprises a hydrophilic material. In some embodiments, the interface comprises a plastic material. In some embodiments, the puncturing element comprises a metallic material. In some embodiments, the outlet port comprises a plastic material. In some embodiments, the breakable seal comprises a metallic material. In some embodiments, the puncturing element comprises a material having a hardness that is at least 2× times the hardness of a material comprising the breakable seal, such that the puncturing element provides for a clear puncture of the breakable seal with repeatable geometry and without deformation of the puncturing element. In some embodiments, the puncturing element has a hardness that is at least about 1×, about 2×, about 3×, about 4×, about 5×, about 6×, about 7×, about 8×, about 9×, about 10×, about 11×, about 12×, about 13×, about 14×, about 15× or about 20× times the hardness of the material comprising the breakable seal.

In some embodiments, an end of the second portion of the puncturing element that is configured to contact the breakable seal comprises a blunt tip, such that a surface area of the end of the second portion is orthogonal to the length of the puncturing element. In some embodiments, an end of the second portion of the puncturing element that is configured to contact the breakable seal comprises a sharp tip. In some embodiments, the inner diameter of the hollow cylinder of the puncturing element is less than a radius of a meniscus of fluid entering the hollow cylinder. In some embodiments, the puncturing element is interference-fit within the at least a portion of the length of the channel formed in the interface.

In some embodiments, a surface area of an end of the second portion of the puncturing element that is configured to contact the breakable seal is less than 25% of the surface area of the breakable seal, thereby limiting a size and/or number of gas bubbles formed during deformation of the breakable seal and/or that can be introduced through the broken seal.

In some embodiments, the sample collection tube is operatively coupled or has been operatively coupled to the test cartridge in the first stable state at the first point in time.

In some embodiments, the assay assembly further comprises a sample collector comprising a handle and a sample collection portion, the sample collection tube configured to receive the sample collection portion of the sample collector.

In some embodiments, the sample collection portion of the sample collector is breakable such that the sample collection portion is configured to dislocate from the sample collector. In some embodiments, the handle of the sample collector is 1″ to 5″ between the cap and the sample collection portion. In some embodiments, the cap comprises a grip handle for a user to handle the sample collector. In some embodiments, the grip handle comprises knurlings and/or one or more finger-grip indentations. In some embodiments, the first and second sub-containers are concentric. In some embodiments, the outer surface of the sample collection tube and/or the test cartridge comprises alignment features to prevent rotation of the sample collection tube and/or test cartridge. In some embodiments, the alignment features are linear alignment features.

In some embodiments, the bi-stable locking mechanism is irreversible such that the bi-stable locking mechanism cannot transition from the at least one second state in which (i) the sample collection tube, the first chamber or the first sub-container and (ii) the test cartridge are operatively coupled in the second stable state to the at least one first state in which the sample collection tube and the test cartridge are operatively coupled in the first stable state.

In some embodiments, the sample collection tube, the first chamber, the first sub-container and/or the test cartridge comprises one more of the following to prevent transition from the at least one second state to the at least one first state: locking detents, cantilever snap features, lock-out release arm, ratchet features, sawtooth ratchets, ratchet and pawl features.

In some embodiments, an exterior surface of the sample collection tube comprises alignment features, the sample collection tube holder comprises a shelf having gaps configured to align with and sized to fit the alignment features of the sample collection tube, and responsive to the sample collection tube holder operatively coupling the sample collection tube and the test cartridge in the first stable state, responsive to the alignment features of the sample collection tube aligning with the gaps in the shelf of the collection tube holder, and responsive to the bi-stable locking mechanism transitioning to the at least one second state, the sample collection tube holder operatively couples the sample collection tube and the test cartridge in the second stable state.

In some embodiments, the exterior surface of the sample collection tube comprises notches, and the sample collection tube holder comprises hooks positioned below the shelf and configured to interlock with the notches of the sample collection tube responsive to the alignment features of the sample collection tube aligning with the gaps in the shelf of the collection tube holder and responsive to the sample collection tube holder operatively coupling the sample collection tube and the test cartridge in the second stable state, such that the sample collection tube is prevented from transitioning from operative coupling with the test cartridge in the second stable state to operative coupling with the test cartridge in the first stable state.

In some embodiments, the shelf of the sample collection tube holder comprises one or more cantilever snap features, responsive to the bi-stable locking mechanism being in the at least one first state, the one or more cantilever snap features are positioned in a first position, thereby causing the sample collection tube holder to operatively couple the sample collection tube and the test cartridge in the first stable state, and responsive to the bi-stable locking mechanism being in the at least one second state, the one or more cantilever snap features are positioned in a second position, the second position proximal to the test cartridge relative to the first position, thereby causing the sample collection tube holder to operatively couple the sample collection tube and the test cartridge in the second stable state.

In some embodiments, the sample collection tube holder comprises one or more cantilever snap features, responsive to the bi-stable locking mechanism being in the at least one first state, the one or more cantilever snap features are positioned above the shelf of the sample collection tube, thereby causing the sample collection tube holder to operatively couple the sample collection tube and the test cartridge in the first stable state, and responsive to the bi-stable locking mechanism being in the at least one second state, the one or more cantilever snap features are positioned below the shelf of the sample collection tube, thereby causing the sample collection tube holder to operatively couple the sample collection tube and the test cartridge in the second stable state.

In some embodiments, the cap comprises a pressurizing component. In some embodiments, the pressurizing component is a rubber sealing element on the surface of the cap proximal to the first chamber. In some embodiments, in the at least one second state, the pressurizing component pressurizes contents of the first chamber. In some embodiments, in the at least one second state, the pressurizing component pressurizes contents of the first sub-container. In some embodiments, in the at least one second state the pressurizing component, displaces air in the first chamber or in the first sub-container. In some embodiments, the volume of air displaced by the pressurizing component when the cap operatively couples with the sample collection tube in the at least one second state is 0.05 mL to 5 mL. In some embodiments, the volume of air displaced by the pressurizing component when the cap operatively couples with the sample collection tube in the at least one second state is the total volume of air in the one or more reaction chambers in the test cartridge.

In some embodiments, the first chamber of the sample collection tube comprises at least a liquid reagent. In some embodiments, the assay assembly weighs less than one pound. In some embodiments, the assay assembly is a hand-held device. In some embodiments, all linear dimensions of the assay assembly are less than 5 inches in length. In some embodiments, the one or more reaction chambers are each microfluidic reaction chambers. In some embodiments, the assay assembly comprises lyophilized reagents and has a shelf life of at least 12 months at room temperature. In some embodiments, the assay assembly comprises batteries and is battery-powered. In some embodiments, the power supply comprises batteries and is battery-powered.

In another aspect, the present disclosure provides an assay assembly, the assembly comprising:
a. a sample collection tube comprising:
   a first chamber; and
   a breakable seal or valve;
b. a test cartridge comprising:
   a sample inlet;
   one or more reaction chambers; and
   a puncturing element,
   wherein the sample collection tube is operatively coupleable with the test cartridge; and
c. a sample collector comprising:
   a handle comprising a cap that is operatively coupleable with the sample collection tube; and
   a sample collection portion,
   wherein responsive to the cap not being operatively coupled to the sample collection tube, the sample collection tube and the test cartridge are operatively coupled in a first stable state such that the puncturing element of the test cartridge does not break the breakable seal of the sample collection tube or such that the valve is not actuated, and wherein responsive to the cap being operatively coupled to the sample collection tube, the sample collection portion of the sample collector is located within the first chamber of the sample collection tube and the sample collection tube and the test cartridge are operatively coupled in a second stable state such that the puncturing element of the test cartridge breaks the breakable seal of the sample collection tube or the valve is actuated, thereby placing the first chamber of the sample collection tube in fluidic communication with the sample inlet of the test cartridge.

In some embodiments, the cap includes a first attachment element and the sample collection tube includes a second attachment element that is operatively coupleable with the first attachment element.

In some embodiments, the cap comprises a twist-on cap and wherein the first attachment element comprises threading and the second attachment element comprises reciprocating threading configured to slidably receive the threading. In some embodiments, the reciprocating threading of the sample collection tube is configured to slidably receive ½-10 complete rotations of the threading of the twist-on cap. In some embodiments, the sample collection portion of the sample collector is offset from an axis of rotation of the twist-on cap, such that, during rotation of the twist-on cap about the axis of rotation, the sample collection portion rotates off the axis of rotation of the sample handle and maximizes volume contact.

In some embodiments, responsive to the cap being operatively coupled to the sample collection tube, the cap seals the sample collection tube.

In some embodiments, the breakable seal is proximal to an outlet of the sample collection tube and wherein responsive to the cap being operatively coupled to the sample collection tube, the sample collection portion of the sample collector is located within the first chamber of the sample collection tube proximal to the breakable seal such that, responsive to the puncturing element of the test cartridge breaking the breakable seal of the sample collection tube, the sample collection portion is proximal to the outlet of the sample collection tube, thereby maximizing sample content from the sample collection portion proximal to the outlet of the sample collection tube.

In some embodiments, the first chamber of the sample collection tube comprises a first sub-container and a second sub-container, the first sub-container and the second sub-container sealed from one another by a second breakable seal, and wherein responsive to the cap being operatively coupled to the sample collection tube and the sample collection portion of the sample collector being located within the first chamber of the sample collection tube, the sample collection portion of the sample collector breaks the second breakable seal of the sample collection tube, thereby placing the first sub-container of the sample collection tube in fluidic communication with the second sub-container of the sample collection tube.

In some embodiments, the first chamber of the sample collection tube contains agitator features.

In some embodiments, the sample collection tube is operative coupled or has been operatively coupled to the test cartridge. In some embodiments, the operative coupling of the cap to the sample collection tube is irreversible such that the cap cannot transition from being operatively coupled to the sample collection tube to not being operatively coupled to the sample collection tube. In some embodiments, the cap comprises one more of the following to prevent transition from the at least one second state to the at least one first state: locking detents, cantilever snap features, a lock-out release arm, ratchet features, sawtooth ratchets, ratchet and pawl features.

In some embodiments, the test cartridge further comprises a sample collection tube holder, the sample collection tube holder is configured to operatively couple the sample collection tube and the test cartridge in the first stable state and in the second stable state, and the sample collection tube holder is operatively coupled with the cap of the sample collector such that responsive to the cap not being operatively coupled to the sample collection tube, the sample collection tube holder operatively couples the sample collection tube and the test cartridge in the first stable state, and responsive to the cap being operatively coupled to the sample collection tube, the sample collection tube holder operatively couples the sample collection tube and the test cartridge in the second stable state.

In some embodiments, an exterior surface of the sample collection tube comprises alignment features, the sample collection tube holder comprises a shelf having gaps configured to align with and sized to fit the alignment features of the sample collection tube, and responsive to the sample collection tube holder operatively coupling the sample collection tube and the test cartridge in the first stable state, responsive to the alignment features of the sample collection tube aligning with the gaps in the shelf of the collection tube holder, and responsive to the cap operatively coupling with the sample collection tube, the sample collection tube holder operatively couples the sample collection tube and the test cartridge in the second stable state.

In some embodiments, the exterior surface of the sample collection tube comprises notches, and the sample collection tube holder comprises hooks positioned below the shelf and configured to interlock with the notches of the sample collection tube responsive to the alignment features of the sample collection tube aligning with the gaps in the shelf of the collection tube holder and responsive to the sample collection tube holder operatively coupling the sample collection tube and the test cartridge in the second stable state, such that the sample collection tube is prevented from transitioning from operative coupling with the test cartridge in the second stable state to operative coupling with the test cartridge in the first stable state.

In some embodiments, the shelf of the sample collection tube holder comprises one or more cantilever snap features, responsive to the cap not being operatively coupled to the sample collection tube, the one or more cantilever snap features are positioned in a first position, thereby causing the sample collection tube holder to operatively couple the sample collection tube and the test cartridge in the first stable state, and responsive to the cap being operatively coupled to the sample collection tube, the one or more cantilever snap features are positioned in a second position, the second position proximal to the test cartridge relative to the first position, thereby causing the sample collection tube holder to operatively couple the sample collection tube and the test cartridge in the second stable state.

In some embodiments, the sample collection tube holder comprises one or more cantilever snap features, responsive to the cap not being operatively coupled to the sample collection tube, the one or more cantilever snap features are positioned above the shelf of the sample collection tube, thereby causing the sample collection tube holder to operatively couple the sample collection tube and the test cartridge in the first stable state, and responsive to the cap being operatively coupled to the sample collection tube, the one or more cantilever snap features are positioned below the shelf of the sample collection tube, thereby causing the sample collection tube holder to operatively couple the sample collection tube and the test cartridge in the second stable state.

In some embodiments:
a. the sample collection tube further comprises:
   an outlet port, the outlet port sealed from the first chamber by the breakable seal,
b. the test cartridge further comprises a fluid transfer mechanism comprising:
   an interface, wherein the outlet port of the sample collection tube is configured to receive the interface of the fluid transfer mechanism; and
   a channel formed in the interface, the channel comprising a first end and a second end, the channel having a length and at least one diameter, the first end comprising an inlet, and the second end comprising an outlet in fluidic communication with the second chamber of the test cartridge,
c. the puncturing element comprises a hollow cylinder having an inner diameter, an outer diameter, and a length,
d. a first segment of the puncturing element includes a first portion of the length of the hollow cylinder,
e. a second segment of the puncturing element includes a second portion of the length of the hollow cylinder,
f. the outer diameter of the hollow cylinder is equivalent to the at least one diameter of the channel in the interface,
g. the first segment of the puncturing element is embedded within at least a portion of the length of the channel, thereby forming a single effective diameter of the channel along the length of the channel, the single effective diameter equivalent to the inner diameter of the hollow cylinder of the puncturing element,
h. the second segment of the puncturing element extends beyond the inlet of the channel, and
i. operatively coupling the sample collection tube and the test cartridge in the second stable state comprises the outlet port receiving the interface of the fluid transfer mechanism such that at least one portion of the interface has a diameter that is equivalent to a diameter of at least one portion of the outlet port and such that the at least one portion of the interface is located within the at least one portion of the outlet port, thereby fluidically sealing the outlet port with the interface and breaking the breakable seal of the sample collection tube with the second segment of the puncturing element, thereby placing the first chamber of the sample collection tube in fluidic communication with the channel of the fluid transfer mechanism and thus with the second chamber of the test cartridge.

In some embodiments, the at least one portion of the interface of the fluid transfer mechanism having the diameter that is equivalent to the diameter of the outlet port comprises more than one portion.

In some embodiments, the diameter of the interface of the fluid transfer mechanism increases along the length of the channel from the first end to the second end, and the at least one portion of the interface of the fluid transfer mechanism that has the diameter that is equivalent to the diameter of the outlet port comprises a portion of the interface of the fluid transfer mechanism that is proximal to the second end of the channel.

In some embodiments, at least one of the interface of the fluid transfer mechanism and the outlet port comprises a deformable material. In some embodiments, the at least one portion of the interface having the diameter that is equivalent to the diameter of the outlet port is positioned such that the interface fluidically seals the outlet port prior to the puncturing element breaking the breakable seal of the sample collection tube.

In some embodiments, the least one diameter of the channel formed in the interface comprises more than one diameter, the portion of the length of the channel in which the first segment of the puncturing element is embedded has a first diameter that is equivalent to the outer diameter of the hollow cylinder comprising the puncturing element, and additional portions of the length of the channel have a second diameter that is equivalent to the inner diameter of the hollow cylinder comprising the puncturing element, thereby forming the single effective diameter of the channel along the length of the channel, the single effective diameter equivalent to the inner diameter to the hollow cylinder of the puncturing element.

In some embodiments, the interface comprises a hydrophobic material. In some embodiments, the puncturing element comprises a hydrophilic material. In some embodiments, the outlet port comprises a hydrophobic material. In some embodiments, the breakable seal comprises a hydrophilic material. In some embodiments, the interface comprises a plastic material. In some embodiments, the puncturing element comprises a metallic material. In some embodiments, the outlet port comprises a plastic material. In some embodiments, the breakable seal comprises a metallic material. In some embodiments, the puncturing element comprises a material having a hardness that is at least 2× times a hardness of a material comprising the breakable seal, such that the puncturing element provides for a clear puncture of the breakable seal with repeatable geometry and without deformation of the puncturing element.

In some embodiments, an end of the second portion of the puncturing element that is configured to contact the breakable seal comprises a blunt tip, such that a surface area of the end of the second portion is orthogonal to the length of the puncturing element. In some embodiments, the inner diameter of the hollow cylinder of the puncturing element is less than a radius of a meniscus of fluid entering the hollow cylinder.

In some embodiments, the puncturing element is interference-fit within the at least a portion of the length of the channel formed in the interface. In some embodiments, a surface area of an end of the second portion of the puncturing element that is configured to contact the breakable seal is less than 25% of the surface area of the breakable seal, thereby limiting a size and/or number of gas bubbles formed during deformation of the breakable seal and/or that can be introduced through the broken seal.

In some embodiments, the first chamber of the sample collection tube comprises at least a liquid reagent. In some embodiments, the assay assembly weighs less than one pound. In some embodiments, the assay assembly weights less than 0.5, 1, 2, 3, 4 or 5 pounds. In some embodiments, all linear dimensions of the assay assembly are less than 5 inches in length. In some embodiments, all linear dimensions of the assay assembly are less than 0.5, 1, 1.5, 2, 2.5, 3, 3.5, 4, 4.5, or 5 inches in length. In some embodiments, the assay assembly comprises lyophilized reagents and has a shelf life of at least 12 months at room temperature or ambient temperature. In some embodiments, the assay assembly comprises lyophilized reagents and has a shelf life of at least 1, 2, 3, 4, 5, 6, 7, 8, 9, 10, 11 or 12 months at room temperature or ambient temperature. In some embodiments, the assay assembly comprises batteries and is battery-powered.

In some embodiments, the test cartridge further comprises a conduit fluidically connecting the sample inlet to one of the one or more reaction chambers. In some embodiments, the test cartridge comprises a plurality of conduits and each of the conduits fluidically connects the sample inlet to one of the one or more reaction chambers. In some embodiments, each of the one or more reaction chambers comprises a selective venting element that allows one or more gases to pass therethrough. In some embodiments, the selective venting elements is configured to proceed, upon contact with a liquid, from a first conformation, in which one or more gases can pass therethrough, to a second conformation that reduces the permeability of fluid therethrough or renders the selective venting element impermeable to fluid, wherein the first conformation allows flow from the sample collection tube to the sample inlet and into the one or more reaction chambers. In some embodiments, the sample collection tube comprises a sealed cavity that is proximal to the test cartridge and into which the one or more gases vent. In some embodiments, responsive to the cap operatively coupling to the sample collection tube in the at least one second state, one or more gases vent out of the one or more reaction chambers into the sealed cavity.

In some embodiments, the assay assembly comprises the first and second sub-containers, and wherein responsive to the cap operatively coupling to the sample collection tube in the at least one second state, one or more gases vent out of the one or more reaction chambers into the second sub-container.

In some embodiments, the cap comprises a pressurizing component, wherein the assay assembly comprises the first and second sub-containers, wherein as the cap operatively couples to the sample collection tube, a portion of the pressurizing component extends into the first sub-container, thereby sealing the first sub-container and leaving the second sub-container exposed to the atmosphere, such that one or more gases vent out of the one or more reaction chambers into the atmosphere via the second sub-container.

In some embodiments, the one or more reaction chambers comprise an optical property modifying reagent or a nucleic acid amplification reagent.

In some embodiments, the cap comprises (i) a reagent and (ii) a second breakable seal or second actuable valve. In some embodiments, operative coupling of the cap with the sample collection tube breaks the second breakable seal or actuates the second actuable valve, thereby flowing the reagent from the cap into the sample collection tube.

In another aspect, the present disclosure provides an assembly comprising:
a. a sample collection tube comprising:
   a main chamber;
   an outlet port; and
   a breakable seal, the breakable seal sealing the main chamber from the outlet port; and
b. a fluid transfer mechanism that is operatively couplable with the sample collection tube, the fluid transfer mechanism comprising:
   an interface, wherein the outlet port of the sample collection tube is configured to receive the interface of the fluid transfer mechanism;
   a channel formed in the interface, the channel comprising a first end and a second end, and having a length and at least one diameter, the first end comprising an inlet; and
   a puncturing element comprising a hollow cylinder having an inner diameter, an outer diameter, and a length, and
wherein a first segment of the puncturing element includes a first portion of the length of the hollow cylinder, a second segment of the puncturing element includes a second portion of the length of the hollow cylinder, and the outer diameter of the hollow cylinder is equivalent to the at least one diameter of the channel in the interface,
wherein the first segment of the puncturing element is embedded within at least a portion of the length of the channel, thereby forming a single effective diameter of the channel along the length of the channel, the single effective diameter equivalent to the inner diameter of the hollow cylinder of the puncturing element,
wherein the second segment of the puncturing element extends beyond the inlet of the channel, and
wherein operatively coupling the sample collection tube and the fluid transfer mechanism comprises the outlet port receiving the interface of the fluid transfer mechanism such that at least one portion of the interface has a diameter that is equivalent to a diameter of at least one portion of the outlet port and such that the at least one portion of the interface is located within the at least one portion of the outlet port, thereby fluidically sealing the outlet port with the interface and puncturing the breakable seal of the sample collection tube with the second segment of the puncturing element of the fluid transfer mechanism, thereby placing the main chamber of the sample collection tube in fluidic communication with the channel of the fluid transfer mechanism.

In some embodiments, the sample collection tube is operatively coupled or has been operatively coupled to the fluid transfer mechanism. In some embodiments, the at least one portion of the interface of the fluid transfer mechanism having the diameter that is equivalent to the diameter of the outlet port comprises more than one portion. In some embodiments, the diameter of the interface of the fluid transfer mechanism increases along the length of the channel from the first end to the second end, and the at least one portion of the interface of the fluid transfer mechanism that has the diameter that is equivalent to the diameter of the outlet port comprises a portion of the interface of the fluid transfer mechanism that is proximal to the second end of the channel. In some embodiments, at least one of the interface of the fluid transfer mechanism and the outlet port comprises a deformable material. In some embodiments, the at least one portion of the interface having the diameter that is equivalent to the diameter of the outlet port is positioned such that the interface fluidically seals the outlet port prior to the puncturing element breaking the breakable seal of the sample collection tube.

In some embodiments, the least one diameter of the channel formed in the interface comprises more than one diameter, the portion of the length of the channel in which the first segment of the puncturing element is embedded has a first diameter that is equivalent to the outer diameter of the hollow cylinder comprising the puncturing element, and additional portions of the length of the channel have a second diameter that is equivalent to the inner diameter of the hollow cylinder comprising the puncturing element, thereby forming the single effective diameter of the channel along the length of the channel, the single effective diameter equivalent to the inner diameter to the hollow cylinder of the puncturing element.

In some embodiments, the interface comprises a hydrophobic material. In some embodiments, the puncturing element comprises a hydrophilic material. In some embodiments, the outlet port comprises a hydrophobic material. In some embodiments, the breakable seal comprises a hydrophilic material. In some embodiments, the interface comprises a plastic material. In some embodiments, the puncturing element comprises a metallic material. In some embodiments, the outlet port comprises a plastic material. In some embodiments, the breakable seal comprises a metallic material.

In some embodiments, the puncturing element comprises a material having a hardness that is at least 2× times a hardness of a material comprising the breakable seal, such that the puncturing element provides for a clear puncture of the breakable seal with repeatable geometry and without deformation of the puncturing element.

In some embodiments, an end of the second portion of the puncturing element that is configured to contact the breakable seal comprises a blunt tip, such that a surface area of the end of the second portion is orthogonal to the length of the puncturing element.

In some embodiments, the inner diameter of the hollow cylinder of the puncturing element is less than a radius of a meniscus of fluid entering the hollow cylinder.

In some embodiments, the puncturing element is interference-fit within the at least a portion of the length of the channel formed in the interface. In some embodiments, a surface area of an end of the second portion of the puncturing element that is configured to contact the breakable seal is less than 25% of the surface area of the breakable seal, thereby limiting a size and/or number of gas bubbles formed during deformation of the breakable seal and/or that can be introduced through the broken seal.

In some embodiments, the sample collection tube contains at least a liquid reagent.

In another aspect, the present disclosure provides a method comprising:
a. obtaining the assay assembly as described herein,
b. operatively coupling the base unit and the sample collection tube;
c. collecting a sample on the sample collection portion;
d. inserting the sample collection portion into the first chamber or first sub-container thereby generating a sample preparation solution;
e. operatively coupling the cap and the sample collection tube and transitioning the bi-stable locking mechanism from the first state to the second state, thereby fluidically connecting the first chamber or first sub-container with the test cartridge and transmitting at least a portion of the sample preparation solution out of the sample receiving module and into one or more reaction chambers of the test cartridge, wherein the chambers comprise an optical property modifying reagent and an amplification composition, and thereby generating a nucleic acid reaction mixture;
f. heating the reaction mixture with the heating element, wherein the heating accelerates a nucleic acid amplification reaction comprising the nucleic acid and the amplification composition, the reaction generating an amplified nucleic acid and a plurality of protons, wherein the reacting sufficiently modifies the nucleic acid reaction mixture to allow detection of the modified optical property; and
g. determining one or more characteristics of the sample based on the modified optical property.

In some embodiments, the base unit comprises the electronic display and the one or more characteristics of the sample are displayed on the electronic display. In some embodiments, the base unit comprises the audio device and after detection of the modified optical property, the audio device emits an alert sound. In some embodiments, determining one or more characteristics of the sample comprises obtaining the result as displayed on the electronic display with a sample analyzer. In some embodiments, the sample analyzer is a mobile device. In some embodiments, the method further comprises reversing the coupling of the base unit and the sample collection tube, thereby separating the base unit and sample collection tube. In some embodiments, the method further comprises disposing of the sample collection tube.

In another aspect, the present disclosure provides a method comprising:
a. obtaining an assay assembly, the assembly comprising:
   a sample collection tube comprising a first chamber;
   a test cartridge comprising:
      1. a sample inlet,
      2. one or more reaction chambers, and
      3. a sample collection tube holder configured to operatively couple the sample collection tube and the test cartridge in a first stable state and a second stable state;
   a fluidic coupling mechanism; and
   a bi-stable locking mechanism, wherein the bi-stable locking mechanism is in at least one first state, thereby causing the sample collection tube holder to operatively couple the sample collection tube and the test cartridge in the first stable state; and
b. transitioning the bi-stable locking mechanism from the at least one first state to at least one second state, thereby causing the sample collection tube holder to operatively couple the sample collection tube and the test cartridge in the second stable state, and thereby causing the fluidic coupling mechanism to place the first chamber of the sample collection tube in fluidic communication with the sample inlet of the test cartridge.

In some embodiments, the assay assembly further comprises a snap-on cap that is operatively coupleable with the sample collection tube, the fluidic coupling mechanism comprises a breakable seal of the sample collection tube and a puncturing element of the test cartridge, the at least one first state of the bi-stable locking mechanism comprises the snap-on cap not being operatively coupled to the sample collection tube, transitioning the bi-stable locking mechanism from the at least one first state to at least one second state comprises operatively coupling the snap-on cap to the sample collection tube, causing the sample collection tube holder to operatively couple the sample collection tube and the test cartridge in the second stable state thereby causing the puncturing element of the test cartridge to break the breakable seal of the sample collection tube, and causing the fluidic coupling mechanism to place the first chamber of the sample collection tube in fluidic communication with the sample inlet of the test cartridge.

In some embodiments, the assay assembly further comprises a twist feature of the test cartridge, the fluidic coupling mechanism comprises a breakable seal of the sample collection tube and a puncturing element of the test cartridge, the at least one first state of the bi-stable locking mechanism comprises the twist feature not being twisted, transitioning the bi-stable locking mechanism from the at least one first state to at least one second state comprising twisting the twist feature, causing the sample collection tube holder to operatively couple the sample collection tube and the test cartridge in the second stable state thereby causing the puncturing element of the test cartridge to break the breakable seal of the sample collection tube, and causing the fluidic coupling mechanism to place the first chamber of the sample collection tube in fluidic communication with the sample inlet of the test cartridge.

In some embodiments, the assay assembly further comprises a twist-on cap that is operatively coupleable with the sample collection tube, the fluidic coupling mechanism comprises a breakable seal of the sample collection tube and a puncturing element of the test cartridge, the at least one first state of the twist-on cap comprises the twist-on cap not being operatively coupled to the sample collection tube, transitioning the bi-stable locking mechanism from the at least one first state to at least one second state comprises operatively coupling the twist-on cap to the sample collection tube, causing the sample collection tube holder to operatively couple the sample collection tube and the test cartridge in the second stable state thereby causing the puncturing element of the test cartridge to break the breakable seal of the sample collection tube, and causing the fluidic coupling mechanism to place the first chamber of the sample collection tube in fluidic communication with the sample inlet of the test cartridge.

In some embodiments, the twist-on cap comprises a handle of a sample collector, the sample collector comprises the handle and a sample collection portion, and operatively coupling the twist-on cap to the sample collection tube comprises locating the sample collection portion of the sample collector within the first chamber of the sample collection tube.

In some embodiments, the method further comprises collecting a sample with the sample collection portion of the sample collector prior to operatively coupling the twist-on cap to the sample collection tube.

In some embodiments, the twist-on cap comprises a first attachment element and the sample collection tube comprises a second attachment element, and wherein operatively coupling the twist-on cap to the sample collection tube comprises operatively coupling the first attachment element and the second attachment element.

In some embodiments, the first attachment element comprises threading and the second attachment element comprises reciprocating threading, and wherein operatively coupling the first attachment element and the second attachment element comprises the reciprocating threading of the second attachment element slidably receiving the threading of the first attachment element.

In some embodiments, the reciprocating threading of the second attachment element slidably receives ½ to 10 complete rotations of the threading of the first attachment element. In some embodiments, operatively coupling the twist-on cap to the sample collection tube comprises sealing the sample collection tube with the twist-on cap. In some embodiments, the breakable seal is proximal to an outlet of the sample collection tube, and wherein locating the sample collection portion of the sample collector within the first chamber of the sample collection tube comprises locating the sample collection portion proximal to the breakable seal, and thus proximal to the outlet of the sample collection tube, such that responsive to the puncturing element of the test cartridge breaking the breakable seal of the sample collection tube, an amount of sample from the sample collection portion that travels from the first chamber of the sample collection tube into the sample inlet of the test cartridge is maximized.

In some embodiments, operatively coupling the twist-on cap to the sample collection tube comprises rotating the twist-on cap around the sample collection tube about an axis of rotation of the twist-on cap, and wherein the sample collection portion of the sample collector is offset from the axis of rotation of the twist-on cap, such that during rotation of the twist-on cap about the axis of rotation, the sample collection portion rotates off the axis of rotation of the twist-on cap, thereby maximizing volume contact of the sample collection portion within the first chamber.

In some embodiments, operatively coupling the twist-on cap to the sample collection tube comprises mixing a volume of the first chamber of the sample collection tube with the sample collection portion of the sample collector, and wherein the first chamber of the sample collection tube contains agitator features, such that the volume of the first chamber of the sample collection tube is agitated by the agitator features during mixing with the sample collection portion of the sample collector.

In some embodiments, the assay assembly further comprises a key feature of the sample collection tube that is operatively coupleable with a threaded feature of the test cartridge, the fluidic coupling mechanism comprises a breakable seal of the sample collection tube and a puncturing element of the test cartridge, the at least one first state comprises the key feature of the sample collection tube not being operatively coupled to the threaded feature of the test cartridge, transitioning the bi-stable locking mechanism from the at least one first state to at least one second state comprising operatively coupling the key feature of the sample collection tube to the threaded feature of the test cartridge, causing the sample collection tube holder to operatively couple the sample collection tube and the test cartridge in the second stable state thereby causes the puncturing element of the test cartridge to break the breakable seal of the sample collection tube, and causing the fluidic coupling mechanism to place the first chamber of the sample collection tube in fluidic communication with the sample inlet of the test cartridge.

In some embodiments, the assay assembly further comprises a cap that is operatively couplable to the sample collection tube, and wherein operatively coupling the key feature of the sample collection tube to the threaded feature of the test cartridge comprises: operatively coupling the cap to the sample collection tube, thereby forming the key feature of the sample collection tube; inverting the sample collection tube; and inserting the inverted sample collection tube into the test cartridge such that the cap of the sample collection tube that forms the key feature of the sample collection tube operatively couples to the threaded feature of the test cartridge.

In some embodiments, the cap of the sample collection tube at least in part comprises the breakable seal, and wherein operatively coupling the key feature of the sample collection tube to the threaded feature of the test cartridge thereby causes the puncturing element of the test cartridge to break the breakable seal in the cap of the sample collection tube.

In some embodiments, an end of the sample collection tube opposite the cap operatively coupled to the sample collection tube comprises a knob, and wherein operatively coupling the key feature of the sample collection tube to the threaded feature of the test cartridge further comprises: following inserting the inverted sample collection tube into the test cartridge, twisting the knob of the inserted sample collection tube such that the key feature of the sample collection tube operatively couples to the threaded feature of the test cartridge.

In some embodiments, the assay assembly further comprises a twist feature of the sample collection tube, the fluidic coupling mechanism comprises a breakable seal of the sample collection tube and a puncturing element of the test cartridge, the at least one first state of the twist feature comprises the twist feature not being twisted, transitioning the twist feature from the at least one first state to at least one second state comprising twisting the twist feature, causing the sample collection tube holder to operatively couple the sample collection tube and the test cartridge in the second stable state thereby causes the puncturing element of the test cartridge to break the breakable seal of the sample collection tube, and causing the fluidic coupling mechanism to place the first chamber of the sample collection tube in fluidic communication with the sample inlet of the test cartridge.

In some embodiments, the assay assembly further comprises a cap that is operatively coupleable with the sample collection tube, the at least one first state of the cap comprises the cap not being operatively coupled to the sample collection tube, and transitioning the cap from the at least one first state to the at least one second state comprises operatively coupling the cap to the sample collection tube.

In some embodiments, transitioning the bi-stable locking mechanism from the at least one first state to the at least one second state comprises: transitioning the cap from the at least one first state to the at least one second state by operatively coupling the cap to the sample collection tube; and responsive to the cap being in the at least one second state such that the cap is operatively coupled to the sample collection tube, transitioning the twist feature from the at least one first state to at least one second state by twisting the twist feature.

In some embodiments, the cap comprises a lockout release arm configured to prevent the cap from transitioning from the at least one second state in which the cap is operatively coupled to the sample collection tube to the at least one first state in which the cap is not operatively coupled to the sample collection tube.

In some embodiments, operatively coupling the cap to the sample collection tube further comprises sealing the sample collection tube with the cap.

In some embodiments, wherein the assay assembly further comprises a sample collector comprising at least a breakable sample collection portion, wherein the sample collection tube and the cap each comprise an opening sized to fit the sample collection portion of the sample collector, wherein an interior portion of the cap comprises a blade, and wherein the method further comprises: during transitioning of the cap from the at least one first state in which the cap is not operatively coupled to the sample collection tube to the at least one second state in which the cap is operatively coupled to the sample collection tube, aligning the opening of the sample collection tube and the opening of the cap; inserting the sample collection portion of the sample collector through the aligned openings of the sample collection tube and the cap and into the first chamber of the sample collection tube; and responsive to transitioning the cap to the at least one second state in which the cap is operatively coupled to the sample collection tube, dislocating the sample collection portion from the sample collector and into the first chamber of the sample collection tube using the blade of the cap.

In some embodiments, wherein the assay assembly further comprises a cap that is operatively coupleable with the sample collection tube, wherein the cap comprises a portion of a sample collector, wherein the sample collector comprises at least a handle and a sample collection portion, and wherein the method further comprises: prior to transitioning the twist feature from the at least one first state to the at least one second state by twisting the twist feature, operatively coupling the cap to the sample collection tube, thereby locating the sample collection portion of the sample collector within the first chamber of the sample collection tube.

In some embodiments, operatively coupling the cap to the sample collection tube further comprises sealing the sample collection tube with the cap.

In some embodiments, the sample collector is flexible and wherein locating the sample collection portion of the sample collector within the first chamber of the sample collection tube further comprises bending the sample collector within the first chamber of the sample collection tube.

In some embodiments:
a. the sample collection tube further comprises:
   an outlet port, the outlet port sealed from the first chamber by the breakable seal,
b. the test cartridge further comprises a fluid transfer mechanism comprising:
   an interface, wherein the outlet port of the sample collection tube is configured to receive the interface; and
   a channel formed in the interface, the channel comprising a first end and a second end and having a length and at least one diameter, the first end comprising an inlet, and the second end comprising an outlet in fluidic communication with the second chamber of the test cartridge,
c. the puncturing element comprises a hollow cylinder having an inner diameter, an outer diameter, and a length,
d. a first segment of the puncturing element includes a first portion of the length of the hollow cylinder,
e. a second segment of the puncturing element includes a second portion of the length of the hollow cylinder,
f. the outer diameter of the hollow cylinder is equivalent to the at least one diameter of the channel in the interface,
g. the first segment of the puncturing element is embedded within at least a portion of the length of the channel, thereby forming a single effective diameter of the channel along the length of the channel, the single effective diameter equivalent to the inner diameter of the hollow cylinder of the puncturing element, and
h. the second segment of the puncturing element extends beyond the inlet of the channel, and
   wherein operatively coupling the sample collection tube and the test cartridge in the second stable state comprises: the outlet port receiving the interface such that at least one portion of the interface has a diameter that is equivalent to a diameter of at least one portion of the outlet port and such that the at least one portion of the interface is located within the at least one portion of the outlet port, thereby fluidically sealing the outlet port with the interface and breaking the breakable seal of the sample collection tube with the second segment of the puncturing element, thereby placing the first chamber of the sample collection tube in fluidic communication with the channel of the fluid transfer mechanism and thus with the second chamber of the test cartridge.

In some embodiments, the interface fluidically seals the outlet port prior to the puncturing element breaking the breakable seal of the sample collection tube, thereby preventing thereby preventing gas bubbles from forming within liquid contained within the first chamber of the sample collection tube and preventing the liquid contained within the first chamber of the sample collection tube from leaking out of the outlet port responsive to the second segment of the puncturing element breaking the breakable seal of the sample collection tube.

In some embodiments, gas vents from the outlet port of the sample collection tube prior to the interface fluidically sealing the outlet port, thereby preventing gas bubbles from forming within liquid contained within the first chamber of the sample collection tube, responsive to the second segment of the puncturing element breaking the breakable seal of the sample collection tube.

In some embodiments, the single effective diameter of the channel along the length of the channel prevents gas bubbles from forming within liquid traveling through the channel.

In some embodiments, the diameter of the interface increases along the length of the channel form the first end to the second end, wherein the at least one portion of the interface of the fluid transfer mechanism that has the diameter that is equivalent to the diameter of the at least one portion of the outlet port comprises a portion of the interface of the fluid transfer mechanism that is proximal to the second end of the channel, and wherein the outlet port receiving the interface comprises: the method further comprises inserting the interface into the outlet port until the portion of the interface that is proximal to the second end of the channel is located within the at least one portion of the outlet port, thereby fluidically sealing the outlet port with the interface.

In some embodiments, at least one of the interface and the outlet port comprises a deformable material, and the outlet port receiving the interface comprises: the at least one interface and outlet port deforming such that at least one portion of the interface has a diameter that is equivalent to a diameter of at least one portion of the outlet port and such that the at least one portion of the interface is located within the at least one portion of the outlet port.

In some embodiments, the interface comprises a hydrophobic material, the puncturing element comprises a hydrophilic material, and the breakable seal comprises a hydrophilic material, and wherein breaking the breakable seal of the sample collection tube with the second segment of the puncturing element traps gas from the outlet port between the interface and the breakable seal but separate from the puncturing element, thereby preventing gas bubbles from forming within liquid contained within the first chamber of the sample collection tube.

In some embodiments, breaking the breakable seal of the sample collection tube with the second segment of the puncturing element forms a narrow gap between the puncturing element and the breakable seal, such that gas trapped between the interface and the breakable seal cannot overcome surface tension of liquid contained within the first chamber of the sample collection tube to travel through the narrow gap, past the breakable seal, and into the liquid contained within the first chamber of the sample collection tube, thereby preventing gas bubbles from forming within liquid contained within the first chamber of the sample collection tube.

In some embodiments, the puncturing element comprises a material having a hardness that is at least 2× the hardness of a material comprising the breakable seal, such that the puncturing element provides for a clear puncture of the breakable seal with repeatable geometry and without deformation of the puncturing element.

In some embodiments, the inner diameter of the hollow cylinder of the puncturing element is less than a radius of a meniscus of liquid entering the hollow cylinder, thereby preventing gas bubbles from forming within liquid entering the hollow cylinder.

In some embodiments, the puncturing element is interference-fit within the at least a portion of the length of the channel formed in the interface, thereby preventing gas bubbles from forming within liquid traveling through the channel at an interface between the puncturing element and the channel formed in the interface.

In some embodiments, a surface area of an end of the second portion of the puncturing element that is configured to contact the breakable seal is less than 25% of the surface area of the breakable seal, thereby limiting deformation of the breakable seal during breaking by the second portion of the puncturing element, and thereby limiting a size and/or number of gas bubbles formed during deformation of the breakable seal and/or that can be introduced through the broken seal and into the sample collection tube.

In some embodiments, the method further comprises placing or having placed the bi-stable locking mechanism in the at least one first state, thereby causing the sample collection tube holder to operatively couple the sample collection tube and the test cartridge in the first stable state.

In some embodiments, the assay assembly further comprises a sample collector comprising a handle and a sample collection portion, and wherein the method further comprises inserting the sample collection portion having a sample into the sample collection tube to elute the sample into the sample collection tube prior to transitioning the bi-stable locking mechanism from the at least one first state to the at least one second state.

In some embodiments, the method further comprises collecting the sample with the sample collection portion of the sample collector prior to inserting the sample collection portion having the sample into the sample collection tube.

In some embodiments, the sample collection portion of the sample collector is breakable, and wherein the method further comprises dislocating the sample collection portion from the sample collector and into the first chamber of the sample collection tube prior to transitioning the bi-stable locking mechanism from the at least one first state to the at least one second state.

In some embodiments, the method further comprises removing the sample collector from the sample collection tube prior to transitioning the bi-stable locking mechanism from the at least one first state to the at least one second state.

In some embodiments, the bi-stable locking mechanism is irreversible such that the bi-stable locking mechanism cannot transition from the at least one second state in which (i) the sample collection tube, the first chamber or the first sub-container and (ii) the test cartridge are operatively coupled in the second stable state to the at least one first state in which the sample collection tube and the test cartridge are operatively coupled in the first stable state.

In some embodiments, the sample collection tube, the first chamber, the first sub-container and/or the test cartridge comprises one more of the following to prevent transition from the at least one second state to the at least one first state: locking detents, cantilever snap features, lock-out release arm, ratchet features, sawtooth ratchets, ratchet and pawl features.

In some embodiments, an exterior surface of the sample collection tube comprises alignment features, wherein the sample collection tube holder comprises a shelf having gaps sized to fit the alignment features of the sample collection tube, and wherein transitioning the bi-stable locking mechanism from the at least one first state to the at least one second state at least in part comprises aligning the alignment features of the sample collection tube with the gaps of in the shelf of the sample collection tube holder and moving the alignment features of the sample collection tube through the gaps of the shelf of the sample collection tube holder towards the test cartridge, thereby causing the sample collection tube holder to operatively couple the sample collection tube and the test cartridge in the second stable state.

In some embodiments, the exterior surface of the sample collection tube further comprises notches, wherein the sample collection tube holder comprises hooks positioned below the shelf, and the method further comprises, following operative coupling of the sample collection tube and the test cartridge in the second stable state, the hooks interlocking with the notches, thereby preventing the sample collection tube from transitioning from operative coupling with the test cartridge in the second stable state to operative coupling with the test cartridge in the first stable state.

In some embodiments, the shelf of the sample collection tube holder comprises one or more cantilever snap features, wherein responsive to the bi-stable locking mechanism being in the at least one first state, the one or more cantilever snap features are positioned in a first position, thereby causing the sample collection tube holder to operatively couple the sample collection tube and the test cartridge in the first stable state, and wherein transitioning the bi-stable locking mechanism from the at least one first state to at least one second state at least in part comprises moving the one or more cantilever snap features from the first position to a second position, the second position proximal to the test cartridge relative to the first position, thereby causing the sample collection tube holder to operatively couple the sample collection tube and the test cartridge in the second stable state.

In some embodiments, the sample collection tube holder further comprises one or more cantilever snap features, wherein responsive to the bi-stable locking mechanism being in the at least one first state, the one or more cantilever snap features are positioned above the shelf of the sample collection tube holder, thereby causing the sample collection tube holder to operatively couple the sample collection tube and the test cartridge in the first stable state, and wherein transitioning the bi-stable locking mechanism from the at least one first state to at least one second state at least in part comprises moving the one or more cantilever snap features below the shelf of the sample collection tube holder, thereby causing the sample collection tube holder to operatively couple the sample collection tube and the test cartridge in the second stable state.

In some embodiments, the first chamber of the sample collection tube comprises a liquid reagent, and wherein placing the first chamber of the sample collection tube in fluidic communication with the sample inlet of the test cartridge comprises flowing the liquid reagent from the first chamber into the sample inlet.

In another aspect, the present disclosure provides a method comprising:
a. obtaining an assay assembly, the assembly comprising:
   a sample collection tube comprising:
      1. a first chamber; and
      2. a breakable seal;
   a test cartridge comprising:
      1. a sample inlet;
      2. one or more reaction chambers; and
      3. a puncturing element; and
   a sample collector comprising:
      1. a handle comprising a cap that is operatively coupleable with the sample collection tube; and
      2. a sample collection portion,
wherein the sample collection tube and the test cartridge are operatively coupled in a first stable state; and
b. operatively coupling the cap to the sample collection tube, thereby locating the sample collection portion of the sample collector within the first chamber of the sample collection tube and operatively coupling the sample collection tube and the test cartridge in a second stable state, thereby causing the puncturing element of the test cartridge to break the breakable seal of the sample collection tube, and thereby placing the first chamber of the sample collection tube in fluidic communication with the sample inlet of the test cartridge.

In some embodiments, the method further comprises operatively coupling or having operatively coupled the sample collection tube and the test cartridge in the first stable state.

In some embodiments, the method further comprises collecting a sample with the collection portion of the sample collector prior to operatively coupling the cap to the sample collection tube.

In some embodiments, the cap comprises a first attachment element and the sample collection tube comprises a second attachment element, and wherein operatively coupling the cap to the sample collection tube comprises operatively coupling the first attachment element and the second attachment element.

In some embodiments, the cap comprises a twist-on cap, wherein the first attachment element comprises threading and the second attachment element comprises reciprocating threading, and wherein operatively coupling the first attachment element and the second attachment element comprises the reciprocating threading slidably receiving the threading.

In some embodiments, the reciprocating threading of the second attachment element slidably receives ½ to 10 complete rotations of the threading of the first attachment element.

In some embodiments, operatively coupling the twist-on cap to the sample collection tube comprises rotating the twist-on cap around the sample collection tube about an axis of rotation of the twist-on cap, and wherein the sample collection portion of the sample collector is offset from the axis of rotation of the twist-on cap, such that during rotation of the twist-on cap about the axis of rotation, the sample collection portion rotates off the axis of rotation of the twist-on cap, thereby maximizing volume contact of the sample collection portion within the first chamber.

In some embodiments, operatively coupling the twist-on cap to the sample collection tube comprises mixing a volume of the first chamber of the sample collection tube with the sample collection portion of the sample collector.

In some embodiments, the first chamber of the sample collection tube contains agitator features such that the volume of the first chamber of the sample collection tube is agitated by the agitator features during mixing with the sample collection portion of the sample collector.

In some embodiments, operatively coupling the cap to the sample collection tube comprises sealing the sample collection tube with the cap.

In some embodiments, the breakable seal is proximal to an outlet of the sample collection tube, and wherein locating the sample collection portion of the sample collector within the first chamber of the sample collection tube comprises locating the sample collection portion proximal to the breakable seal, and thus proximal to the outlet of the sample collection tube, such that responsive to the puncturing element of the test cartridge breaking the breakable seal of the sample collection tube, an amount of sample from the sample collection portion that travels from the first chamber of the sample collection tube into the sample inlet of the test cartridge is maximized.

In some embodiments, the operative coupling of the cap to the sample collection tube is irreversible such that the cap cannot transition from being operatively coupled to the sample collection tube to not being operatively coupled to the sample collection tube.

In some embodiments, the cap comprises one more of the following to prevent transition from the at least one second state to the at least one first state: locking detents, cantilever snap features, a lock-out release arm, ratchet features, sawtooth ratchets, ratchet and pawl features.

In some embodiments, the operative coupling of the sample collection tube and the test cartridge in the second stable state is irreversible such that sample collection tube, the first chamber or the first sub-container cannot transition from being operatively coupled with the test cartridge in the second stable state to being operatively coupled with the test cartridge in the first stable state.

In some embodiments, the sample collection tube and/or the test cartridge comprises one more of the following to prevent transition from the at least one second state to the at least one first state: locking detents, cantilever snap features, lock-out release arm, ratchet features, sawtooth ratchets, ratchet and pawl features.

In some embodiments, the test cartridge further comprises a sample collection tube holder, the sample collection tube holder operatively couples the sample collection tube and the test cartridge in the first stable state, and operatively coupling the sample collection tube and the test cartridge in the second stable state comprises the sample collection tube holder operatively coupling the sample collection tube and the test cartridge in the second stable state.

In some embodiments, an exterior surface of the sample collection tube comprises alignment features, wherein the sample collection tube holder comprises a shelf having gaps sized to fit the alignment features of the sample collection tube, and wherein the sample collection tube holder operatively coupling the sample collection tube and the test cartridge in the second stable state at least in part comprises aligning the alignment features of the sample collection tube with the gaps of in the shelf of the sample collection tube holder and moving the alignment features of the sample collection tube through the gaps of the shelf of the sample collection tube holder towards the test cartridge, thereby causing the sample collection tube holder to operatively couple the sample collection tube and the test cartridge in the second stable state.

In some embodiments, the exterior surface of the sample collection tube further comprises notches, wherein the sample collection tube holder comprises hooks positioned below the shelf, and the method further comprises, following operative coupling of the sample collection tube and the test cartridge in the second stable state, the hooks interlocking with the notches, thereby preventing the sample collection tube from transitioning from operative coupling with the test cartridge in the second stable state to operative coupling with the test cartridge in the first stable state.

In some embodiments, the shelf of the sample collection tube holder comprises one or more cantilever snap features, wherein responsive to the one or more cantilever snap features being positioned in a first position, the sample collection tube holder operatively couples the sample collection tube and the test cartridge in the first stable state, and wherein the sample collection tube holder operatively coupling the sample collection tube and the test cartridge in the second stable state at least in part comprises moving the one or more cantilever snap features from the first position to a second position, the second position proximal to the test cartridge relative to the first position.

In some embodiments, the sample collection tube holder further comprises one or more cantilever snap features, wherein responsive to the one or more cantilever snap features being positioned above the shelf of the sample collection tube holder, the sample collection tube holder operatively couples the sample collection tube and the test cartridge in the first stable state, and wherein the sample collection tube holder operatively coupling the sample collection tube and the test cartridge in the second stable state at least in part comprises moving the one or more cantilever snap features below the shelf of the sample collection tube holder.

In some embodiments, the first chamber of the sample collection tube comprises a liquid reagent, and wherein placing the first chamber of the sample collection tube in fluidic communication with the sample inlet of the test cartridge comprises flowing the liquid reagent from the first chamber into the sample inlet.

In some embodiments:
a. the sample collection tube further comprises:
   an outlet port, the outlet port sealed from the first chamber by the breakable seal,
b. the test cartridge further comprises a fluid transfer mechanism comprising:
   an interface, wherein the outlet port of the sample collection tube is configured to receive the interface; and
   a channel formed in the interface, the channel comprising a first end and a second end and having a length and at least one diameter, the first end comprising an inlet, and the second end comprising an outlet in fluidic communication with the second chamber of the test cartridge,
c. the puncturing element comprises a hollow cylinder having an inner diameter, an outer diameter, and a length,
d. a first segment of the puncturing element includes a first portion of the length of the hollow cylinder,
e. a second segment of the puncturing element includes a second portion of the length of the hollow cylinder,
f. the outer diameter of the hollow cylinder is equivalent to the at least one diameter of the channel in the interface,
g. the first segment of the puncturing element is embedded within at least a portion of the length of the channel, thereby forming a single effective diameter of the channel along the length of the channel, the single effective diameter equivalent to the inner diameter of the hollow cylinder of the puncturing element, and
h. the second segment of the puncturing element extends beyond the inlet of the channel, and
   wherein operatively coupling the sample collection tube and the test cartridge in the second stable state comprises: the outlet port receiving the interface such that at least one portion of the interface has a diameter that is equivalent to a diameter of at least one portion of the outlet port and such that the at least one portion of the interface is located within the at least one portion of the outlet port, thereby fluidically sealing the outlet port with the interface and breaking the breakable seal of the sample collection tube with the second segment of the puncturing element, thereby placing the first chamber of the sample collection tube in fluidic communication with the channel of the fluid transfer mechanism and thus with the second chamber of the test cartridge

In some embodiments, the interface fluidically seals the outlet port prior to the puncturing element breaking the breakable seal of the sample collection tube, thereby preventing thereby preventing gas bubbles from forming within liquid contained within the first chamber of the sample collection tube and preventing the liquid contained within the first chamber of the sample collection tube from leaking out of the outlet port responsive to the second segment of the puncturing element breaking the breakable seal of the sample collection tube.

In some embodiments, gas vents from the outlet port of the sample collection tube prior to the interface fluidically sealing the outlet port, thereby preventing gas bubbles from forming within liquid contained within the first chamber of the sample collection tube, responsive to the second segment of the puncturing element breaking the breakable seal of the sample collection tube.

In some embodiments, the single effective diameter of the channel along the length of the channel prevents gas bubbles from forming within liquid traveling through the channel.

In some embodiments, the diameter of the interface increases along the length of the channel form the first end to the second end, wherein the at least one portion of the interface of the fluid transfer mechanism that has the diameter that is equivalent to the diameter of the at least one portion of the outlet port comprises a portion of the interface of the fluid transfer mechanism that is proximal to the second end of the channel, and wherein the outlet port receiving the interface comprises: inserting the interface into the outlet port until the portion of the interface that is proximal to the second end of the channel is located within the at least one portion of the outlet port, thereby fluidically sealing the outlet port with the interface.

In some embodiments, at least one of the interface and the outlet port comprises a deformable material, and wherein the outlet port receiving the interface comprises: the at least one interface and outlet port deforming such that at least one portion of the interface has a diameter that is equivalent to a diameter of at least one portion of the outlet port and such that the at least one portion of the interface is located within the at least one portion of the outlet port.

In some embodiments, the interface comprises a hydrophobic material, the puncturing element comprises a hydrophilic material, and the breakable seal comprises a hydrophilic material, and wherein breaking the breakable seal of the sample collection tube with the second segment of the puncturing element traps gas from the outlet port between the interface and the breakable seal but separate from the puncturing element, thereby preventing gas bubbles from forming within liquid contained within the first chamber of the sample collection tube.

In some embodiments, breaking the breakable seal of the sample collection tube with the second segment of the puncturing element forms a narrow gap between the puncturing element and the breakable seal, such that gas trapped between the interface and the breakable seal cannot overcome surface tension of liquid contained within the first chamber of the sample collection tube to travel through the narrow gap, past the breakable seal, and into the liquid contained within the first chamber of the sample collection tube, thereby preventing gas bubbles from forming within liquid contained within the first chamber of the sample collection tube.

In some embodiments, the puncturing element comprises a material having a hardness that is at least 2× the hardness of a material comprising the breakable seal, such that the puncturing element provides for a clear puncture of the breakable seal with repeatable geometry and without deformation of the puncturing element.

In some embodiments, the inner diameter of the hollow cylinder of the puncturing element is less than a radius of a meniscus of liquid entering the hollow cylinder, thereby preventing gas bubbles from forming within liquid entering the hollow cylinder.

In some embodiments, the puncturing element is interference-fit within the at least a portion of the length of the channel formed in the interface, thereby preventing gas bubbles from forming within liquid traveling through the channel at an interface between the puncturing element and the channel formed in the interface.

In some embodiments, a surface area of an end of the second portion of the puncturing element that is configured to contact the breakable seal is less than 25%, thereby limiting a size and/or number of gas bubbles formed during deformation of the breakable seal and/or that can be introduced through the broken seal and into the sample collection tube.

In another aspect, the present disclosure provides a method comprising:
a. obtaining an assay assembly, the assembly comprising:
   a sample collection tube comprising:
      1. a main chamber;
      2. an outlet port; and
      3. a breakable seal, the breakable seal sealing the main chamber from the outlet port; and
   a fluid transfer mechanism comprising:
      1. an interface, wherein the outlet port of the sample collection tube is configured to receive the interface of the fluid transfer mechanism;
      2. a channel formed in the interface, the channel comprising a first end and a second end, and having a length and at least one diameter, the first end comprising an inlet; and
      3. a puncturing element comprising a hollow cylinder having an inner diameter, an outer diameter, and a length, and wherein a first segment of the puncturing element includes a first portion of the length of the hollow cylinder, a second segment of the puncturing element includes a second portion of the length of the hollow cylinder, and the outer diameter of the hollow cylinder is equivalent to the at least one diameter of the channel in the interface,
   wherein the first segment of the puncturing element is embedded within at least a portion of the length of the channel, thereby forming a single effective diameter of the channel along the length of the channel, the single effective diameter equivalent to the inner diameter of the hollow cylinder of the puncturing element, and
   wherein the second segment of the puncturing element extends beyond the inlet of the channel, and
b. moving the interface of the fluid transfer mechanism into the outlet port of the sample collection tube such that at least one portion of the interface has a diameter that is equivalent to a diameter of at least one portion of the outlet port and such that the at least one portion of the interface is located within the at least one portion of the outlet port, thereby fluidically sealing the outlet port with the interface and puncturing the breakable seal of the sample collection tube with the second segment of the puncturing element of the fluid transfer mechanism, thereby placing the main chamber of the sample collection tube in fluidic communication with the channel of the fluid transfer mechanism.

In some embodiments, the interface fluidically seals the outlet port prior to the puncturing element breaking the breakable seal of the sample collection tube, thereby preventing thereby preventing gas bubbles from forming within liquid contained within the main chamber of the sample collection tube and preventing the liquid contained within the main chamber of the sample collection tube from leaking out of the outlet port responsive to the second segment of the puncturing element breaking the breakable seal of the sample collection tube.

In some embodiments, gas vents from the outlet port of the sample collection tube prior to the interface fluidically sealing the outlet port, thereby preventing gas bubbles from forming within liquid contained within the main chamber of the sample collection tube, responsive to the second segment of the puncturing element breaking the breakable seal of the sample collection tube.

In some embodiments, the single effective diameter of the channel along the length of the channel prevents gas bubbles from forming within liquid traveling through the channel.

In some embodiments, the diameter of the interface increases along the length of the channel form the first end to the second end, wherein the at least one portion of the interface of the fluid transfer mechanism that has the diameter that is equivalent to the diameter of the at least one portion of the outlet port comprises a portion of the interface of the fluid transfer mechanism that is proximal to the second end of the channel, and wherein moving the interface of the fluid transfer mechanism into the outlet port of the sample collection tube comprises: inserting the interface into the outlet port until the portion of the interface that is proximal to the second end of the channel is located within the at least one portion of the outlet port, thereby fluidically sealing the outlet port with the interface.

In some embodiments, at least one of the interface and the outlet port comprises a deformable material, and wherein moving the interface of the fluid transfer mechanism into the outlet port of the sample collection tube comprises: the at least one interface and outlet port deforming such that at least one portion of the interface has a diameter that is equivalent to a diameter of at least one portion of the outlet port and such that the at least one portion of the interface is located within the at least one portion of the outlet port.

In some embodiments, the interface comprises a hydrophobic material, the puncturing element comprises a hydrophilic material, and the breakable seal comprises a hydrophilic material, and wherein breaking the breakable seal of the sample collection tube with the second segment of the puncturing element traps gas from the outlet port between the interface and the breakable seal but separate from the puncturing element, thereby preventing gas bubbles from forming within liquid contained within the main chamber of the sample collection tube.

In some embodiments, breaking the breakable seal of the sample collection tube with the second segment of the puncturing element forms a narrow gap between the puncturing element and the breakable seal, such that gas trapped between the interface and the breakable seal cannot overcome surface tension of liquid contained within the main chamber of the sample collection tube to travel through the narrow gap, past the breakable seal, and into the liquid contained within the main chamber of the sample collection tube, thereby preventing gas bubbles from forming within liquid contained within the main chamber of the sample collection tube.

In some embodiments, the puncturing element comprises a material having a hardness that is at least 2× the hardness of a material comprising the breakable seal, such that the puncturing element provides for a clear puncture of the breakable seal with repeatable geometry and without deformation of the puncturing element.

In some embodiments, the inner diameter of the hollow cylinder of the puncturing element is less than a radius of a meniscus of liquid entering the hollow cylinder, thereby preventing gas bubbles from forming within liquid entering the hollow cylinder.

In some embodiments, the puncturing element is interference-fit within the at least a portion of the length of the channel formed in the interface, thereby preventing gas bubbles from forming within liquid traveling through the channel at an interface between the puncturing element and the channel formed in the interface.

In some embodiments, a surface area of an end of the second portion of the puncturing element that is configured to contact the breakable seal is less than 25%, thereby limiting a size and/or number of gas bubbles formed during deformation of the breakable seal and/or that can be introduced through the broken seal and into the sample collection tube.

### BRIEF DESCRIPTION OF THE DRAWINGS

These and other features, aspects, and advantages of the present invention will become better understood with regard to the following description, and accompanying drawings, where:

FIG. 1 is a diagram showing an example of a streamlined assay process including the sample collection, assay set-up, assay run time, immediate display/reporting of the results, in accordance with an embodiment. As shown, the streamlined assay process allows users to bypass conventional sample transportation and purification steps.

FIGS. 2A-2C depict an assay assembly having a sample collection tube 201 and a test cartridge 203 in a first stable state, wherein the sample collection tube 201 and test cartridge 203 are not in fluidic communication, in accordance with an embodiment.

FIGS. 3A-3C depict an assay assembly having a sample collection tube 201 and a test cartridge 203 in a second stable state, wherein the sample collection tube 201 and test cartridge 203 are in fluidic communication, in accordance with an embodiment.

FIG. 4 is a cross-section of a sample collection tube 201 and a piercing element 206 in a first stable state, wherein the piercing element 206 has not punctured the breakable seal 207 at the bottom of the sample collection tube 201, and the sample collection tube 201 and piercing element 206 are maintained in a first stable state by a spring 209 (e.g., open-coil spring, helical spring, etc.), in accordance with an embodiment.

FIGS. 5A-5D depict an exemplar streamlined assay preparation and assembly 500 in a plurality of sequential steps, in accordance with an embodiment. FIG. 5A depicts operative coupling of the sample collection tube 502 into the sample collection tube holder 503 of the test cartridge in a first stable state, in accordance with an embodiment. FIG. 5B depicts an exemplary sample collection process using a mid-turbinate swab 504, in accordance with an embodiment. FIG. 5C depicts the mixing of the sample in the reagent of the sample collection tube 502, in accordance with an embodiment. FIG. 5D depicts the capping of the sample collection tube 502, which operatively couples the sample collection tube 502 with the sample collection tube holder 503 of the test cartridge in a second stable state and allows fluidic communication between the sample collection tube 502 and the test cartridge, in accordance with an embodiment.

FIGS. 6A-6E depict an exemplar streamlined assay preparation and assembly 600 in a plurality of sequential steps, in accordance with an embodiment. FIG. 6A depicts the sample collector 605, sample collection tube 604 and test cartridge 601 having a twist-on cap 602, in accordance with an embodiment. FIG. 6B depicts the operative coupling of a sample collection tube 604 and a test cartridge 601 in a first stable state, in accordance with an embodiment. FIG. 6C depicts the sample collection process, e.g., nasal swab specimen collection, in accordance with an embodiment. FIG. 6D depicts the insertion of the sample collector 605, which has a breakable handle 608, into the sample collection tube 604 and breaking the sample collector handle 608 by twisting the cap 602, in accordance with an embodiment. FIG. 6E depicts the twisting of the cap 602, which operatively couples the sample collection tube 604 with the test cartridge 601 in a second stable state, thereby allowing fluidic communication between the sample collection tube 604 with the test cartridge 601, in accordance with an embodiment.

FIGS. 7A-7F depict an exemplar streamlined assay preparation and assembly 700 in a plurality of sequential steps, in accordance with an embodiment. FIG. 7A depicts the sample collector 703, sample collection tube 702 and test cartridge 704, wherein the sample collector 703 is affixed to a twist-on cap 701, in accordance with an embodiment. FIG. 7B depicts the insertion of the sample collection tube 702 into the sample collection tube holder of the test cartridge 704. FIG. 7C depicts the twist-on cap 701 comprising a sample collector 703, in accordance with an embodiment. FIG. 7D depicts the sample collection process, e.g., nasal swab specimen collection, in accordance with an embodiment. FIG. 7E depicts the insertion of the sample collection portion of the sample collector 703 into the sample collection tube 702, in accordance with an embodiment. FIG. 7F depicts the operative coupling of the sample collection tube 702 to the test cartridge 704 by twisting the twist-on cap 701, in accordance with an embodiment. FIG. 7G depicts the operative coupling of the sample collection tube 702 to the test cartridge 704 in the first stable state, wherein the piercing element 708 has not punctured the breakable seal 707 at the bottom of the sample collection tube 702. The sample collection tube 702 and piercing element 708 are maintained in a first stable state by a spring 709 (e.g., open-coil spring, helical spring, etc.), in accordance with an embodiment.

FIGS. 8A-8F depict an exemplar streamlined assay preparation and assembly 800 in a plurality of sequential steps, in accordance with an embodiment. FIG. 8A depicts the sample collector, sample collection tube 802 and test cartridge 803 with the sample collection tube 802 inverted and operatively coupled to the test cartridge 803 in a first stable state, in accordance with an embodiment. FIG. 8B depicts the sample collection process, e.g., nasal swab specimen collection, in accordance with an embodiment. FIG. 8C depicts the introduction of the sample to the reagent in the sample collection tube 802, in accordance with an embodiment. FIG. 8D depicts the sample collection tube 802 with its cap closed and a key feature 801 on the capped sample collection tube 802, in accordance with an embodiment. FIG. 8E depicts the inversion of the capped sample collection tube 802 and operative coupling of the sample collection tube 802 and the test cartridge 803 in a first stable state, in accordance with an embodiment. FIG. 8F depicts the operative coupling of the sample collection tube 802 to the test cartridge 803 by twisting the knob 806 on the opposite end of the capped side of the sample collection tube 802, in accordance with an embodiment.

FIGS. 9A-9E depict an exemplar streamlined assay preparation and assembly 900 in a plurality of sequential steps, in accordance with an embodiment. FIG. 9A depicts the sample collector 908, sample collection tube 901 and test cartridge 902 with sample collection tube 901 operatively coupled to the test cartridge 902 in a first stable state, in accordance with an embodiment. FIG. 9B depicts the insertion of the sample collection tube 901 in the sample collection tube holder of the test cartridge 902, in accordance with an embodiment. FIG. 9C depicts the sample collection process, e.g., nasal swab specimen collection, in accordance with an embodiment. FIG. 9D depicts the insertion of the sample collector head 906 into the reagent in the sample collection tube 901 and breaking of the sample collector handle 907 by pushing down the cap 904, in accordance with an embodiment. FIG. 9E depicts the twisting of the sample collection tube 901, which operatively couples the sample collection tube 901 with a second chamber in the test cartridge 902, allowing fluidic communication between the sample collection tube 901 and the test cartridge 902, in accordance with an embodiment.

FIGS. 10A-10F depict an exemplar streamlined assay preparation and assembly 1000 in a plurality of sequential steps, in accordance with an embodiment. FIG. 10A depicts the sample collector 1001 affixed to a cap 1002, the sample collection tube 1003, and the test cartridge 1005 with the sample collection tube 1003 operatively coupled to the test cartridge 1005, in accordance with an embodiment. FIG. 10B depicts operative coupling of a sample collection tube 1003 and a test cartridge 1005 in a first stable state, in accordance with an embodiment. FIG. 10C depicts the sample collection process, e.g., nasal swab specimen collection, in accordance with an embodiment. FIG. 10D depicts the removal of the original sample collection tube cap 1006 and insertion of the sample collector 1001, in accordance with an embodiment. FIG. 10E depicts capping of the sample collection tube 1003 with the cap 1002 affixed to the sample collector 1001, in accordance with an embodiment. FIG. 10F depicts the twisting of the sample collection tube 1003, which operatively couples the sample collection tube 1003 with the test cartridge 1005 in a second stable state, thereby allowing fluidic communication between the sample collection tube 1003 and the test cartridge 1005, in accordance with an embodiment.

FIG. 11 is a cross-section showing an exemplar bi-stable locking mechanism having a first stable state and a second stable state, in accordance with an embodiment.

FIG. 12 is a diagram showing the sample collection tube 1205 and a sample collection tube holder 1201 having a shelf 1202 with gaps 1203 configured to align with alignment features 1204 (e.g., ribs) on the sample collection tube 1205, in accordance with an embodiment.

FIG. 13A is a diagram showing the sample collection tube 1305 having alignment features 1306 and/or 1301 (e.g., ribs and notches) on its exterior surface and a sample collection tube holder 1302 having a shelf 1304 with rotational alignment features 1303, in accordance with an embodiment. FIGS. 13B and 13C depict the sample collection tube 1305 loaded into the sample collection tube holder 1302, in accordance with an embodiment.

FIG. 14A is a diagram showing the sample collection tube holder operatively coupling the sample collection tube to the test cartridge in the first stable state, wherein the sample collection tube is positioned above cantilever snap features 1401, in accordance with an embodiment. FIG. 14B and FIG. 14C are diagrams of a sample collection tube holder having cantilever snap features 1401 and ribs to facilitate alignment of a sample collection tube and/or locking of the assay assembly components, in accordance with an embodiment.

FIG. 15 is a cross-section of an assembly 1500 for bubble-free puncturing, depicting a puncturing element 1509 penetrating a breakable seal 1504 at the bottom of a sample collection tube 1502, in accordance with an embodiment.

FIGS. 16A-16C show a cross-section of an assembly for bubble-free puncturing in a plurality of sequential steps, in accordance with an embodiment.

FIGS. 17A-17C include photographs of the interior of a test cartridge 1700 (FIG. 17A), a breakable seal 1701 at the bottom of a sample collection tube 1702 (FIG. 17B), and the insertion of a sample collection tube 1702 in the sample collection tube holder 1703 of a test cartridge 1700 (FIG. 17C), in accordance with an embodiment.

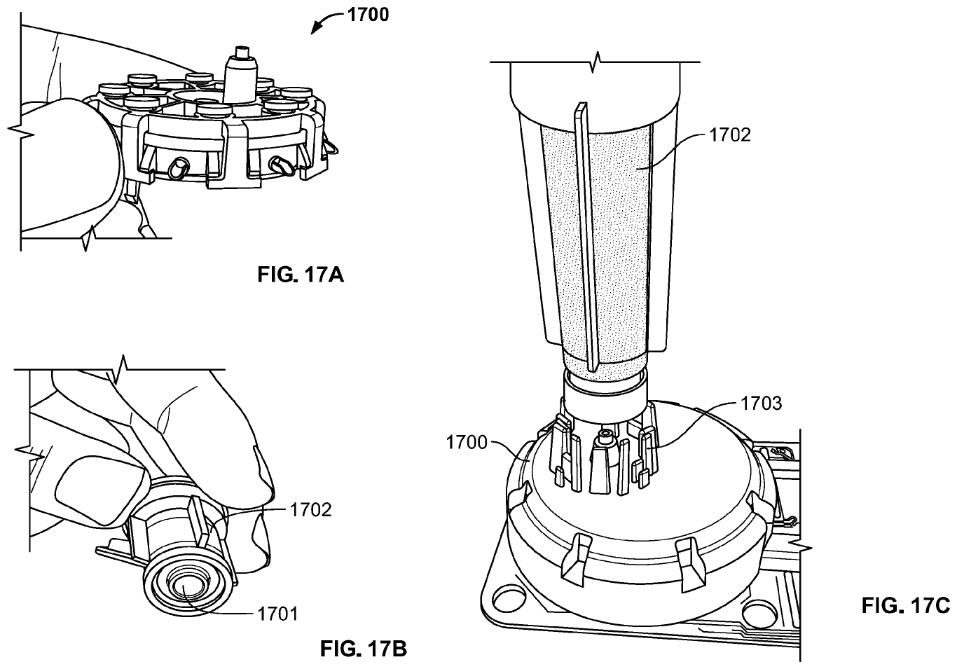

FIGS. 18A-18C include photographs of the sample collection tube holder 1801 for a test cartridge 1800 (FIG. 18A), a sealed and uncapped sample collection tube 1802 positioned in the sample collection tube holder 1801 of a test cartridge 1800 (FIG. 18B and FIG. 18C), in accordance with an embodiment.

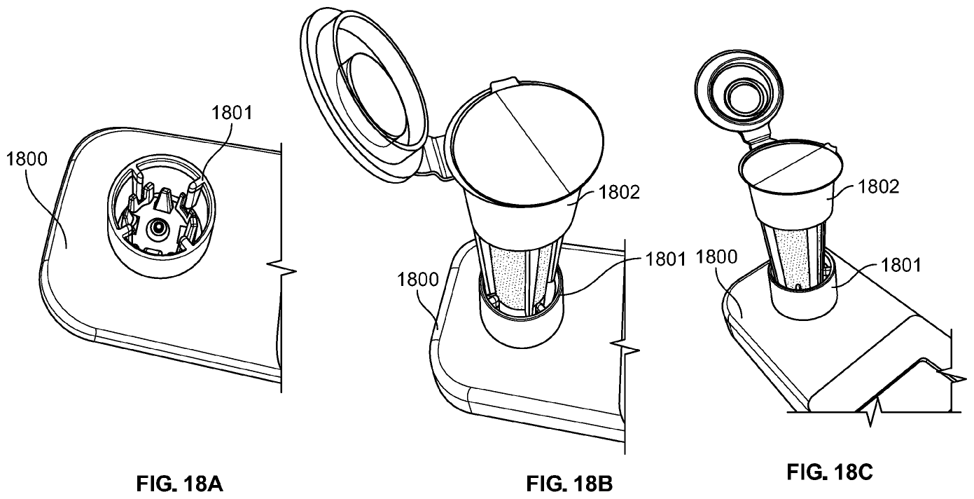

FIGS. 19A and 19B include photographs depicting an assembly in a plurality of sequential steps, in accordance with an embodiment. FIG. 19A includes a photograph depicting operative coupling of a sample collection tube 1900 and a test cartridge 1901 in a first stable state by inserting the sample collection tube 1900 into the sample collection tube holder 1902, in accordance with an embodiment. FIG. 19B includes a photograph depicting a user rotating the sample collection tube holder 1902, thereby operatively coupling the sample collection tube 1900 with the test cartridge 1901 in a second stable state allowing the sample collection tube 1900 to move down the sample collection tube holder 1902 and breaking the breakable seal (not shown), in accordance with an embodiment.

FIG. 20A includes a photograph depicting a user pushing a release feature 2003 (e.g., button) on the sample collection tube holder 2002, thereby operatively coupling the sample collection tube 2000 with the test cartridge 2001 in a second stable state allowing the sample collection tube 2000 to move down the sample collection tube holder 2002 and breaking the breakable seal (not shown), in accordance with an embodiment. FIG. 20B includes a photograph depicting a user moving (e.g., pulling) a release feature 2003 (e.g., a lever) on the sample collection tube holder 2002, thereby operatively coupling the sample collection tube 2000 with the test cartridge 2001 in a second stable state allowing the sample collection tube 2000 to move down the sample collection tube holder 2002 and breaking the breakable seal (not shown), in accordance with an embodiment.

FIGS. 21A-21F include photographs of an exemplar streamlined assay preparation and assembly in a plurality of sequential steps, in accordance with an embodiment. FIG. 21A depicts operative coupling of an open (uncapped) sample collection tube 2100 and a test cartridge 2101 in a first stable state, in accordance with an embodiment. FIG. 21B depicts a user unpacking a cap 2102 affixed to a sample collector 2103, in accordance with an embodiment. FIG. 21C depicts the sample collection process, e.g., nasal swab specimen collection, in accordance with an embodiment. FIG. 21D depicts insertion of the sample collection portion of the sample collector 2103 into the sample collection tube 2100, in accordance with an embodiment. FIG. 21E depicts a user pushing the cap 2102 affixed to the sample collector 2103 into the keyed recess of the unit 2104 comprising the sample collection tube holder and sample collection tube, in accordance with an embodiment. FIG. 21F depicts a user rotating the unit 2104 comprising the sample collection tube holder while the test cartridge base 2105 remains stationary, in accordance with an embodiment.

FIG. 22 includes a flow chart for a method 2200 of the subject disclosure, in accordance with an embodiment.

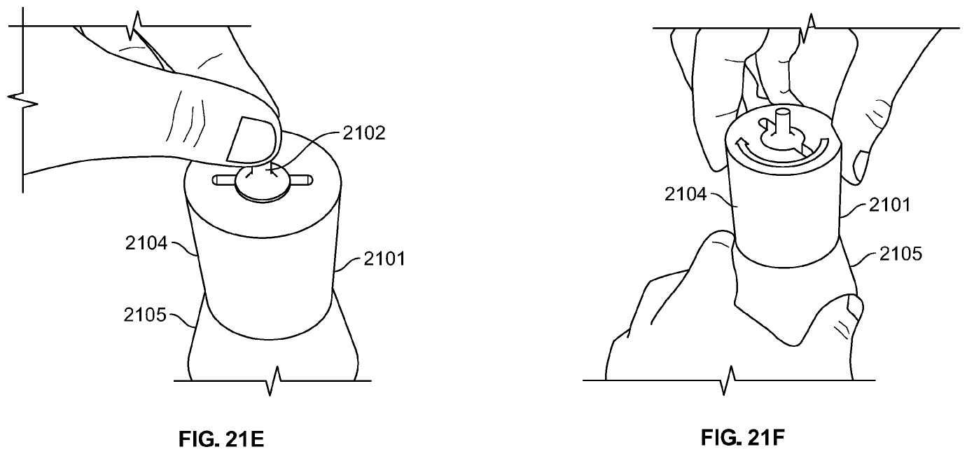

FIG. 23 includes a flow chart for a method 2300 of the subject disclosure, in accordance with an embodiment.

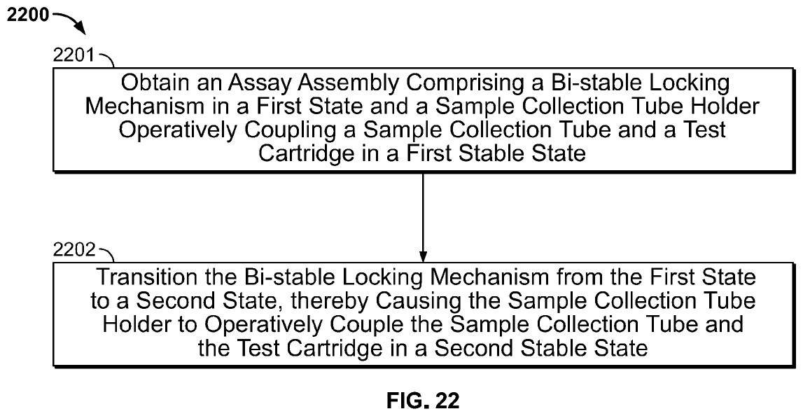

FIG. 24 includes a flow chart for a method 2400 of the subject disclosure, in accordance with an embodiment.

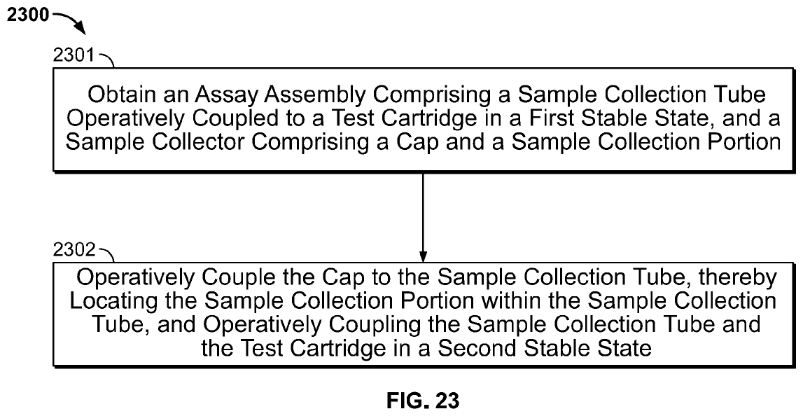

FIG. 25 includes a cross-section showing an assay assembly 2500 having a sample collection tube 2501 (which comprises a test cartridge 2502) separate from a reusable base unit 2503.

FIG. 26 includes schematics showing an assay assembly having a base unit 2601, base unit engagement holder 2603, sample collection tube 2604, first 2605 and second 2606 sub-containers, and sample collector 2607.

FIG. 27 includes schematics showing an assay assembly 2700 having a sample collector 2701, a base unit 2702, base unit engagement holder 2703, sample collection tube 2704 comprising a first 2705 and second 2706 sub-container, a testing cartridge 2707 and a sealing gasket 2708 that goes around the perimeter of the testing cartridge 2707 in the sample collection tube 2704.

FIGS. 28A-28B include schematics showing a first sub-container 2801 having a break-away tab 2802 at its base, and the operative coupling of the sample collector to the sample collection tube (FIG. 28B).

FIG. 29 includes schematics showing a pressurizing element 2901 (e.g., rubber stopper) and the handle 2902 of the sample collector. It also shows exemplary alignment features 2903 on the first sub-container, which prevent rotation of the first sub-container in the sample collection tube, e.g. ribs and/or slots on the first sub-container.

FIG. 30 includes schematics showing a base unit 3001 with an alignment feature 3002 and a sample collection tube 3003 with a mateable tab 3004 to facilitate accurate positioning of the sample collection tube in the base unit engagement holder in the third stable state. The base unit engagement holder 3005 shown also includes molded detents 3006.

FIG. 31 includes a base unit engagement holder 3101 having gaps 3102 and keying features on the sample collection tube 3103 for operative coupling of the sample collection tube to the base unit.

FIG. 32 includes photographs of the components of an assay assembly having a sample collection tube 3201, base unit 3202 and sample collector 3203.

FIGS. 33A and 33B include a schematic and photographs showing an assay assembly having a sample collection tube 3301 and base unit 3302, wherein the base unit engagement holder 3303 utilizes detents for the operative coupling of the sample collection tube 3301 to the base unit 3302.

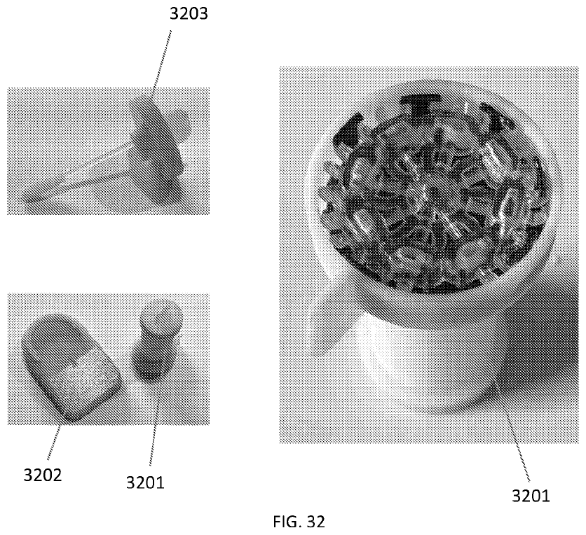

FIG. 34 includes cross-sections of an assay assembly having a sample collection tube 3401, base unit 3402, a sample collector 3403 with a twist-on cap. It illustrates the translation of the first sub-container in the direction of the puncturing element 3404 during operative coupling of the sample collector 3403 to the sample collection tube 3401 and the subsequent breaking of a break-away tab.

FIGS. 35A-35B include cross-sections of a sample collection tube 3501 comprising a first sub-container 3502, a second sub-container 3503 and test cartridge 3504. FIG. 35A shows a sample collection tube configured to allow for the escape of one or more gases through the selective venting elements 3505 into the second sub-container. FIG. 35B is a sample collection tube that further comprises a skirt 3506 and is configured to allow escape of one or more gases through the selective venting elements 3505 into the sealed skirt 3506.

FIG. 36 includes cross-sections of a cap 3601 (e.g., the cap from a sample collector) having pressurizing components 3602. The pressurizing components are various types of rubber sealing elements.

FIG. 37 includes cross-sections of an assay assembly comprising a sample collector 3701 with a twist-on cap 3702, wherein the sample collector 3701 further comprises a pressurizing element 3703. FIG. 37 shows the operative coupling of the sample collector to the sample collection tube 3700, which translates the first sub-container 3704 in the direction of the puncturing element 3705 and breaks the breakable seal 3706.

FIGS. 38A and 38B include cross-sectional photographs of a sample collection tube 3801 (i) without agitator features (sample collection portion 3803 is visible) and (ii) with four agitator features 3802, respectively.

FIG. 39 includes cross-sectional photographs of sample collection tubes 3901 having various numbers of agitator features 3902, as described in Example 1.

FIG. 40 includes a cross-sectional photograph of a sample collection tube that is a concave agitator tube, as described herein.

FIG. 41A includes a thermal image of a base unit comprising a heating element at steady state during heating. FIG. 41B includes a photograph of a base unit with a thermal interface and electronic display (LEDs shown).

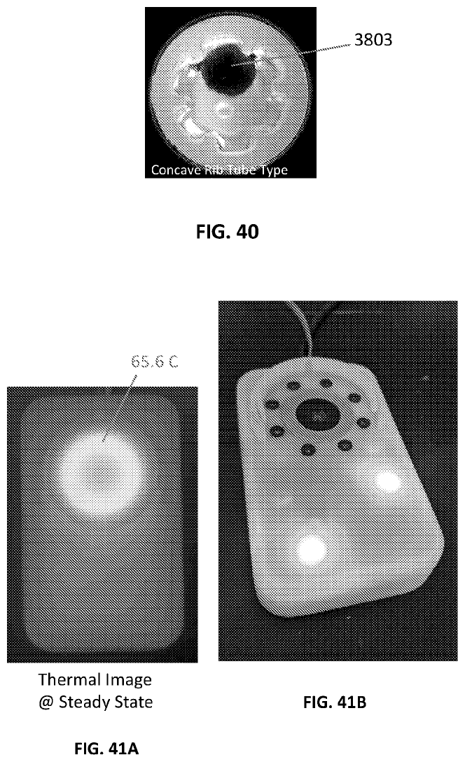

FIG. 42 includes photographs of an exemplar streamlined assay preparation and assembly in a plurality of sequential steps, in accordance with an embodiment.

FIG. 43 includes photographs of an exemplar streamlined assay preparation and assembly in a plurality of sequential steps, in accordance with an embodiment.

FIG. 44 includes photographs of an exemplar streamlined assay preparation and assembly in a plurality of sequential steps, in accordance with an embodiment.

The figures depict various embodiments of the present invention for purposes of illustration only. One skilled in the art will readily recognize from the following discussion that alternative embodiments of the structures and methods illustrated herein can be employed without departing from the principles of the invention described herein.

### DETAILED DESCRIPTION

### I. Definitions

Before the present invention is described in greater detail, it is to be understood that the present disclosure is not limited to particular embodiments described, as such can, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges can independently be included in the smaller ranges and are also encompassed within the invention, subject to any specifically excluded limit in the stated range. Where the stated range includes one or both of the limits, ranges excluding either or both of those included limits are also included in the invention.

In general, terms used in the claims and the specification are intended to be construed as having the plain meaning understood by a person of ordinary skill in the art. Certain terms are defined below to provide additional clarity. In case of conflict between the plain meaning and the provided definitions, the provided definitions are to be used.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Additionally, certain embodiments of the disclosed devices and/or associated methods can be represented by drawings which can be included in this application. Embodiments of the devices and their specific spatial characteristics and/or abilities include those shown or substantially shown in the drawings or which are reasonably inferable from the drawings. Such characteristics include, for example, one or more (e.g., one, two, three, four, five, six, seven, eight, nine, or ten, etc.) of: symmetries about a plane (e.g., a cross-sectional plane) or axis (e.g., an axis of symmetry), edges, peripheries, surfaces, specific orientations (e.g., proximal; distal), and/or numbers (e.g., three surfaces; four surfaces), or any combinations thereof. Such spatial characteristics also include, for example, the lack (e.g., specific absence of) one or more (e.g., one, two, three, four, five, six, seven, eight, nine, or ten, etc.) of: symmetries about a plane (e.g., a cross-sectional plane) or axis (e.g., an axis of symmetry), edges, peripheries, surfaces, specific orientations (e.g., proximal), and/or numbers (e.g., three surfaces), or any combinations thereof.

Some embodiments can be described using the expression “coupled” and “connected” along with their derivatives. For example, some embodiments can be described using the term “coupled” to indicate that two or more elements are in direct physical or electrical contact. The term “coupled,” however, can also mean that two or more elements are not in direct contact with each other, but yet still co-operate or interact with each other. The embodiments are not limited in this context unless otherwise explicitly stated.

“Operatively coupled,” “operatively connected,” and “operatively attached” as used herein means connected in a specific way that allows the disclosed devices to operate and/or methods to be carried out effectively in the manner described herein. For example, operatively coupling can include removably coupling or fixedly coupling two or more aspects (e.g., the sample collection tube and the test cartridge). Operatively coupling can also include fluidically coupling two or more aspects. For example, in some embodiments, a sample collection tube and test cartridge are operatively coupled in a second stable state. That second stable state allows for fluidic communication between the sample collection tube and the test cartridge (fluidic coupling). Operatively coupling can also include mateably coupling two or more components. In some embodiments, operative coupling refers to the engagement, twisting-together, snapping-on, press-fitting, screwing together, sliding together, etc., of two of more aspects (e.g., the sample collection tube and the test cartridge).

As used herein, the terms “affixed” and “attached” are used interchangeably to a component (e.g., sample collector) being attached, joined, stuck or fastened to another component (e.g., a cap). For example, as described herein, a sample collector cap is a cap having a sample collector (e.g., swab) affixed to it and it can be referred to as a sample collector cap.

As used herein, the terms “comprises,” “comprising,” “includes,” “including,” “has,” “having” or any other variation thereof, are intended to cover a non-exclusive inclusion. For example, a process, method, article, or assembly that comprises a list of elements is not necessarily limited to only those elements but can include other elements not expressly listed or inherent to such process, method, article, or assembly. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “about” can mean within an acceptable error range for the particular value as determined by one of ordinary skill in the art, which will depend in part on how the value is measured or determined, e.g., the limitations of the measurement system. For example, “about” can mean plus or minus 10%, per the practice in the art. In certain embodiments, the term “about” refers to being within manufacturing tolerance levels as known by one of ordinary skill in the art (e.g., AS 1163, EN 10219, ASTM A500 or G3444/G3466 tolerance level standards). Alternatively, “about” can mean a range of plus or minus 20%, plus or minus 10%, plus or minus 5%, or plus or minus 1% of a given value. In case of doubt, encompassed within the term “about” are numbers that are insignificantly different from the stated number. The term “about” may also encompass variations that are within manufacturing tolerance levels. Where particular values are described in the application and claims, unless otherwise stated the term “about” meaning within an acceptable error range for the particular value can be assumed. Also, where ranges and/or subranges of values are provided, the ranges and/or subranges can include the endpoints of the ranges and/or subranges.

In addition, it is noted that, as used herein and in the appended claims, the singular forms “a,” “an,” and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

As used, the term “proximal end” refers to the end of a device or instrument that is nearer to the user or operator. In contrast, “distal end” refers to the end of a device or instrument that is farther away from the user or operator. For example, when a sample collection tube holder operatively couples a sample collection tube and test cartridge in the second stable state, as described herein, the breakable seal in the sample collection tube is on the distal end of the sample collection tube.

A “reagent” can be any chemical, including organic compounds and inorganic compounds and combinations thereof. A reagent can be provided in gaseous, solid, or liquid form, or any combination thereof, and can be a component of a solution or a suspension. A reagent preferably includes fluids, such as buffers useful in methods of detecting analytes (e.g., pathogens) in a sample, such as anticoagulants, diluents, buffers, test reagents, specific binding members, detectable labels, enzymes and the like. A reagent can also include an extractant, such as a buffer or chemical, to extract an analyte from a sample or a sample collection device. In some embodiments, the reagent is lyophilized. For example, a buffer can be used to elute biological components such as cells on or within a sample collector.

In some embodiments, selective venting elements are described as having passively tunable porosity. The phrase “passively tunable porosity,” as used herein, refers to the ability of having a first conformation in which one or more gasses, e.g., air, can pass therethrough, e.g., through pores, and a second conformation in which fluids including the one or more gasses and liquids, such as liquids including a biological sample, are prevented from passing therethrough, e.g., through the pores, and proceeding automatically from the first to the second conformation upon contact with a liquid. Also, in the second conformation, the selective venting elements prevent evaporation of the liquids therethrough, e.g., through the pores. Furthermore, in the second conformation, the selective venting elements can fluidically seal a fluidic passage, e.g., a reaction chamber at an end by covering an opening of the reaction chamber, e.g., a venting opening, and prevent passage of fluid, including evaporation, therethrough. In addition, selective venting elements are configured to proceed from the first conformation to the second conformation passively, e.g., automatically without user interaction, upon contacting one or more liquids, such as liquids including a biological sample, with the selective venting elements or a portion thereof, e.g., a surface, such as a surface forming a wall of a reaction chamber. As such, in some versions, selective venting elements can be self-sealing to liquids and gasses when contacted by a liquid.

Also, as used herein, the term “optical property,” refers to one or more optically recognizable characteristics, such as a characteristic resulting from wavelength and/or frequency of radiation, e.g., light, emitted from an aspect, such as color, fluorescence, phosphorescence, etc. As such an “optical property modifying reagent” is a reagent that alters these optically recognizable characteristics during a reaction.

As used herein a “sample analyzer” can, in various embodiments, be configured to determine, such as by recognizing, one or more characteristics of a sample or aspect thereof. In various embodiments, a sample analyzer is a mobile device, e.g., a hand-held mobile device, such as a cellular telephone and/or a camera.

As used, “sample” can be a fluid sample (e.g., gas or liquid), a biological sample, etc. A “biological sample” is a sample containing a quantity of organic material, e.g., one or more organic molecules, such as one or more nucleic acids e.g., DNA and/or RNA or portions thereof, which can be taken from a subject. In some aspects a biological sample is a nucleic acid amplification sample, which is a sample including one or more nucleic acids or portions thereof which can be amplified according to the subject embodiments.

A sample (e.g. a biological sample) can be collected from a subject. In certain embodiments, a subject is a “mammal” or a “mammalian” subject, where these terms are used broadly to describe organisms which are within the class mammalia, including the orders carnivore (e.g., dogs and cats), rodentia (e.g., mice, guinea pigs, and rats), and primates (e.g., humans, chimpanzees, and monkeys). In some embodiments, the subject is a human. The term “humans” can include human subjects of both genders and at any stage of development (e.g., fetal, neonates, infant, juvenile, adolescent, and adult), where in certain embodiments the human subject is a juvenile, adolescent or adult. While the devices and methods described herein can be applied in association with a human subject, it is to be understood that the subject devices and methods can also be applied in association with other subjects, that is, on “non-human subjects.”

As used herein, the term “user” refers to a human subject.

Any terms not directly defined herein shall be understood to have the meanings commonly associated with them as understood within the art of the invention. Certain terms are discussed herein to provide additional guidance to the practitioner in describing the compositions, devices, methods and the like of aspects of the invention, and how to make or use them. It will be appreciated that the same thing can be said in more than one way. Consequently, alternative language and synonyms can be used for any one or more of the terms discussed herein. No significance is to be placed upon whether or not a term is elaborated or discussed herein. Some synonyms or substitutable methods, materials and the like are provided. Recital of one or a few synonyms or equivalents does not exclude use of other synonyms or equivalents, unless it is explicitly stated. Use of examples, including examples of terms, is for illustrative purposes only and does not limit the scope and meaning of the aspects of the invention herein.

### II. Streamlined Assay Preparation

Aspects of the subject disclosure include assay assemblies for streamlined and/or rapid sample collection and testing. These assay assemblies are useful for the detection of various pathogenic microorganisms. The assay assemblies of the subject disclosure are designed for a streamlined drug testing process from assay set/up and sample collection, to test read-out. In part, this is due to the parallelization of steps in the assay process. In various embodiments, reagent loading, sample elution, and assay initiation has been condensed to a single step. In certain embodiments, the reagents are already packaged in the sample collection tube and/or testing cartridge, streamlining the testing process.

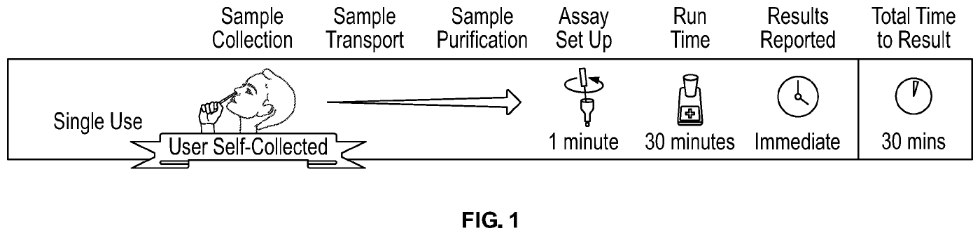

As shown in FIG. 1, the assay assemblies disclosed herein can be used for single-use testing. Biological samples are collected by the user and testing can be performed outside of a laboratory setting (e.g., at home). One advantage of the assay assemblies of the subject disclosure is their reduced set up and run time. The assay assemblies allow the user to bypass conventional sample transportation and purification steps, allowing the user to collect a sample (e.g., swab), set-up the assay assembling, which includes a sample collection tube and test cartridge, introduce the sample to the reagent in the sample collection tube holder, run the test for a shortened length of time (e.g., less than 30 minutes). The user also gets an immediate test result. This streamlined assay design allows for rapid assay set up (e.g., less than 1 minute). Overall, this streamlined assay design allows for rapid preparation and testing, and can be limited, for example, to a total preparation and testing time of 30 minutes or less.

In some embodiments, the total preparation and testing time is up to 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 minutes. In some embodiments, the total testing time is less than 10, 15, 20, 25 or 30 minutes. In some embodiments, the total testing time is up to 2, 3, 4, 5, 6, 7, 8, 9, 10, 11, 12, 13, 14, 15, 16, 17, 18, 19, 20, 21, 22, 23, 24, 25, 26, 27, 28, 29, or 30 minutes. As used, testing time can refer to time from insertion of the sample collector (e.g., swab) into the sample collection tube to first result display.

The biological sample can be obtained using any appropriate vehicle for use to transfer the sample onto a sample collector or directly into a sample collection tube. The “sample collector” as used herein, can be a rod, spoon, spatula, knife, brush, cup, tube, or fabric, but is preferably a swab. In one embodiment of the invention, a swab is used to collect a biological sample (e.g. blood, urine, nasal swab, nasopharyngeal swab, mid-turbinate swab, fecal sample, vaginal swab, tears, fluid excreted at wound sites or sites of inflammation, or any other clinical material that contains nucleic acids or proteins). As one of skill in the art will appreciate, the biological sample can be obtained by means other than a swab, e.g., by a syringe or a collection vessel. The swab used can be a standard swab, or a swab designed specifically for the device. The swab can also include a stopper on its handle to guide the user on the depth for adequate sample, for example, in the nasal cavity. The stopper can also serve as a safety feature to ensure that the sample collector is not inserted too far into an orifice.

The devices and assay assemblies described herein are useful as portable, disposable, inexpensive devices that have applications across a broad range of disciplines and sectors. The disposable device components keep manufacturing and product costs low. The single use of the disclosed devices obviates the need for cleaning the device after use and minimizes the risk of contaminating new samples, as seen in reusable devices. Following use, the device can be disposed of using protocol established to avoid the spread of infection.

The assemblies of the subject disclosure are suited for rapid deployment of testing equipment, decentralized testing, telemedicine, and wide-spread accessibility. Unlike conventional testing devices, the assemblies disclosed herein do not require a skilled clinician/technician, making them ideal at-home testing devices.

One use of the assay assemblies herein is the rapid detection of pathogenic microorganisms. In preferred embodiments, this assay assembly is used for the rapid detection of SARS-CoV-2. The assay assembly can be used to detect pathogenic microorganisms such as, but not limited to, Escherichia coli, Listeria monocytogenes, Clostridium difficile, Mycoplasma pneumonia, Chlamydia pneumoniae, Chlamydia trachomatis, Chikungunya virus, Legionella pneumophilia, Neisseria gonorrhea, Streptococcus, Herpes, papillomavirus, Staphylococcus, Methicillin-resistant Staphylococcus aureus (MRS A), Influenza virus, Respiratory Syncytial Virus, Norovirus, West Nile Virus, Dengue Virus, SARS-CoV, SARS-CoV-2, Ebola virus, Lassa fever virus, Tuberculosis, HIV or Middle East respiratory syndrome coronavirus.

One application of the assay assemblies herein is as an at-home testing assembly for pathogenic microorganisms (e.g., respiratory infections including SARS-CoV-2). This device can also be used for real-time surveillance and outbreak control in large populations. In addition, it can be used for respiratory virus testing of passengers embarking or disembarking transportation vehicles (e.g., planes, trains, coach buses). The assay assemblies can be used as at-home testing for sexually transmitted diseases (e.g., chlamydia). Women can take a vaginal swab, which is highly sensitive for Chlamydia detection, and use the device for analysis. Additionally, the present assay assemblies are particularly useful to detect infectious disease in resource-poor settings without access to a central laboratory for molecular testing. The assay assemblies can be useful for testing surfaces in food-processing plants for Listeria or E. coli contamination. The assay assemblies can be used for real-time contamination monitoring in food-processing plants and to ensure sterilization during cleaning processes, and to prevent food-associated outbreak of gastrointestinal diseases. Another application of the devices herein is the detection of disease in animals, such as porcine-respiratory virus in pigs by veterinarians, which severely affects the porcine industry.

Various diagnostic mechanisms are contemplated in these streamlined assay assemblies. In certain embodiments, the test cartridge is utilized (and comprises reagents) for molecular diagnostics (e.g., Reverse transcription polymerase chain reaction (RT-PCR), reverse transcriptase loop-mediated amplification (RT-LAMP), etc.). For example, in certain embodiments, the test cartridge is utilized for molecular diagnostics, e.g., wherein the a disease or an infection is identified by the nucleic acid of the pathogen (e.g., RNA, DNA) or biological markers (e.g., cell surface markers) associated with the infection or disease, mutations associated with the disease, etc. In certain embodiments, the test cartridge is utilized (and comprises reagents) for immunologic diagnostics or antigenic diagnostics. For example, in certain embodiments, the test cartridge is utilized for immunoserologic diagnostics, e.g., wherein a disease or an infection is indicated by the in vitro detection of immunoglobulins, host antibodies specific for surface and internal antigens of the pathogen and/or produced by an infected host.

In certain embodiments, the streamlined assay assemblies described herein utilize molecular diagnostic techniques (e.g., RT-PCR), thereby allowing for rapid pathogen or disease detection and results that emulate those obtained using the current gold standards for diagnosing the infections or diseases of interest.

In some embodiments, these devices can perform any suitable type of isothermal amplification process, including, for example, Loop Mediated Isothermal Amplification (LAMP), Nucleic Acid Sequence Based Amplification (NASBA), which can be useful to detect target RNA molecules, Strand Displacement Amplification (SDA), Multiple Displacement Amplification (MDA), Ramification Amplification Method (RAM), or any other type of isothermal process.

The assays disclosed herein are useful for at-home testing applications. They are designed for portability and single-use. They are manufactured at a low cost and at high throughput. In some embodiments, the assay assemblies weigh less than 1 pound. In some embodiments, the assay assemblies weigh less than about 0.5 lb., about 0.6 lb., about 0.7 lb., about 0.8 lb., about 0.9 lb., about 1 lb., about 1.1 lb., about 1.2 lb., about 1.3 lb., about 1.4 lb., about 1.5 lb., about 1.6 lb., about 1.7 lb., about 1.8 lb., about 1.9 lb. or about 2.0 lb. In some embodiments, all linear dimensions of the assay assembly are less than 5 inches in length. In some embodiments, all linear dimensions of the assay assembly are less than about 4 in., about 4.1 in., about 4.2 in., about 4.3 in., about 4.4 in., about 4.5 in., about 4.6 in., about 4.7 in., about 4.8 in., about 4.9 in., about 5 in., about 5.1 in., about 5.2 in., about 5.3 in., about 5.4 in., about 5.5 in., about 5.6 in., about 5.7 in., about 5.8 in., about 5.9 in. or about 6 in. in length.

The assay assemblies disclosed herein comprise lyophilized reagents. In some embodiments, the lyophilized reagents are in the sample collection tube. In some embodiments, the lyophilized reagents are in the second chamber in the test cartridge. In some embodiments, the assay assemblies have a long shelf-life. For example, some of the assay assemblies have a shelf life of 3 months, 4 months, 5 months, 6 months, 7 months, 8 months, 9 months, 10 months, 11 months, 12 months, 13 months, 14 months, 15 months, 16 months, 17 months, 18 months, 19 months, 20 months, 21 months, 22 months, 23 months, 24 months, 25 months, 26 months, 27 months, 28 months, 29 months, 30 months, 31 months, 32 months, 33 months, 34 months, 35 months or 36 months.

Further contributing to the portability of the assay assemblies, in some embodiments, the assay assemblies are battery powered and comprise batteries.

II.A. Fluidic Coupling in the Assay

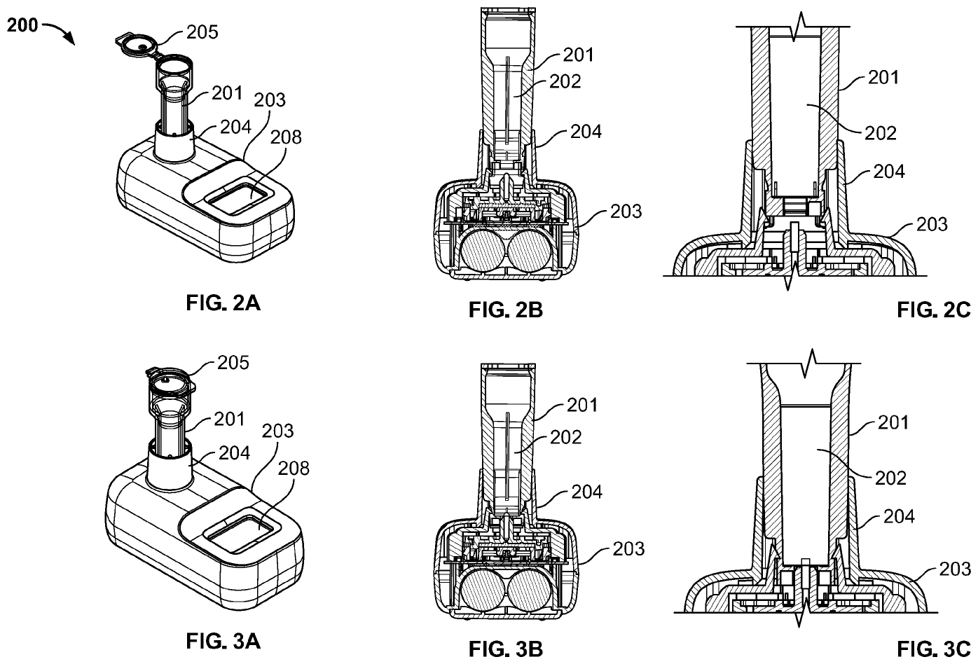

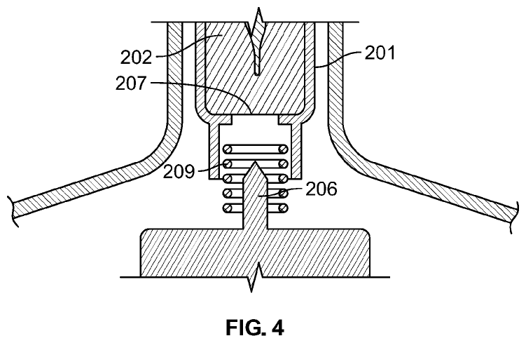

The subject disclosure provides various assemblies for streamlined sample preparation and testing. As shown in FIG. 2A, the assay assembly 200 can comprise (i) a sample collection tube 201 having a first chamber 202 and (ii) a test cartridge 203 having a second chamber and a sample collection tube holder 204. The sample collection tube 201 comprises a cap 205 on its proximal end, according to some embodiments. As shown in FIGS. 2A-3C, the sample collection tube holder 204 is configured to operatively couple the sample collection tube 201 and the test cartridge 203 in (i) a first stable state or (ii) a second stable state. The assembly also comprises a bi-stable locking mechanism having at least one first state and at least one second state. When the bi-stable locking mechanism is in a first state (FIGS. 2B and 2C), the sample collection tube holder 204 operatively couples the sample collection tube 201 and the test cartridge 203 in the first stable state. In this state there is no fluidic communication between the first chamber 202 of the sample collection tube 201 and the second chamber of the test cartridge 203. When the bi-stable locking mechanism is in a second state (FIGS. 3B and 3C), the sample collection tube holder 204 operatively couples the sample collection tube 201 and the test cartridge 203 in the second stable state. The transition of sample collection tube 201 and the test cartridge 203 from the first stable state to the second stable state allows for fluidic communication between the two chambers. As will be discussed in further detail, the transition of the sample collection tube 201 and the test cartridge 203 to the second stable state is actuated by some user action (e.g., sliding, pushing, snapping, twisting or screwing) on some component of the assay assembly. That action leads to the loading of sample into the test cartridge 203 and initiation of the assay in a single step.

In various embodiments of the subject disclosure, the sample collection tube has agitator features. As used “agitator features” refer to features (e.g., protrusions) on the interior surface of the sample collection tube such as ribs, fins, tabs, ridges, wipers, brushes, or beads. These agitator features improve the sample elution process in the sample collection tube 201 (e.g. swab elution). When the sample collector head contacts these agitator features, additional sample is released into the reagent in the sample collector tube. In certain embodiments, the first chamber of the sample collection tube contains agitator features such that the volume of the first chamber of the sample collection tube is agitated by the agitator features during mixing with the sample collection portion of the sample collector. In certain embodiments, the sample collection portion of the sample collector is offset from an axis of rotation of the twist-on cap such that as it rotates around the tube it interacts with agitator features such that the sample collection portion of the sample collector agitates is agitated by the agitator features during mixing with the sample collection portion of the sample collector.

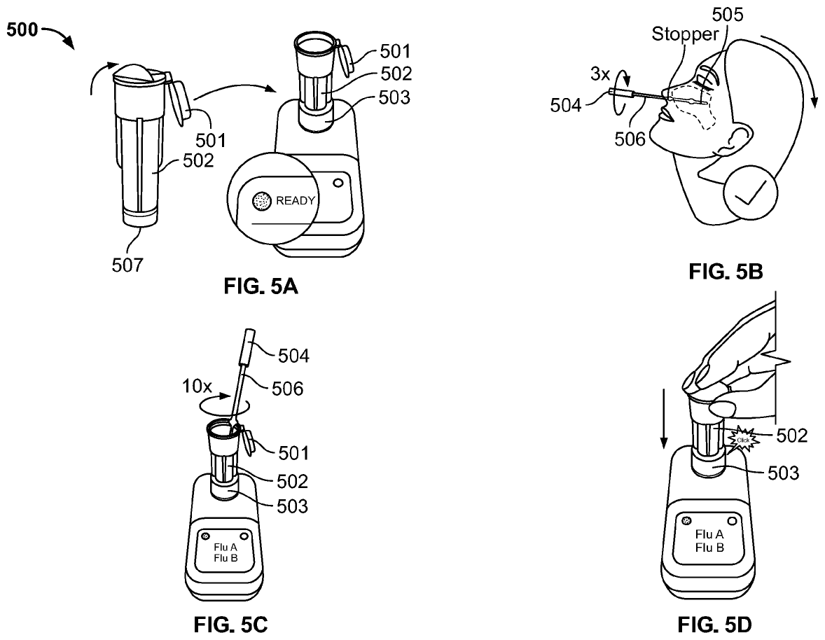

In some embodiments, the test cartridge 203 comprises: (i) a puncturing element 206 and the sample collection tube 201 comprises a breakable seal 207 on its distal end or (ii) an actuable valve on the distal end of the sample collection tube 201. In the first stable state, the puncturing element 206 and breakable seal 207 are not in (and have not made) contact (FIGS. 2B and 2C) or the valve has not been actuated and thus there is no fluidic communication between the sample collection tube 201 and the test cartridge 203. In the second stable state, the puncturing element 206 breaks the breakable seal 207 or the breakable valve is actuated, allowing the flow of the sample in the sample collection tube 201 into the test cartridge 203 (fluidic communication between the sample collection tube 201 and test cartridge 203) and initiation of the assay. In some embodiments, as shown in FIG. 4, a spring 209 is attached to the test cartridge 203, the sample collection tube holder 204 of the test cartridge or sample collection tube 201, and the spring 209 maintains the sample collection tube holder in a first stable state until, for example, force is applied on the spring as the sample collection tube holder and test cartridge are transitioned to the second stable state. In some embodiments, the spring is an open-coil spring, helical spring, etc.

As used, the term “breakable seal” refers to a material seal that separates the contents of the first chamber from the second chamber. It is a seal that can be punctured, ruptured, broken, torn, pierced or penetrated once the puncturing element is brought into direct contact with the seal under sufficient force. As used herein, the breakable seal being “broken” refers to any one of these means for breaking the breakable seal, e.g., piercing, tearing, penetrating, rupturing, etc. As one of skill in the art will appreciate, the breakable seal can comprise one or more materials selected from the group including, but not limited to, foil (e.g., aluminum foil), plastics, foil-plastic laminates (e.g., plastic-backed foil), rubbers, membrane, polymer, paper, and cellophane. In certain embodiments, the breakable seal comprises perforations marks (e.g., at the site at which the puncturing element is brought into direct contact with the seal) for puncturing, rupturing, breaking, tearing, piercing or penetrating of the breakable seal. In certain embodiments, the presences of the perforation marks on the allows for a clear puncture of the breakable seal with repeatable geometry and, in certain embodiments, without deformation of the puncturing element. In certain embodiments, this allows for bubble-free puncturing, as described herein.

In some embodiments of the present disclosure, rather than having a breakable seal at its base (bottom), the sample collection tube, first chamber, or first sub-container (receiving the sample collector) has a base that is scored to allow for breaking when pressure is applied. In some embodiments, a small area on the base of the sample collection tube, first chamber, or first sub-container has circular scoring.

As used, the term “puncturing element” refers to a material that can rupture, pierce, puncture, tear or break the breakable seals described herein upon contact. In the present disclosure, where piercing or puncturing of the breakable seal are contemplated, other means to break the breakable seal are also contemplated (e.g., without limitation, rupturing, tearing, penetrating, slicing, cutting, ripping, etc.). Rods, needles, spears, spikes, and lances are non-limiting examples of puncturing elements contemplated in the subject disclosure. In some embodiments, the puncturing element is a hypotube. In some embodiments, the puncturing element is a unibody spike, wherein the puncturing element is molded as part of the sample collection tube or the test cartridge. In some embodiments, the puncturing element 206 is housed within the test cartridge 203. In alternative embodiments, the puncturing element 206 is not housed within the test cartridge 203. The puncturing element 206 can have a blunt tip, such that a surface area of the end of the second portion is orthogonal to the length of the puncturing element. In some embodiments, the puncturing element can have a tapered and/or sharp tip. Also contemplated are rotational puncturing elements, such that rotational movement actuates the rupturing, piercing, puncturing, tearing or breaking of the breakable seal.

In some embodiments of the present disclosure, the assembly can have a valve e.g., an actuable valve or a reversibly actuable valve. Such a valve may be incorporated in the device at the same location but instead of a breakable seal. As used the term “valve” refers to a device component that allows for passage of fluids when it is actuated (on) and blocks the passage of fluid when it is not actuated (off). Non-limiting examples of valves include check valves, ball valves, butterfly valves, clapper valves, choke valves, diaphragm valves, solenoid valves, valve sequencers, multiway valves, and other suitable valves and similar devices.

In various embodiments, the assembly, including the sample collection tube and the test cartridge, comprises one or more materials including, for example, medical plastics, polymeric materials (e.g., materials having one or more polymers including, for example, plastic and/or rubber), synthetic polymer (e.g., thermoplastics), glass, and/or metallic materials. Materials of which any of the assembly can be composed include, but are not limited to: polymeric materials, e.g., elastomeric rubbers, such as natural rubber, silicone rubber, ethylene-vinyl rubber, nitrile rubber, ethylene propylene diene monomer (EPDM) rubber, butyl rubber; plastics, such as polytetrafluoroethene or polytetrafluoroethylene (PFTE), including expanded polytetrafluoroethylene (e-PFTE), polyethylene, polyester (Dacron™), nylon, polystyrene, polycarbonate, polypropylene, polyethylene, polyallomer, polycarbonate, polycarbonate/acrylonitrile butadiene styrene (PC/ABS), acrylonitrile butadiene styrene (ABS), cycloolefins, cycloolefin copolymers, high-density polyethylene (HDPE), polyurethane, polydimethylsiloxane (PDMS); adhesives, such as acrylic adhesive, silicone adhesive, epoxy adhesive, or any combination thereof; metals and metal alloys, e.g., titanium, chromium, aluminum, stainless steel, and/or glass.

Various caps are contemplated for use in the assay assemblies described herein. In some embodiments, the cap comprises a sample collector. In certain embodiments, the cap is solid and seals the contents of the sample collection tube when in a close position. In some embodiments, the cap is a vented cap (allowing passage of gases therethrough). In some embodiments, the vented cap comprises a selective venting element. In certain embodiments, the vented cap allows for the passage of gas, but prevents the passage of gases therethrough. Such a cap allows for pressure equalization between sample collection tube and chambers it is, e.g., in fluidic communication with, pressure equalization when the cap is closed, and pressure equalization during all stages of operation of the assembly (e.g., first stable state and second stable state). In some embodiments, the cap is a pressurizing cap (e.g., comprising a pressurizing element), wherein closing the cap on the sample collection tube exerts pressure on the contents of the sample collection tube.

The test cartridge can be made of suitable material, such as glass, ceramics, metals, paper, pressed cardboard, or polymers (e.g., synthetic polymers, e.g., thermoplastics), but preferably comprises a plastic, polymer or copolymer such as those that are resistant to breakage. Non-limiting examples of such materials include polystyrene, polypropylene, polyethylene, polyallomer, polycarbonate, polycarbonate/acrylonitrile butadiene styrene (PC/ABS), acrylonitrile butadiene styrene (ABS), cycloolefins, cycloolefin copolymers, ethylene propylene diene monomer (EPDM) rubber, and silicone rubber. In certain embodiments, the test cartridge material comprises polystyrene. The materials contemplated for the test cartridge are affordable materials, making the assembly disposable and affordable to manufacture in bulk. As shown in FIG. 2A, the test cartridge 203 can comprise a display 208 for the test results. The display 208 can offer a simple read out for the display (e.g., binary readout indicating positive or negative detection). Examples of readouts contemplated for the assemblies disclosed herein include LCD, LED, or mobile connectivity. Additionally, it can comprise one or more of a heater, a filter, additional reagent for the initiation of the assay, an amplification mixture (to enable nucleic acid amplification), microfluidic channels, microfluidic pumps, and one or more batteries.

II.B. Reusable Base Unit and Sample Collection Tube

The present disclosure also provides for assay assemblies wherein the assembly has been separated into a single-use consumable sample collection tube and a separate reusable base unit. This separation allows for simplified workflow and is more-cost effective since the reusable components of the testing device are sealed away from the liquid/assay and amplicon components of the test. The base unit has more complex and more costly components. The base unit is also more challenging and more expensive to manufacture. It allows users to buy and replace the single-use consumable sample collection tube portion of the assembly in large numbers and/or at affordable cost while re-using the base-unit, and in doing so it minimizes risk of contamination between tests since the sample and amplicons remain sealed (e.g., hermetically) sealed away from the base unit.

The base unit as contemplated is easy to clean and reuse relative to pre-existing and disposable testing assay assemblies and devices.

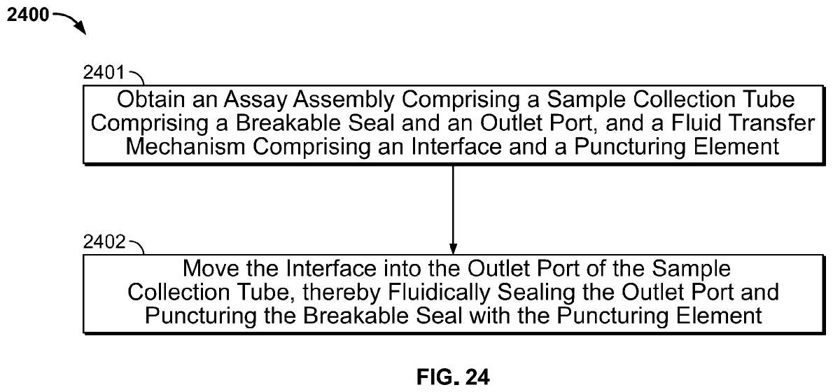

As shown in FIG. 25, in some embodiments, an assay assembly 2500 comprises: (a) a sample collection tube 2501 comprising: a first chamber 2504; a breakable seal 2505 or valve; and a test cartridge 2502 comprising a sample inlet and one or more reaction chambers; (b) a base unit 2503 and (c) a sample collector 2506 comprising (i) a handle 2507 comprising a cap 2508 that is operatively coupleable with the sample collection tube 2501 and (ii) a sample collection portion 2509. The base unit is contemplated as having one or more reusable components. For example, in some embodiments, the base unit comprises a heating element and a power supply. Alternatively, the heating element can be embedded on the sample collection tube (e.g., in a compartment separate from the test cartridge and first chamber of the sample collection tube). In some embodiments, the base unit comprises one or more of the following: a heating element, a power supply, a camera, a printed circuit board, an electronic display, one or more sensors, an audio device, a microprocessor, a timer, wireless signal transmitter, wireless signal receiver, a thermal interface, an electronic interface, a memory chip, one or more light pipes, optical path mirrors, a light source, and a control unit.

With the minimal components contemplated in the sample collection tube, which functions as a single-use consumable, and more complex and costlier components in the base unit, the result is an inexpensive and reliable device capable of nucleic acid (or amplicon) isolation, amplification, and detection without the need for a dedicated laboratory infrastructure. The sample collection tube is contemplated as having most, if not all, the assay components, e.g. buffers, reagents, pellets, primers, etc. The sample collection tube is sealed, one capped, (e.g., hermetically sealed) to prevent contact between liquid components and thermal and/or electrical components. It also prevents amplicon contamination resulting from amplicons contacting the thermal and/or electrical components and any other reusable components described herein or known to those of ordinary skill in the art. Such contamination would adversely affect the accuracy of results after repeated use.

In some embodiments, each of the components described herein as part of the base unit are also contemplated as part of the sample collection tube instead.

In some embodiments, the sample collection tube comprises a filter. In some embodiments, the test cartridge comprises the filter. In some embodiments, the filter allows for concentration of one or more particles of the sample by flowing at least a portion of the prepared nucleic acid amplification sample through the filter.

Heating elements are elements and/or one or more reactants that are configured to generate thermal energy and can be configured for heating one or more reaction chambers and contents thereof, e.g., a biological sample and/or an optical property modifying reagent and/or a nucleic acid amplification composition. The heating element facilitates the generate a reaction product within the test cartridge, e.g., a reaction product including amplified nucleic acids and a plurality of protons. More specifically, in some aspects, the heating accelerates a nucleic acid amplification reaction including a nucleic acid and an amplification composition. Such a reaction generates an amplified nucleic acid and a plurality of protons. As such, the methods of the present disclosure can include reacting a sample with a reagent in a reaction requiring heat, and generating a reaction product. Non-limiting examples of such heating elements include thermoelectric heating elements, e.g., thermoelectric heating elements that include resistive conductors, e.g., thermistors, Peltier devices, or other elements that generate heat.

The heating elements described herein can be configured to elevate the temperature of a reaction chamber and/or contents thereof, e.g., a biological sample, by 1° C. or more, 5° C. or more, 10° C. or more, 15° C. or more, 25° C. or more, 50° C. or more, or 100° C. or more. Such elements can be configured to increase the temperature of a reaction chamber and/or contents thereof from room temperature, e.g., 21° C., to 59° C., 60° C., 61° C., 62° C., 63° C., 64° C., 65° C., 66° C., or 67° C. and/or within a range from 50-75° C., such as 60-70° C., such as 60-66° C., in 10 minutes or less, such as in 5 minutes or less, such as in 3 minutes or less, such as in 2 minutes or less. For example, a heating element can be configured to increase the temperature of a reaction chamber and/or contents thereof from room temperature to 63° C.±1° C. in 3 minutes or less and/or can be configured to maintain such a temperature for 30 minutes or more. Heating elements can also be configured to maintain the temperature of a reaction chamber and/or contents thereof for a period of time such as 2 hours or more or 2 hours or less, such as 1 hour or less, such as 30 minutes or less, such as 15 minutes or less. Such a temperature can be maintained at, for example, 59° C., 60° C., 61° C., 62° C., 63° C., 64° C., 65° C., 66° C., or 67° C. and/or within a range from 50-75° C., such as 60-70° C., such as 60-66° C. Maintaining such a temperature can be performed by applying a thermistor as a heating sensing element and/or can be based on sensor feedback to a control unit. Heating elements can be configured to elevate the temperature of a reaction chamber and/or contents thereof, repeatedly, e.g., heat the contents a first time and then a second time. The subject heating elements also can heat the contents of a reaction chamber so that an optical property modification and/or nucleic acid amplification occurs. Furthermore, the subject heating elements also can heat contents to perform thermo-cycling for amplification reactions, such as PCR.

A “power supply” as used herein, refers to a device that supplies electric power to an electrical load. As such, in some aspects, power supplies can include, for example, one or more battery, direct current (DC) power supply, alternating current (AC) power supply, linear regulated power supply, switched-mode power supply, programmable power supply, uninterruptible power supply, high-voltage power supply and/or a voltage multiplier. The amount of power, current and/or voltage capable of being provided by a power supply can, for example, be equivalent to that required to power the heating elements to generate heat according to the subject embodiments and/or other elements described herein, e.g., one or more controller, to provide their described functions. A power source can, in some aspects, be one or more battery, e.g., a portable and/or self-contained and/or replaceable battery and/or rechargeable battery, such as one or two AA batteries, an outlet, or another source of electrical power. In some embodiments, the power supply can include a USB port for supplying USB power. In some embodiments, a power supply can include one or more electrical cords, e.g., cords configured to operatively connect a device to an outlet. Cords of power sources can be configured to removably connect to a device and/or an outlet.

A camera in the base unit can be used to capture images of the reaction chambers or an electronic display. The camera can be implemented as, for example, a charge-coupled device (CCD) camera, a photo diode (PD) camera, a complementary metal-oxide semiconductor (CMOS) camera, or the like. The camera may be a still-capture or video camera.

A control unit, can include a camera control. Such a control can evaluate camera hardware to ensure appropriate parameters, e.g., resolution and/or shutter speed, to obtain a quality image, such as a clear and/or easily-readable image. A control unit may also function as a communication unit conveying information or images from the base unit to a remote source (e.g. a server or mobile device). It can utilize a short-range wireless communication method such as the display device 29 and Wi-Fi direct, Bluetooth, Zigbee, 6LoWPAN (Low Power Wireless Personal Area Network). Other means for remote communication from the control unit are known to those of ordinary skill in the art.

The printed circuit board (PCB), as used herein, can be composed, for example, of a layer of Silicon and/or Copper and/or Gold and/or Aluminum contacts therein or thereon. A PCB can include a dielectric substrate having an electrically conductive layer, e.g., a wiring layer, on one or more surfaces. Additional non-limiting examples of PCBs are known to those of ordinary skill in the art and can include (i) motherboards for mounting and interconnecting computer components; (ii) printed wiring boards; and (iii) personal computer (PC) cards and similar devices.

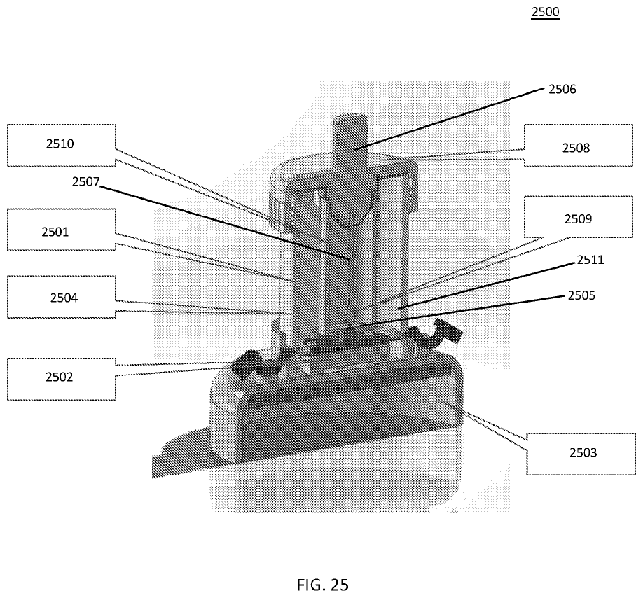

In some embodiments, the base unit comprises an electronic display 2602. The electronic display may be, for example, a liquid crystal display (LCD), organic light emitting diode (OLED) display, electronic paper display, or one or more individual light emitting diodes (LEDs), among other types of displays. The electronic display may provide one or more results for presentation on an electronic readout or analysis of one or more properties (e.g., optical, color, or geometric) of at least one reaction chamber within the optical property modifying device. The electronic display may provide a result using human-readable symbols (e.g., alphanumeric characters or graphics) or machine-readable symbols (e.g., a barcode or QR code). See FIG. 26.

In some embodiments, the base unit comprises a reader (e.g., scanner) of human-readable symbols (e.g., alphanumeric characters or graphics) or machine-readable symbols (e.g., a barcode or QR code). For example, in some embodiments the base unit comprises a QR code reader or barcode reader to identify different cartridge (sample collection tube) types or different types of sample collection tubes. This would allow multiplexing with different cartridge types and flexibility in the use of the reusable base to test for different types of diseases or conditions, detect different types of pathogens that may require different testing parameters (e.g., heating duration, heating schedule and frequency, incubation times, temperature requirements, etc.).

In some embodiments, the base unit comprises a microprocessor for processing data (e.g. images, temperature readings, etc.) and conveying it to the electronic display or conveying it to a remote server. In some embodiments, the base unit comprises one or more control unit, e.g., a central processing unit (CPU) or a field-programmable gate array (FPGA). Such a unit can include a memory and/or a processor, e.g., a microprocessor, configured to generate one or more outputs, e.g., electrical signals, based on one or more sets of inputs, e.g., inputs from a user and/or a sensor, and/or a timer, and/or instructions stored in the memory.

In some embodiments, the base unit comprises an audio device to emit a sound, e.g. at the start of the test and/or when the test is complete (result is ready).

The base unit is also contemplated as having one or more sensors. In some embodiments, a substrate can include one or more sensor, e.g., a plurality of sensors, configured to detect the presence and/or absence of a liquid, e.g., a biological sample, in one or more of the reaction chambers. In some instances the sensors are operatively connected to the control unit and send an input thereto based on a detected presence and/or absence of a sample. For example, a control unit can generate an output which activates a heating element of a device to heat contents, e.g., a biological sample, of one or more reaction chambers by transmitting thermal energy, via a thermal interface between the base unit and sample collection tube, to the reaction chambers when an input from a sensor indicating the presence of a biological sample in a reaction chamber is received. In some versions, the one or more sensors can be configured to detect an optical property, e.g., a wavelength of light, e.g., color, and/or a change in an optical property, such as a wavelength of light emitted from contents of a reaction chamber, e.g., a biological sample.

In some embodiments, the sensor is a temperature sensor. In some embodiments, the sensor is a light sensor. Non-limiting examples of potential sensors include position sensors (e.g., global positioning system (GPS) sensors, mobile device transmitters that enable position triangulation), visual sensors (e.g., cameras capable of detecting visible, infrared or ultraviolet light), proximity sensors, inertial sensor (e.g., accelerometer, gyroscope, inertial measurement device (IMU)), altitude sensor, pressure sensors, audio sensors (e.g., microphones) or electromagnetic field sensors (e.g., magnetometers, electromagnetic sensors).

In some embodiments, the sensor(s) facilitates detection of the presence or absence of the sample in one or more reaction chambers. Further where the base unit or sample collection tube includes a heating element, the methods can include heating a sample in the one or more reaction chambers when a sensor detects sample in the one or more reaction chambers. Heating a sample can be performed in any of the amounts which a heating element is configured to do so, as is described herein. Also, in some versions, the devices include a light and the methods include emitting light with the light source when the sensor detects the sample in the one or more reaction chambers. This streamlines the testing further by allowing the reaction to begin as soon as operative coupling occurs between the first chamber of the sample collection tube and the test cartridge, and the sample (or reaction mixture) enters the reaction chambers.

Potential light pipes and light sources are known to those of ordinary skill in the art and examples are provided in U.S. Pat. No. 10,549,275, the disclosure of which is herein incorporated by reference in its entirety. In some embodiments, the base unit comprises a plurality of LEDs and a photodiode. In some embodiments, the base unit comprises 8 LEDs and a photodiode.

In some embodiments, the surface of the base unit comprises a thermal interface to allow transfer of heat from the heating element to the reaction chambers in the sample collection tube. In some embodiments, the base unit comprises metal rings and thermal pads for the transmission of heat. In some embodiments, the base unit comprises a spring feature for heating element compliance. In some embodiments, the surface of the base unit comprises an electronic interface. In some embodiments, the base unit (e.g. surface of base unit) comprises a thermally conductive metal insert. In some embodiments, the heating elements, and optionally a temperature sensor, are on the sample collection tube and the surface of the base unit comprises an electronic interface. This electronic interface could be used to relay information about the cartridge (sample collection tube) (e.g., type, serial number, expiration date, etc.), in a similar manner to the QR code, camera, and scanner. It could also be used to power the heating element, to detect light sources (e.g., LEDs), send or receive signals from a sensor, e.g., in the case of a consumable sample collection tube that has some integrated electronic elements. In such embodiments, the placement (e.g., embedding) of the heating elements on the sample collection tube can facilitate highly reproducible thermal coupling, rapid temperature equilibrium and faster assay completion time. See, for example, U.S. application Ser. No. 16/678,973, the disclosure of which is herein incorporated by reference in its entirety.

In some embodiments, the interface between the sample collection tube and the base unit (e.g., on the surface of the base unit) is entirely electronic. In some embodiments, the interface between the sample collection tube and the base unit (e.g., on the surface of the base unit) is entirely thermal. In some embodiments, the interface between the sample collection tube and the base unit (e.g., on the surface of the base unit) is a combination of thermal and electronic.

In some embodiments, the base unit and/or the sample collection tube comprise magnetic components or a magnet. These can facilitate the operative coupling of the sample collection tube to the base unit.

Other components contemplated in the base unit are discussed for example in U.S. application Ser. No. 16/081,793, the disclosure of which is herein incorporated by reference in its entirety.

II.B.1. Sub-Container

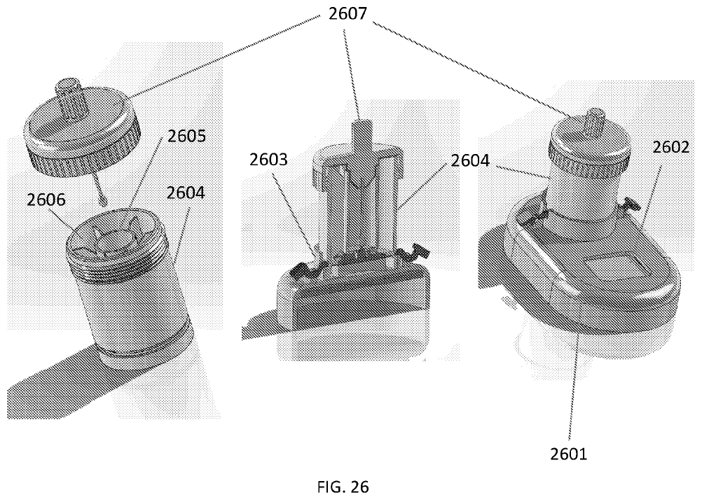

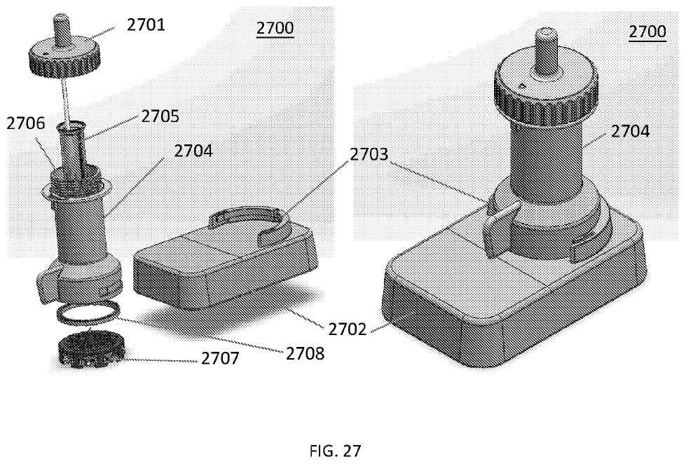

In embodiments, as shown in FIGS. 25-27, the first chamber of the sample collection tube comprises a first sub-container 2510 and a second sub-container 2511, wherein the first sub-container and the test cartridge are sealed from one another by a breakable seal 2505. Alternatively, the base of the first sub-container can be without a breakable seal and instead have a break-away tab 2802, which is a portion of the base of the first sub-container that has been weakened (e.g., by scoring) such that the application of force on the break-away tab breaks the tab and allows for fluidic communication (FIGS. 28A-28B). The first sub-container is positioned within second sub-container. In some embodiments, when the sample collector is operatively coupled to the sample collection tube in the second stable state, the sample collection portion of the sample collector, which is located within the first sub-container, translates down into the first sub-container and breaks the breakable seal or the break-away tab, thereby placing the first sub-container in fluidic communication with the test cartridge of the sample collection tube. Alternatively, the first chamber or first sub-container translates down in the direction of a puncturing element and once the puncturing element contacts and applies force to the break-away tab, it breaks.

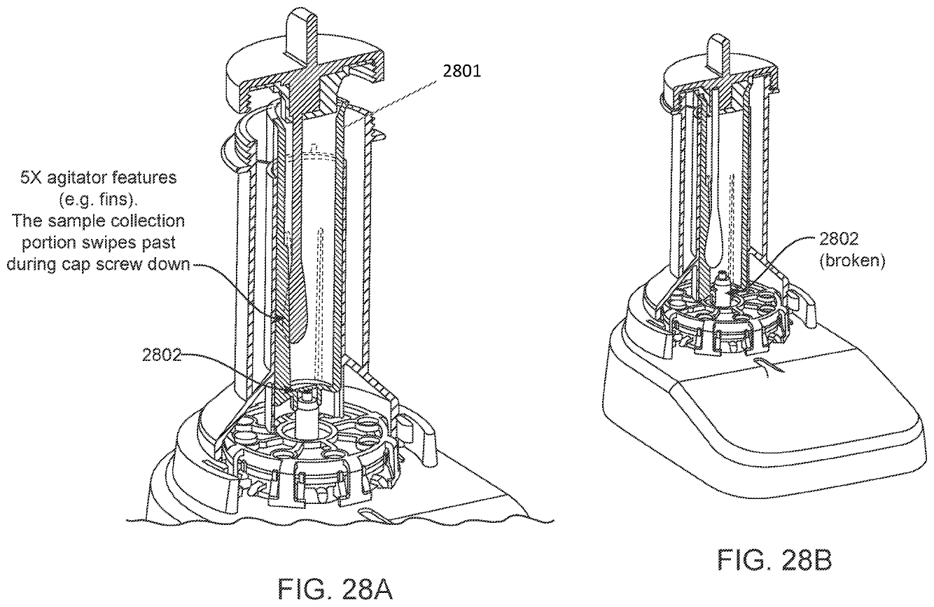

In some embodiments, the first sub-container comprises alignment features 2903 and the inside of the second sub-container comprises mateable features (e.g., gaps or slots) that are mateable with alignment features in order to prevent rotation of the first sub-container during operative coupling of the cap and sample collection tube (e.g. twist the cap) or at any other point once the first sub-container and the test cartridge are in the second stable state. Also resulting in similar advantages, in embodiments, the inner surface of the second sub-container has alignment features and the outer surface of the first sub-container comprises mateable features (e.g., gaps or slots) that are mateable with alignment features. See FIG. 29.

In some embodiments, the sample collection tube holder as described herein, is located on the test cartridge within the sample collection tube and is configured to place the first chamber or first sub-container in the first stable state or the second stable state relative to the test cartridge.

In some embodiments, the engagement of the cap and the sample collection tube is irreversible. In some embodiments, the engagement of the first chamber or first sub-container with the test cartridge is irreversible. These reduces indeterminate or erroneous test results and reduces the risk of interrupting or terminating the reaction, once the reaction has been initiated in the test cartridge.

II.B.2. Base Unit Engagement Holder

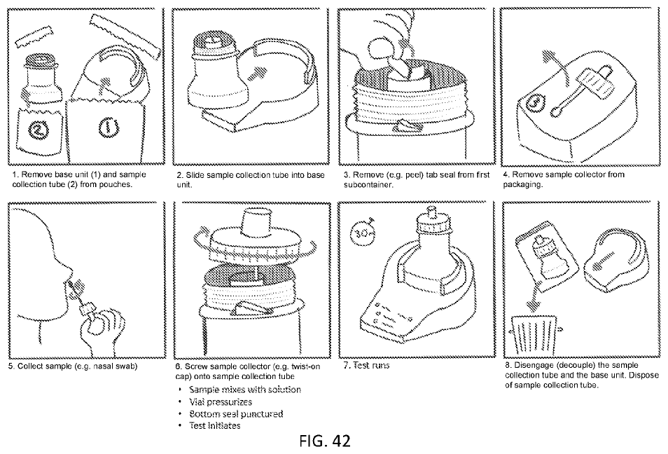

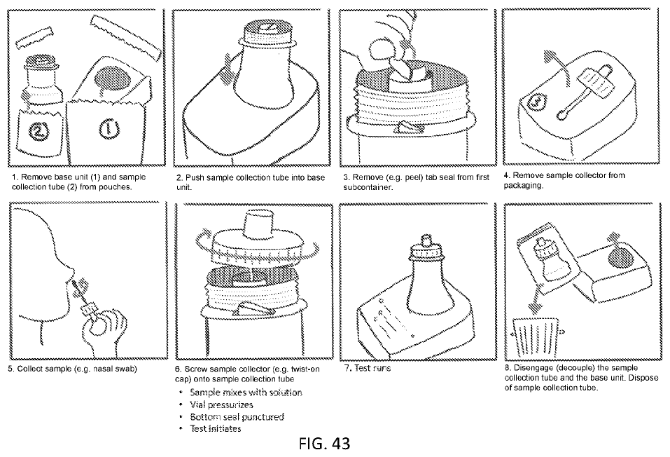

In some embodiments, the base unit comprises a base unit engagement holder, wherein the base unit engagement holder is configured to operatively couple the sample collection tube and base unit in a third stable state. During the second stable state, the base engagement holder holds the sample tube in direct contact or adequately close contact for thermal conductance between the heating elements and reaction chambers, electrical conductance to facilitate heating and power any components on the sample collection tube requiring power, imaging of the reaction chambers in the sample collection tube, operation of the sensors for acquiring the result, accurate reading of the reader. In some embodiments, a user operatively couples the sample collection tube and the base unit in a third stable state prior to operatively coupling the cap and the sample collection tube in the at least one second state. See FIGS. 42 and 43.

In some embodiments, the base unit comprises a heating element and in the third stable state, when the heating element is actively providing heat (steady state), heat is transmitted to the reaction chambers. In some embodiments, the thermal variance between the heating element in the base unit and the reaction chambers is less than 5 degrees Celsius. In some embodiments, the thermal variance between the heating element in the base unit and the reaction chambers is 1 degree Celsius. In some embodiments, the thermal variance between the heating element in the base unit and the reaction chambers is 1, 2, 3, or 5 degree Celsius and temperature values therebetween.

In some embodiments, the base unit engagement holder facilitates close coupling between the sample collection tube to facilitate use of a reader in the base unit. In such embodiments, the base unit engagement holder positions the sample collection tube in close proximity (e.g. less than 1, 2, 3, 4 or 5 mm) to the reader in the base unit.

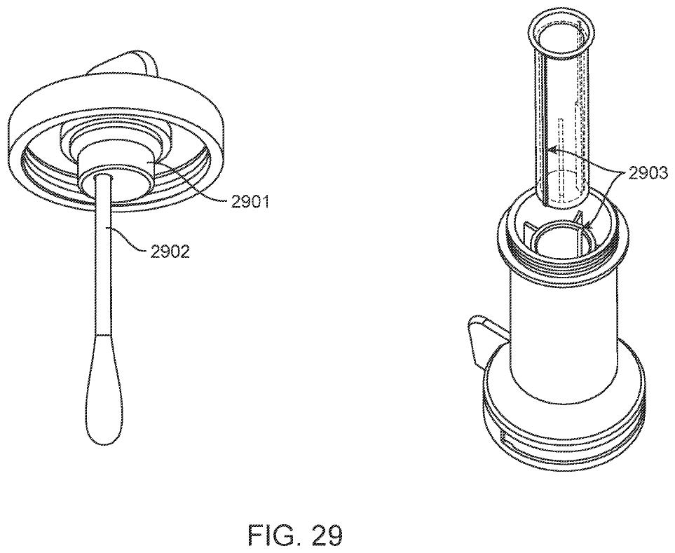

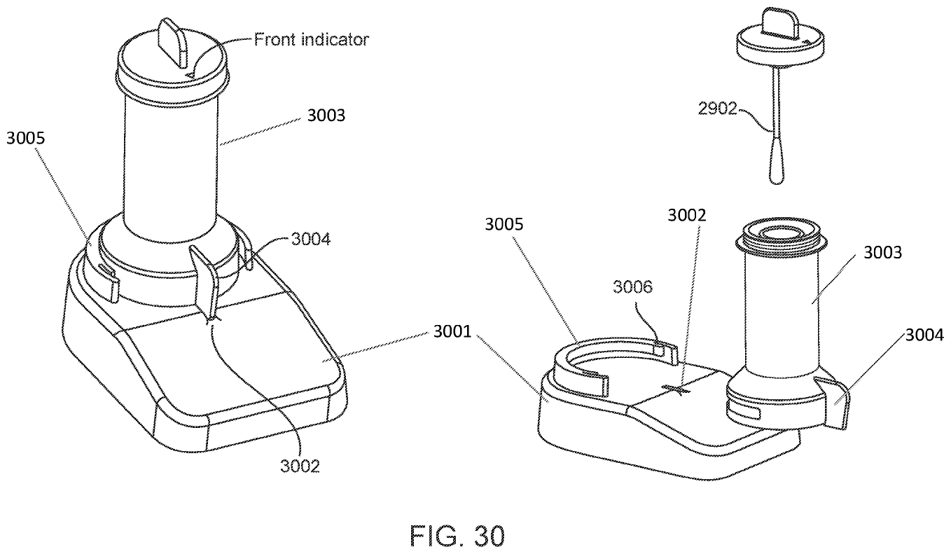

In some embodiments, due to the reusable nature of the base unit, the operative coupling of the sample collection tube and the base unit in the third stable state is reversible. The operative coupling of the sample collection tube and the base unit is contemplated using any one of the engagement means disclosed herein, provided it is reversible (e.g., shelves, shelves with gaps, alignment features on the sample collection tube and/or the base unit, hooks, notches, snap features, cantilever snap features, detents, annular snap features, torsion snap features, slide locks, push locks, key features on the sample collection tube and/or the base unit engagement holder, twist features on the sample collection tube and/or the base unit engagement holder). See FIGS. 30-31.

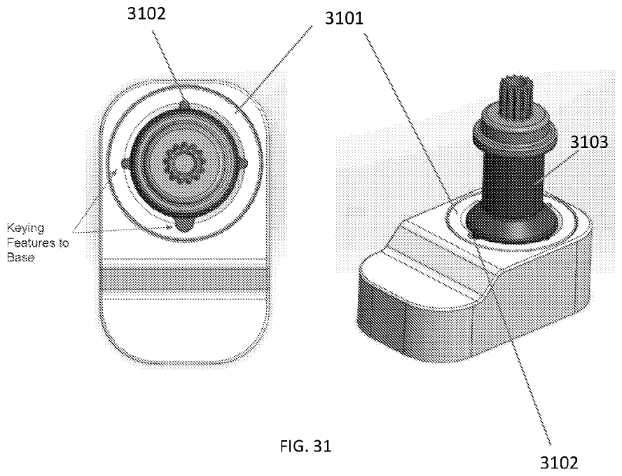

In some embodiments, the base unit comprises an alignment feature and the sample collection tube comprises one or more keying features to facilitate correct alignment of the sample collection tube in the base unit during operative coupling (FIGS. 30 and 32). In some embodiments, the alignment feature prevents rotation of the sample collection tube within the base unit in the third stable state.

II.C. Bi-Stable Locking Mechanisms

In some embodiments, there is a bi-stable locking mechanism having at least one first state and at least one second state, wherein the first state of the bi-stable locking mechanism comprises the sample collection tube holder operatively coupling the sample collection tube and the test cartridge in the first stable state, and the second state of the bistable locking mechanism comprises the sample collection tube holder operatively coupling the sample collection tube and the test cartridge in the second stable state. There is also a fluidic coupling mechanism, wherein responsive to the sample collection tube holder operatively coupling the sample collection tube and the test cartridge in the second stable state, the fluidic coupling mechanism is configured to place the first chamber of the sample collection tube in fluidic communication with the sample inlet of the test cartridge.

Where there is a sample collection tube-base unit assay assembly, a bi-stable locking mechanism is also contemplated as having at least one first state and at least one second state; wherein the first state of the bi-stable locking mechanism comprises the first chamber and the test cartridge coupled in the first stable state. Alternatively, the first state of the bi-stable locking mechanism can be the first sub-container and the test cartridge coupled in the first stable state. The second state of the bistable locking mechanism is responsive to the sample collector being operatively coupled with the sample collection tube and the second state of the bistable locking mechanism comprises the first chamber being operatively coupled to the test cartridge in the second stable state. There is a fluidic coupling mechanism, wherein responsive to the sample collector operatively coupling the first chamber and the test cartridge in the second stable state, the fluidic coupling mechanism is configured to place the first chamber of the sample collection tube (or the first sub-container) in fluidic communication with the test cartridge.

In some embodiments, in the second state of the bistable locking mechanism, where the sample collector operatively couples with the sample collection tube, there is a translation of the first chamber or the first sub-container downwards towards a puncturing element on the test cartridge. The puncturing element then breaks the breakable seal or the break-away tab. The translation can be z-translation, due to threading on the test cartridge and/or the first chamber. The translation can be translation by complete rotations of the first chamber or first sub-container. The translation can be z-translation due to the presence of a shelf feature with one or more gaps on the test cartridge and alignment features on the first chamber or first sub-container. The translation can be facilitated by any one of the engagement means disclosed herein for coupling of the first chamber with the test cartridge.

In some embodiments, in the second state of the bistable locking mechanism, where the sample collector operatively couples with the sample collection tube, the sample collector translates downwards in the first chamber or the first sub-container and applies force on the breakable seal or break-away tab at the bottom of the first chamber or the first sub-container, thereby breaking the breakable seal or break-away tab and allowing for fluidic communication into the test cartridge.

In some embodiments, the bi-stable locking mechanism is irreversible such that the bi-stable locking mechanism cannot transition from the at least one second state in which the sample collection tube and the test cartridge are operatively coupled in the second stable state to the at least one first state in which the sample collection tube and the test cartridge are operatively coupled in the first stable state. This reduces indeterminate or erroneous test results and reduces the risk of interrupting or terminating the reaction, once the reaction has been initiated in the test cartridge. The cap and/or sample collection tube comprise one or more of the following to prevent transition from the at least one second state to the at least one first state: locking detents, snap features, cantilever snap features, annular snap features, torsion snap features, lock-out release arm, ratchet features, sawtooth ratchets, ratchet and pawl features, and the like.

II.C.1. Snap-On Cap

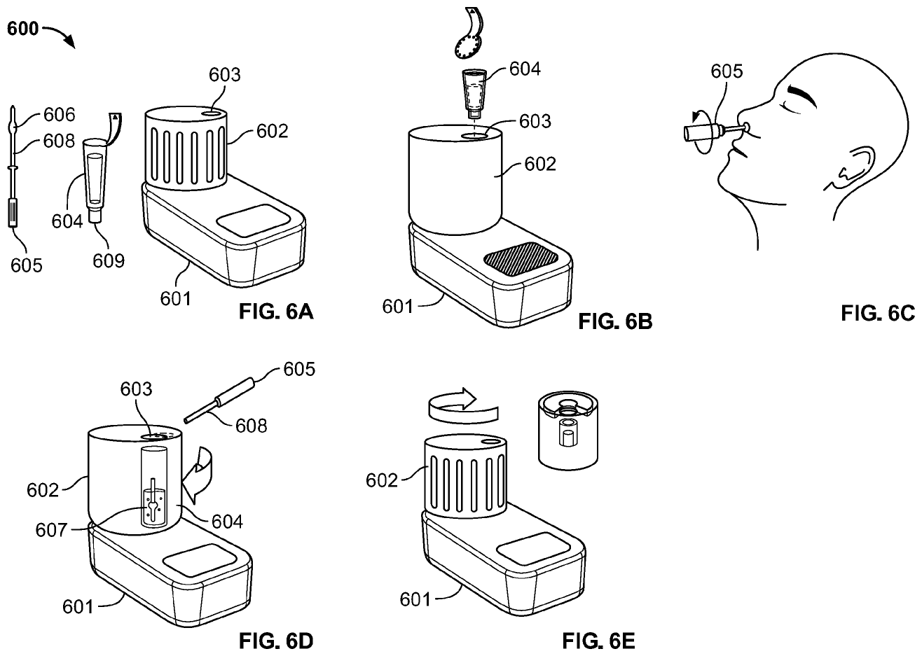

In some embodiments, the bi-stable locking mechanism in the assembly 500 comprises a snap-on cap 501 that is operatively coupleable with the sample collection tube 502. As shown in FIGS. 5A-5D, the sample collection tube 502 can be loaded (inserted) into the sample collection tube holder 503. The sample collection tube 502 can have a snap-on cap 501 on its proximal head and can be filled with reagents. A biological sample is collected a sample collector (e.g., swab). In certain embodiments, the sample collector is a swab 504. In certain embodiments, the user utilizes a swab to collect a nasal sample. The sample collector is then mixed into the reagent in the sample collection tube 502 (sample elution). Once inserted into the reagent, the sample collector 504 undergoes a sufficient number of revolutions and remains in the reagent an adequate duration of time to release a detectable quantity of specimen into the reagent. The mixing of the sample collector 504 can comprise, for example, 10 revolutions of the sample collector head 505 in the reagent of the sample collection tube 502. In certain embodiments, this process is referred to as swab elution. The sample collector 504 can be removed following the elution. Alternatively, in certain embodiments, the handle of the sample collector 506 is breakable, allowing the head of the sample collector 505 to be left inside the sample collection tube 502.

Following the elution of the sample from the sample collector 504 into the sample collection tube 502, the snap-on cap 501 is operatively coupled to the sample collection tube 502. The fluidic coupling mechanism in this assay comprises a breakable seal 507 on the distal end of the sample collection tube and a puncturing element of the test cartridge. At least one first state of the snap-on cap comprises the snap-on cap not being operatively coupled to the sample collection tube, while the at least one second state of the snap-on cap comprises the snap-on cap being operatively coupled to the sample collection tube. This immediately transitions the sample collection tube and the test cartridge from a first stable state, comprising the puncturing element of the test cartridge not breaking the breakable seal of the sample collection tube, to a second stable state comprising the puncturing element of the test cartridge breaking the breakable seal of the sample collection tube, thereby placing the first chamber of the sample collection tube in fluidic communication with the second chamber of the test cartridge.

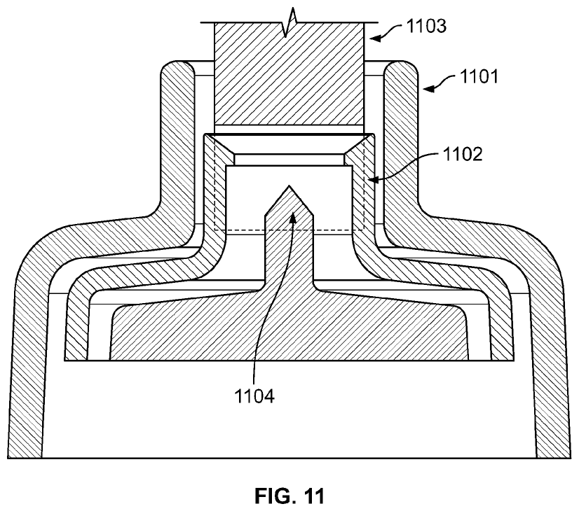

In various embodiments, the terms “loaded” and “loading” refer to the insertion of one component into another (e.g., insertion of a sample collection tube into the sample collection tube holder of the test cartridge). Loading of the sample collection tube into the sample collection tube holder does not initiate the transition from the first stable state to the second state, puncturing of the breakable seal, or initiation of the assay. In various embodiments, the sample collection tubes and sample collection tube holders of the subject disclosure include features that prevent the premature puncturing of the breakable seal or initiation of the assay. These features will be discussed in further detail below with regard to FIGS. 11-14C.

Where there is a sample collection tube-base unit assay assembly, in some embodiments, the coupling of the sample collection tube and the test cartridge in the first stable state comprises: (i) the puncturing element of the test cartridge not breaking the breakable seal of the sample collection tube (ii) the sample collector not breaking the break-away tab or (iii) not actuating the actuable valve; and the operative coupling of the sample collection tube and the test cartridge in the second stable state comprises: (i) the puncturing element of the test cartridge breaking the breakable seal of the sample collection tube (ii) the sample collector breaking the break-away tab or (iii) actuating the actuable valve, thereby placing the first chamber of the sample collection tube in fluidic communication with the test cartridge.

II.C.2. Test Cartridge Twist Feature

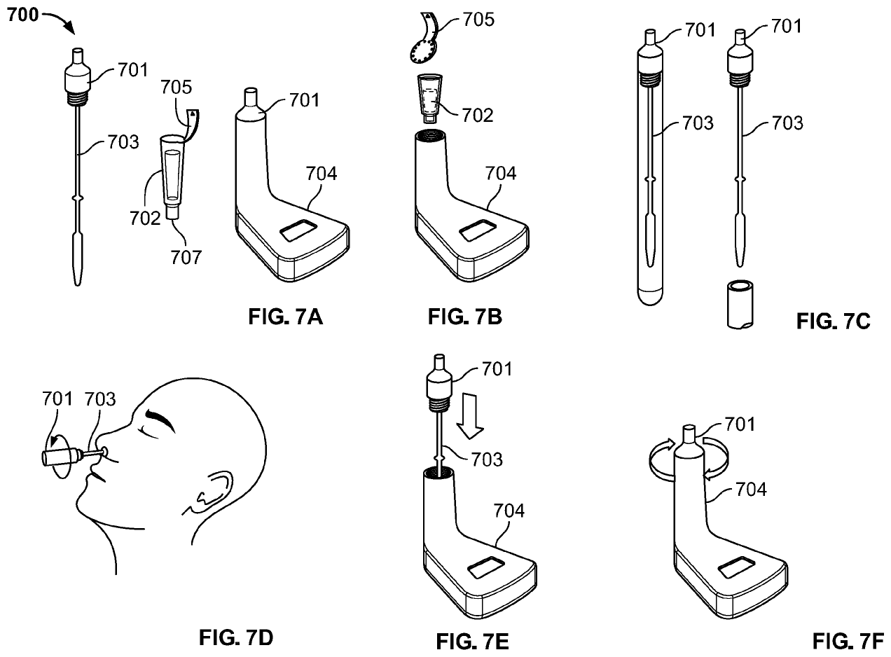

In various embodiments, the bi-stable locking mechanism in the assembly comprises a twist feature on the body of the test cartridge 601. As shown in FIGS. 6A-6E that twist feature can be present in a cap 602 covering test cartridge 601. The test cartridge 601 includes a sample collection tube holder. The cap 602 covering the test cartridge 601 includes an opening 603 that, when aligned with the sample collection tube holder, allows direct access to the sample collection tube holder (FIG. 6B). The opening 603 is aligned with the sample collection tube holder in the first state of the twist feature.

To set up the assay assembly, the sample collection tube 604 is loaded into the sample collection tube holder. A biological sample is collected on a sample collector 605, and the sample collector head 606 is inserted into the reagent 607 in the loaded sample collection tube 604.

As shown, the sample collector handle 608 can be breakable. Movement of the cap (e.g., by rotation or twisting of the cap) transitions the twist feature to a second state and misaligns the opening in the cap and the sample collection tube, effectively breaking the sample collector handle 608 and sealing the contents of the sample collection tube 604. The rotation of the cap translates rotation to linear (vertical) displacement of the sample collection tube 604, operatively coupling the sample collection tube 604 and the test cartridge 601 in the second stable state by puncturing the breakable seal 609 at the distal end of the sample collector. In the second stable state, there is fluidic communication between the sample collection tube 604 and the testing chamber within the test cartridge 601 and the assay is initiated upon user engagement (twisting).

In some embodiments, the cap 602 (e.g., twist-on cap, snap-on cap, etc.) includes a first attachment element and the test cartridge 601 comprises the second attachment element that is operatively coupleable with the first attachment element. In such embodiments, the operative coupling of the second attachment element with the first attachment element (e.g., by threading the cap 602 into the test cartridge 601, or snapping the cap onto the test cartridge, etc.) pushes the sample collection tube 604 towards the test cartridge 601 (e.g., further down into the sample collection tube holder) thereby breaking the breakable seal 609 of the sample collection tube 604, thereby placing the first chamber of the sample collection tube 604 in fluidic communication with the second chamber of the test cartridge 601.

Where there is a sample collection tube-base unit assay assembly, in some embodiments, the fluidic coupling mechanism comprises: (i) a breakable seal of the first chamber or first sub-container and a puncturing element of the test cartridge; (ii) a break-away tab of the first chamber or first sub-container and the sample collector; or (iii) an actuable valve of the first chamber or first sub-container. The at least one first state of the bistable locking mechanism comprises the twist feature not being twisted and the at least one second state of the bistable locking mechanism comprises the twist feature being twisted. The operative coupling of the first chamber or first sub-container and the test cartridge in the first stable state comprises: (i) the puncturing element of the test cartridge not breaking the breakable seal of first chamber or first sub-container; (ii) the sample collector not breaking (e.g., by not contacting) the break-away tab of the first chamber or first sub-container; or (iii) not actuating the actuable valve. The operative coupling of the sample collection tube and the test cartridge in the second stable state comprises: (i) the puncturing element of the test cartridge breaking the breakable seal of first chamber or first sub-container; (ii) the sample collector breaking the break-away tab of the first chamber or first sub-container; or (iii) actuating the actuable valve, thereby placing the first chamber of the sample collection tube in fluidic communication with the test cartridge.

II.C.3. Twist Feature on Sample Collection Tube

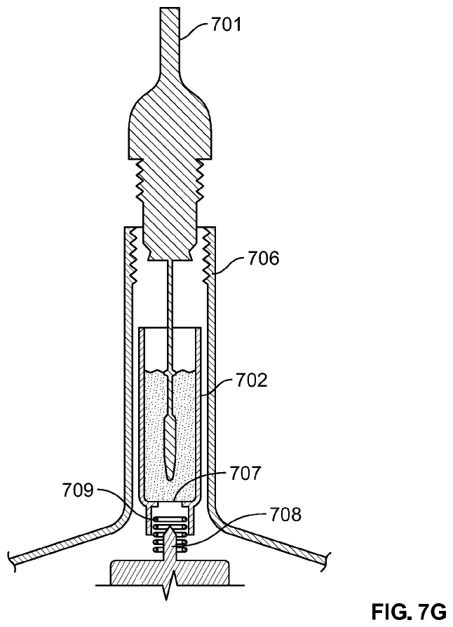

In certain embodiments, the bi-stable locking mechanisms in the assembly 700 comprise a twist-on cap 701 that is operatively coupleable with the sample collection tube 702, as shown in FIGS. 7A-7G. In some embodiments, a cap 701 comprises a sample collector 703. For example, in some embodiments, a sample collector 703 is affixed to the twist-on cap 701. The use of a sample collector 703 affixed to a twist-on cap 701 allows for two-step engagement in the assay: elution of the sample in the sample collector tube 702 and initiation of the assay in the test cartridge 704. The sample collection tube 702 can be packaged with a removable (and disposable) cap or seal 705, which is removed prior or during the loading of the sample collection tube 702 into the sample collection tube holder 706 (FIG. 7B). In various embodiments of the subject disclosure, the twist-on cap 701 can be packaged, for example, as part of a sealed vial or in a sealed container to maintain sterility (FIG. 7C).

To set up the assembly 700, the sample collection tube 702 is loaded into the test cartridge 704. The biological sample is captured on the sample collector 703 by the user. In at least one first state of the twist-on cap 701, the twist-on cap 701 is not operatively coupled to the sample collection tube 702. In at least one second state of the twist-on cap 701, the twist-on cap 702 is operatively coupled to the sample collection tube 702 by rotating or twisting the cap onto the test cartridge 704 or loaded sample collection tube 702. The operative coupling of the sample collection tube 702 and the test cartridge 704 in the first stable state comprises the puncturing element 708 of the test cartridge 704 not breaking the breakable seal 707 of the sample collection tube 702. To transition to the second stable state, the rotation of the twist-on cap 701 translates to the linear (vertical) displacement of the sample collection tube 702. Consequently, the puncturing element 708 of the test cartridge 704 pierces the breakable seal 707 of the sample collection tube 702, thereby placing the first chamber of the sample collection tube 702 in fluidic communication with the second chamber of the test cartridge 704 (FIG. 7G).

Where there is a sample collection tube-base unit assay assembly, in some embodiments, the fluidic coupling mechanism comprises: (i) a breakable seal of the first chamber or the first sub-container and a puncturing element of the test cartridge; (ii) a break-away tab of the first chamber or first sub-container and the sample collector; or (iii) an actuable valve. The at least one first state of the bistable locking mechanism comprises the twist-on cap not being operatively coupled to the sample collection tube and the at least one second state of the bistable locking mechanism comprises the twist-on cap being operatively coupled to the first chamber or the first sub-container. The operative coupling of the first chamber or the first sub-container and the test cartridge in the first stable state comprises: (i) the puncturing element of the test cartridge not breaking the breakable seal of the first chamber or the first sub-container; (ii) the sample collector not breaking (e.g., by not contacting) the break-away tab of the first chamber or first sub-container; or (iii) not actuating the actuable valve. The operative coupling of the first chamber or the first sub-container and the test cartridge in the second stable state comprises: (i) the puncturing element of the test cartridge breaking the breakable seal of the first chamber or the first sub-container; (ii) the sample collector breaking the break-away tab of the first chamber or first sub-container; or (iii) actuating the actuable valve, thereby placing the first chamber of the sample collection tube in fluidic communication with the test cartridge.

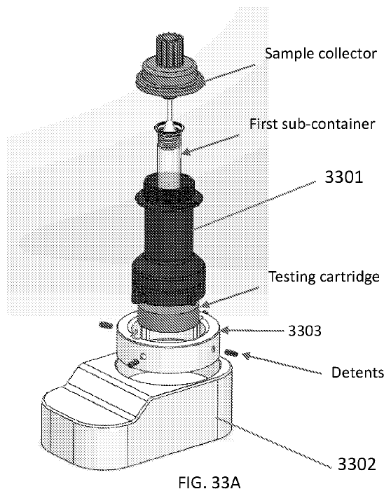

As shown in FIG. 34, when using a twist-on cap, the final rotation(s) can facilitate the translation of the first chamber down towards the puncturing elements. Resultant from the translation there is operative coupling of the first chamber or the first sub-container and the test cartridge in the second stable state, thereby puncturing the break-away tab or breakable seal of the first sub-container.

II.C.4. Key Features on Sample Collection Tube

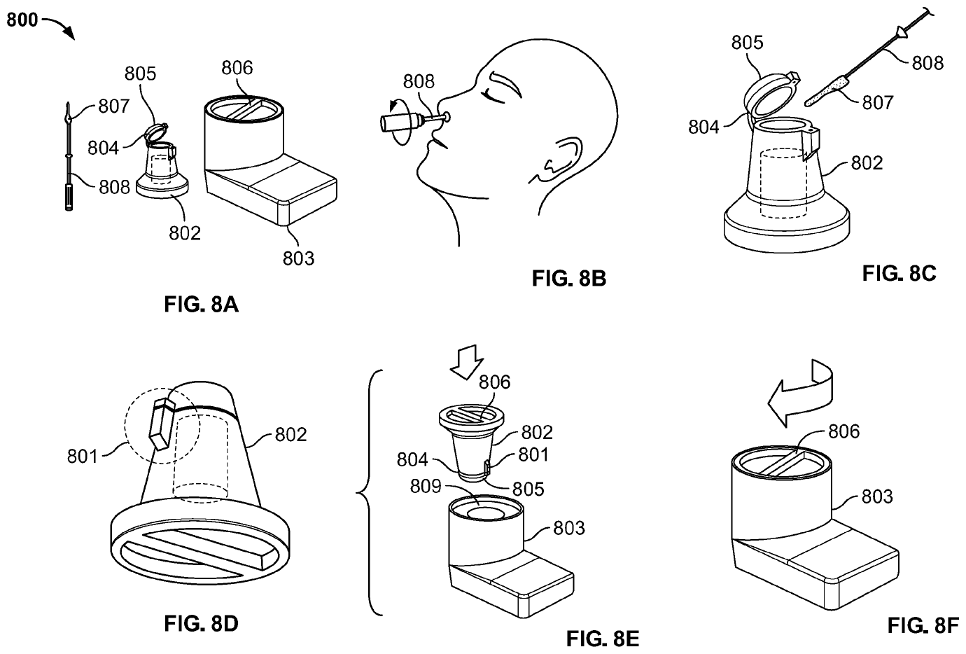

In various embodiments, the bi-stable locking mechanism in the assembly 800 comprises a key feature 801 on the sample collection tube 802 and a threaded feature in the test cartridge 803, as shown in FIGS. 8A-8F. In such embodiments, the sample collection tube 802 can have a cap 804 (e.g., snap-on cap) on its proximal end and the cap 804 comprises a breakable seal 805. On the distal end of the sample collection tube 802, there can be a knob feature 806. The sample collection tube 802 has a protruding, unique “key feature” that completely forms when the sample collection tube is capped.

Following sampling, the sample collector head 807 can be inserted and stirred in the reagent for sample elution and subsequently removed. Alternatively, the sample collector head 807 can be snipped into the sample chamber through the use of a breakable sample collector handle 808. Following elution or snipping of the sample collector head, the sample collection tube is capped, thereby completing the key feature 801 (FIG. 8D), and inverted prior to loading into the sample collection tube holder 809 (FIG. 8E). The inversion of the sample collection tube 802 configures the sample collection tube 802 in the sample collection tube holder 809 such that the knob 806 on the distal end of the sample collection tube 802 is accessible to the user after loading.

The interior walls the sample collection tube holder or test cartridge include a threaded feature to facilitate the operative coupling between the key feature 801 of the sample collection tube 802 and test cartridge 803 (not shown in FIGS. 8A-8F). In at least one first state, the key feature 801 of the sample collection tube 802 is not operatively coupled to the threaded feature of the test cartridge 803. In at least one second state, the key feature 801 of the sample collection tube 802 is operatively coupled to the threaded feature of the test cartridge 803. In the second state, the user rotates the sample collection tube 802 within the test cartridge 803 using the knob feature 806 on the sample collection tube 802 (FIG. 8F). The mating of the key feature 801 with the threaded feature within the test cartridge 803 and/or sample collection tube holder 809 allows for the linear (vertical) displacement of the sample collection tube 802 in the test cartridge 803, thereby transitioning form the first stable state, wherein the puncturing element of the test cartridge 803 is not breaking the breakable seal 805 of the sample collection tube 802, to the second stable state, wherein the puncturing element of the test cartridge 803 pierces the breakable seal 805 of the sample collection tube 802. In the second stable state, there is immediate fluidic communication between the sample collection tube 802 and the test cartridge 803.

The operative coupling of the key feature to the threaded feature, as used herein, refers to the key feature and the threaded feature coming into direct contact or mating within the sample collection tube holder. The sample collection tube holder is designed with a key feature that has a shape specifically configured for mating with the threaded feature.

As would be appreciated by one of ordinary skill in the art, a ramp feature can be used in the sample collection tube holder (in the test cartridge) and a genuinely instead of a threaded feature in the test cartridge.

As used, “knob” refers to any feature facing outward on the sample collection tube when it is loaded in the test cartridge that enables the user to grip and rotate the sample collection tube within the test cartridge. FIGS. 8A and 8E-8F show an exemplar knob feature.

Where there is a sample collection tube-base unit assay assembly, in some embodiments, the bi-stable locking mechanism comprises a key feature of the first chamber or the first sub-container and a threaded feature of the test cartridge, the key feature and the threaded feature operatively couplable with one another. The fluidic coupling mechanism comprises: (i) a breakable seal of the first chamber or the first sub-container and a puncturing element of the test cartridge; (ii) a break-away tab of the first chamber or first sub-container and the sample collector; or (iii) an actuable valve. The at least one first state comprises the key feature of the first chamber or the first sub-container not being operatively coupled to the threaded feature of the test cartridge and the at least one second state comprises the key feature of the first chamber or the first sub-container being operatively coupled to the threaded feature of the test cartridge. The operative coupling of the sample collection tube and the test cartridge in the first stable state comprises: (i) the puncturing element of the test cartridge not breaking the breakable seal of the first chamber or the first sub-container; (ii) the sample collector not breaking (e.g. by not contacting) the break-away tab of the first chamber or first sub-container; or (iii) not actuating the actuable valve. The operative coupling of the sample collection tube and the test cartridge in the second stable state comprises: (i) the puncturing element of the test cartridge breaking the breakable seal of the first chamber or the first sub-container; (ii) the sample collector breaking the break-away tab of the first chamber or first sub-container; or (iii) actuating the actuable valve, thereby placing the first chamber of the sample collection tube in fluidic communication with the test cartridge.

II.C.5. Cylindrical Sample Collection Tube Twist Feature

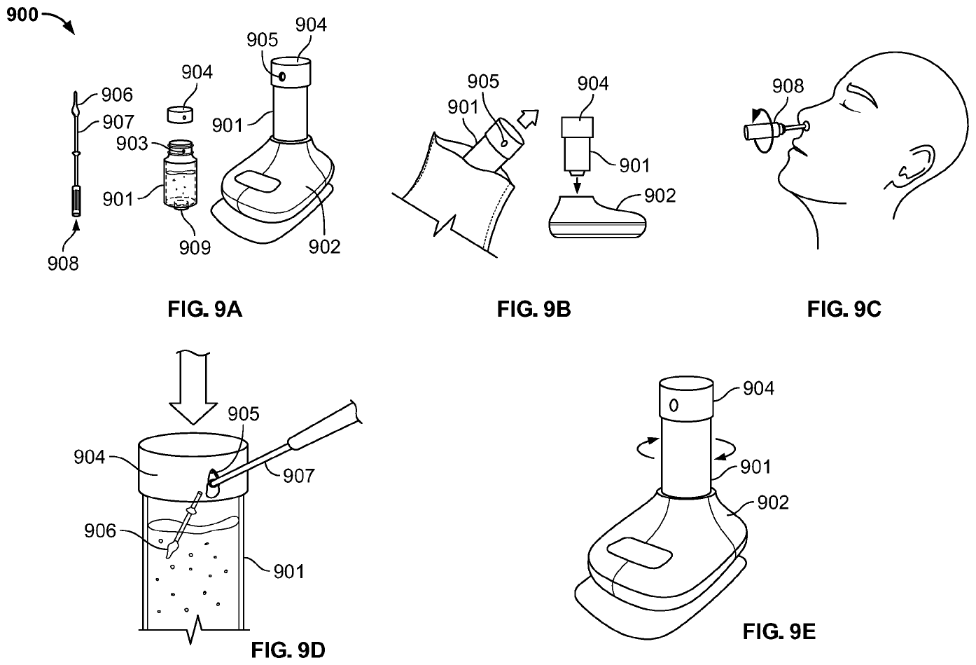

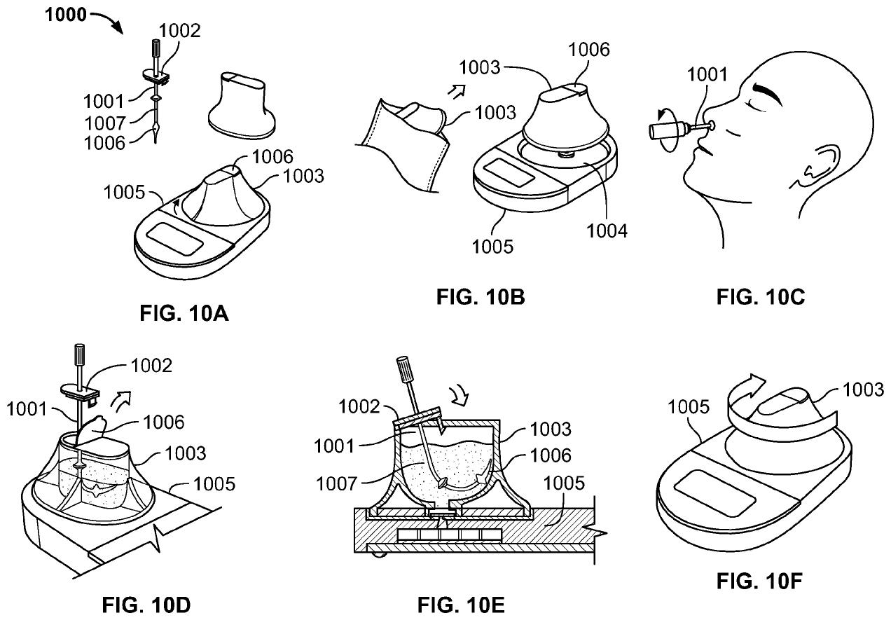

In various embodiments, the bi-stable locking mechanism in the assembly 900 comprises a twist feature on the exterior walls of the sample collection tube 901, as shown in FIGS. 9A-10F. For example, the sample collection tube 901 can have threading at its distal end and the interior walls the sample collection tube holder have threading. The assay 900 is set up by loading the sample collection tube 901 onto the test cartridge 902 (FIG. 9B and FIG. 10B).

In certain embodiments, the sample collection tube 901 has an opening 903 on its proximal end and a cap 904 with an opening 905 on its proximal end. These openings are sized to allow the introduction of the sample collector head 906 and handle 907 into the sample collection tube 901 (FIG. 9D). The cap 904 and sample collection tube 901 are operatively coupled in a first state such that the openings for accepting a sample collector 908 (e.g., swab-accepting openings) are aligned and allow the introduction of a sample collector head 906 and handle 907. The cap 904 and sample collection tube 901 are maintained in the first state by a lockout feature, that ensures that the openings for the sample collector 908 remain aligned. In such embodiments, the sample collector handle 907 is breakable. The user inserts the sample collector 908 into the openings, as shown in FIG. 9D, and applies pressure on the cap 904 to move the cap 904 and the sample collector 908 to a second state, thereby breaking or snipping off the sample collection head 906 in the sample collection tube 901 and sealing the sample collection tube 901.

In at least one first state of the twist feature, the twist feature is not being twisted, and in at least one second state of the twist feature, the twist feature is being twisted. The operative coupling of the sample collection tube 901 and the test cartridge 902 in the first stable state comprises the puncturing element of the test cartridge 902 not breaking the breakable seal of the sample collection tube 901. To transition to the second stable state, the sample collection tube 901 is rotated or twisted in the sample collection tube holder. This translates to the linear (vertical) displacement of the sample collection tube 901. Consequently, the puncturing element of the test cartridge 902 pierces the breakable seal 909 of the sample collection tube, thereby placing the first chamber of the sample collection tube 901 in fluidic communication with the second chamber of the test cartridge 902 (FIGS. 9E and 10F).

Where there is a sample collection tube-base unit assay assembly, in some embodiments, the bi-stable locking mechanism comprises a twist feature of the first chamber or the first sub-container. In some embodiments, the sample collection tube has an opening on its proximal end and a cap with an opening on its proximal end. These openings are sized to allow the introduction of the sample collector head and handle into the sample collection tube. The fluidic coupling mechanism comprises (i) a breakable seal of the first chamber or the first sub-container and a puncturing element of the test cartridge; (ii) a break-away tab of the first chamber or first sub-container and a puncturing element of the test cartridge; or (iii) an actuable valve. The at least one first state comprises the twist feature not being twisted and the at least one second state comprises the twist feature being twisted. The operative coupling of the first chamber or the first sub-container and the test cartridge in the first stable state comprises: (i) the puncturing element of the test cartridge not breaking the breakable seal of the first chamber or the first sub-container; (ii) the puncturing element not breaking (e.g. by not contacting) the break-away tab of the first chamber or first sub-container; or (iii) not actuating the actuable valve. The operative coupling of the first chamber or the first sub-container and the test cartridge in the second stable state comprises: (i) the puncturing element of the test cartridge breaking the breakable seal of the first chamber or the first sub-container; (ii) the puncturing element breaking the break-away tab of the first chamber or first sub-container; or (iii) actuating the actuable valve, thereby placing the first chamber of the sample collection tube in fluidic communication with the test cartridge.

In some embodiments, rather than a sample collector, the interior portion of the cap comprises a blade, such that in the at least one second state when the twist feature is twisted and the first chamber or the first sub-container operatively couples the test cartridge in the second stable state, the blade severs (or dislocates) the sample collection handle so that the sample collector portion is left in the first chamber or first sub-container.

II.C.6. Flared Sample Collection Tube Twist Feature

In certain embodiments, the sample collection tube in the assembly 1000 has a flared volume, for example, as shown in FIGS. 10A-10F. In such embodiments, a sample collector 1001 can be affixed to a cap 1002. The distal end of the sample collection tube 1003 has a threaded (or twist) feature on the exterior walls of the sample collection tube 1003, and the interior walls of the sample collection tube holder 1004 have a threaded (or twist) feature.

The assay is set up by loading the sample collection tube 1003 onto the test cartridge 1005 (FIG. 10B). Following sampling, the original cap 1006 for the sample collection tube 1003 is removed and replaced with the sample collector 1001 affixed to a cap 1002 (FIG. 10D). In certain embodiments, the sample collector head 1006 and/or handle 1007 are deformed within the sample collection tube 1003 and the pressure applied on the sample collector head 1006 allow additional release of the sample into the reagent. The sample collector 1001 affixed to a cap 1002 can be coupled to the sample collection tube 1003 by various means, including but not limited to snapping on and twisting.

In at least one first state of the twist feature on the sample collection tube 1003, the twist feature is not being twisted, and in at least one second state of the twist feature, the twist feature is being twisted. The operative coupling of the sample collection tube 1003 and the test cartridge 1005 in the first stable state comprises the puncturing element of the test cartridge 1005 not breaking the breakable seal of the sample collection tube 1003. To transition to the second stable state, the sample collection tube 1003 is rotated or twisted in the sample collection tube holder 1004. This translates to the linear (vertical) displacement of the sample collection tube 1003. Consequently, the puncturing element of the test cartridge 1005 pierces the breakable seal of the sample collection tube 1003, thereby placing the first chamber of the sample collection tube 1003 in fluidic communication with the second chamber of the test cartridge 1005 (FIGS. 9E and 10F).

II.D. Sample Collector Integrated with Sample Collection Tube

Prior to assembly of the assay assemblies provided herein, in some embodiments, a user first obtains the sample collector in separate packaging from the base unit and in separate packaging from the sample collection tube. See, for example FIGS. 42 and 43. This maintains the sterility of the separate components, and allows the sample collection tube holder, a single-use consumable, to be sold separate from the reusable base unit.

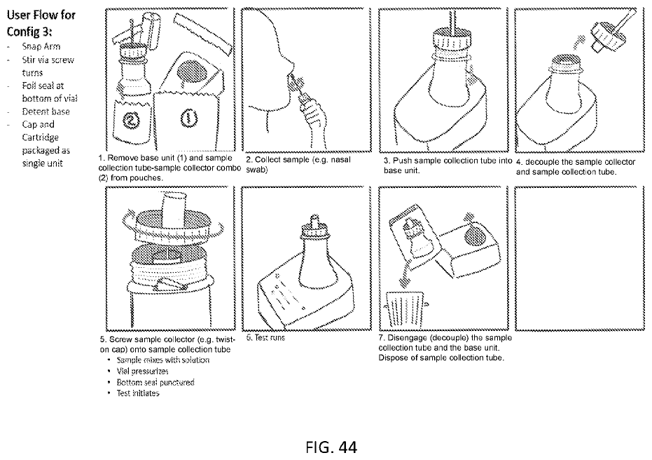

In some embodiments, a user can first obtain the sample collector in the same packaging as the sample collection tube, with the sample collector coupled to the sample collection tube. In some embodiments, when the sample collector and sample collection tube is first unpacked by a user, the cap is coupled to the sample collector such that the grip handle extends into the sample collection tube. In alternative embodiments, the cap is coupled to the sample collector such that the sample collection holder and the sample collection portion extend into the sample collection tube-however the first chamber or first sub-container are in the first stable state. As shown in FIG. 44, in such embodiments, the sample collection tube can be operatively connected to the base unit prior to separation of the sample collector and the sample collection tube. Thereafter, the user obtains the sample, and then operatively couples the sample collector and sample collection tube in the at least one second state.

II.E. Sample Collection Tube Holder

The sample collection tube holders comprise various features that are contemplated in some embodiments in addition to the bi-stable locking mechanism. Some of these features prevent the premature engagement of the sample collection tube with the piercing element of the test cartridge and prevent premature assay initiation.

For example, FIG. 11 is a cross-section of a sample collection tube holder 1101 in certain embodiments. As shown, the sample collection tube holder 1101 can include a cantilever snap features 1102. Upon loading the sample collection tube 1103 into the sample collection tube holder 1101, the sample collection tube 1103 sits above the cantilever snaps 1102—this is the first stable state of the sample collection tube 1103 and the test cartridge. The operative coupling of the sample collection tube 1103 and the test cartridge in the first stable state comprises the sample collection tube 1103 positioned above the cantilever snap features 1102 and the puncturing element 1104 of the test cartridge not breaking the breakable seal of the sample collection tube 1103. Through a user action (e.g., capping, twisting, pressing, twisting-and-pressing of the sample collection tube, etc.) the sample collection tube 1103 undergoes linear displacement and transitions to a second stable state, thereby breaking the breakable seal of the sample collection tube 1103 with the puncturing element 1104, and thereby placing the first chamber of the sample collection tube 1103 in fluidic communication with the second chamber of the test cartridge. In alternative embodiments, the sample collection tube holder comprises detents rather than cantilever snap features.

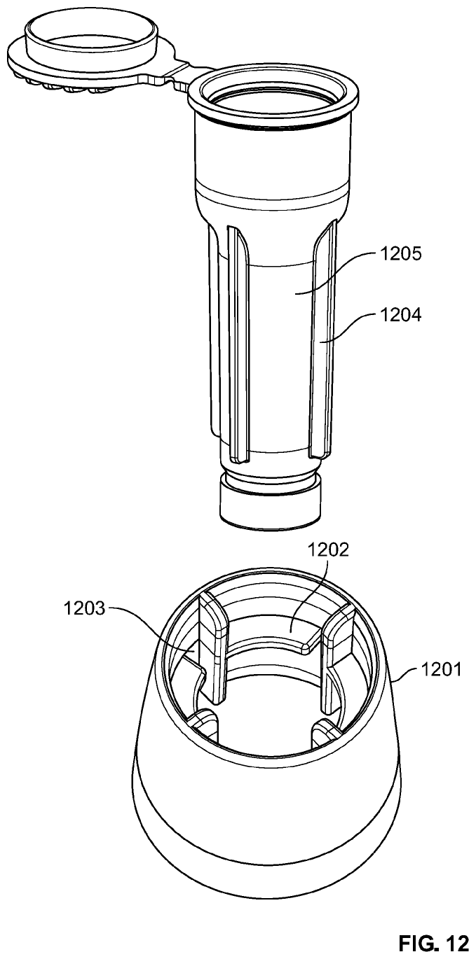

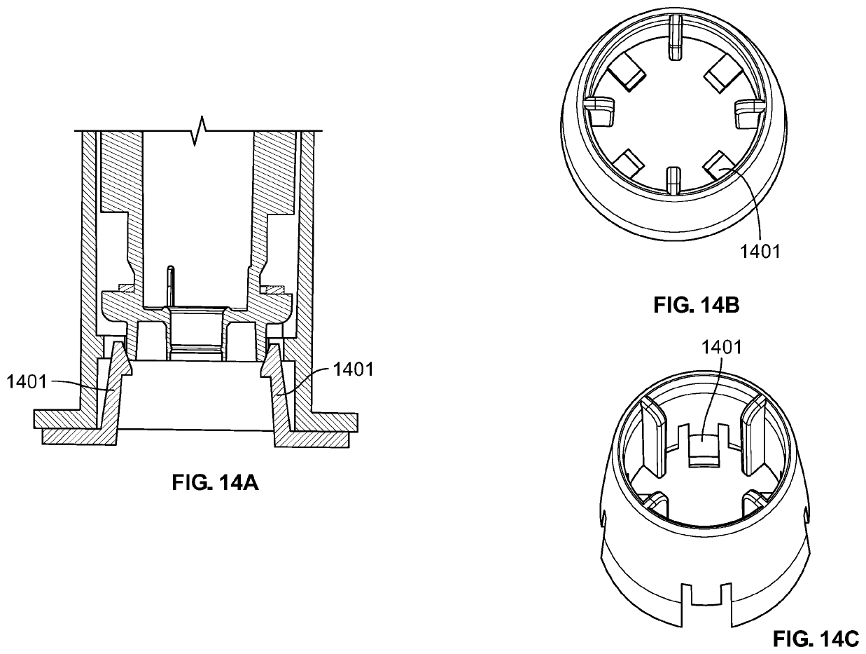

In certain embodiments, the sample collection tube holder 1201 comprises a shelf 1202 having gaps 1203 configured to align with and sized to fit the alignment features 1204 of the sample collection tube 1205, as shown in FIGS. 12 and 14A. Responsive to the sample collection tube holder 1201 operatively coupling the sample collection tube 1205 and the test cartridge in the first stable state, responsive to the alignment features 1204 of the sample collection tube 1205 aligning with the gaps 1203 in the shelf 1202 of the collection tube holder 1201, and responsive to the bi-stable locking mechanism transitioning to the at least one second state, the sample collection tube holder 1201 operatively couples the sample collection tube 1205 and the test cartridge in the second stable state.

As used, an “alignment feature” refers to a feature (e.g., protruding feature) on the exterior surface of the sample collection tube that forces the sample collection tube to sit on the shelf until it is in a specific alignment relative to the gaps in the shelf, which allows transition from the first stable state to the second stable state. Non-limiting examples of these alignment features include rib, tabs, hooks, notches, and nubs.

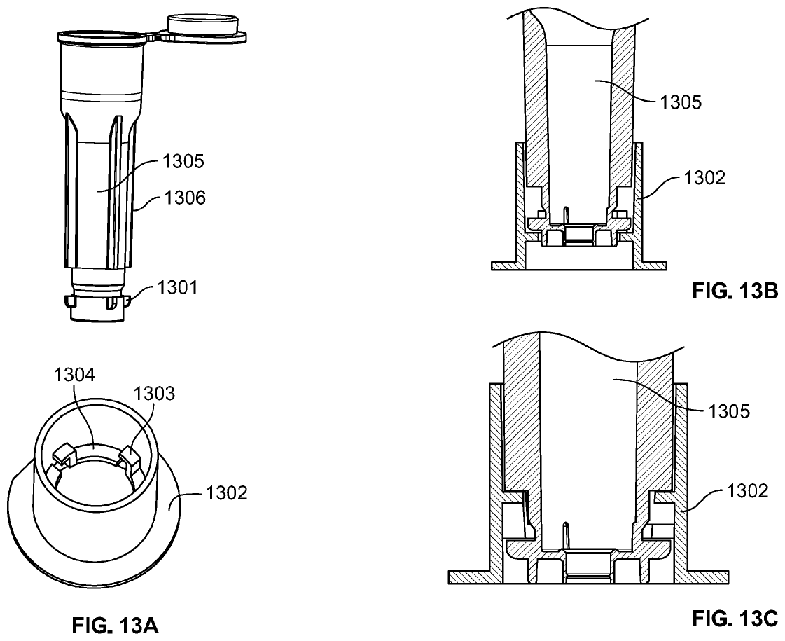

In certain embodiments, the exterior surface of the sample collection tube comprises notches 1301, and the sample collection tube holder 1302 comprises rotational alignment features (e.g., hooks 1303) positioned on the shelf 1304 and configured to interlock with the notches of the sample collection tube 1305 responsive to the alignment features 1306 of the sample collection tube 1305 aligning with the gaps in the shelf of the collection tube holder 1302 and responsive to the sample collection tube holder 1302 operatively coupling the sample collection tube 1305 and the test cartridge in the second stable state (FIG. 13A).

As used, a “rotational alignment feature” refers to a feature (e.g., a hook, a gap, etc.) that is in the shelf of the collection tube holder 1201 such that the sample collection tube is prevented from transitioning from the first stable state unless the sample collection tube or the sample collection tube holder is already aligned or is rotated to align the alignment features on the sample collection tube with the rotational alignment feature(s) on the shelf of the sample collection tube holder, thereby allowing the sample collection tube to transition from the first stable state to the second stable state.

The use of the alignment features (e.g., notches) and, in some embodiments, rotational alignment features (e.g., hooks) can also be used to prevent the sample collection tube from transitioning from operative coupling with the test cartridge in the second stable state to operative coupling with the test cartridge in the first stable state.

In certain embodiments, the sample collection tube holder comprises a shelf having gaps configured to align with and sized to fit the alignment features of the sample collection tube as well as cantilever snap features.

Cantilever snap features 1401 and detents are also contemplated as locking features. For example, in such embodiments, the cantilever snap features 1401 are below the shelf and the cantilever snap features also function to prevent the sample collection tube from transitioning from operative coupling with the test cartridge in the second stable state to operative coupling with the test cartridge in the first stable state. Other locking features that can serve as locking features include, without limitation, hooks (e.g., positioned below the shelf).

II.F. Pressurizing Components

In some embodiments, the sample holder and sample collection portion are not affixed to a cap. As described herein, in some embodiments, a sample collector comprises a cap, a sample holder, and sample collection portion. In some embodiments, the sample collector further comprises a grip handle for the user to handle the sample collector while minimizing contamination (e.g. from hands) of the sample handle and sample collection portion.

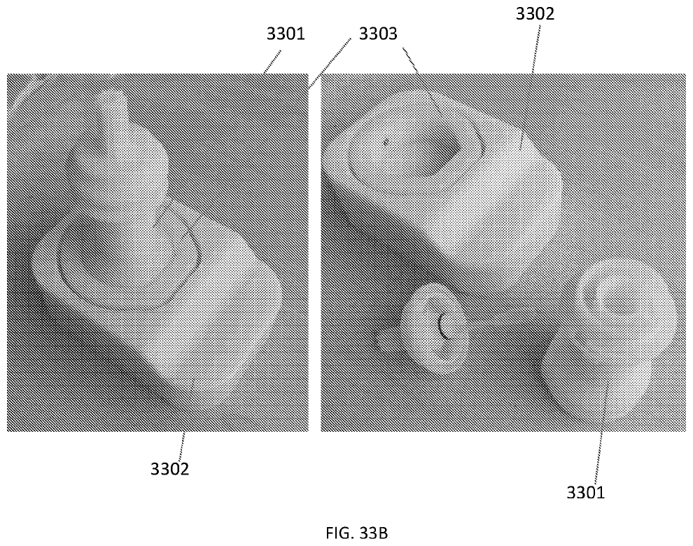

In some embodiments, the sample collector further comprises a pressurizing component for pressurizing the inside of the sample collection tube, first chamber or first sub-container. As shown in FIGS. 35A-35B, in some embodiments, the pressurizing component is a rubber sealing element (e.g., rubber stopper) attached to the inside of the cap. The rubber sealing element is partially or wholly insertable into the sample collection tube, first chamber or first sub-container, thereby pressuring the sample collection tube, the first chamber or first sub-container. Upon operative coupling of the cap to the sample collection tube 3501, the pressurizing component can displace, in some embodiments, 0.4 mL of air and/or fluids. In some embodiments, the pressurizing component can displace 0.1 to 0.5 mL of air and/or fluids. In some embodiments, the pressurizing component is configured to displace at least the total volume of the reaction chambers in the test cartridge 3504. It can increase the pressure within the sample collection tube, first chamber or first sub-container by, e.g. 1 psi, 2 psi, 3 psi, 4 psi or 5 psi. In some embodiments, the pressurizing component can increase the pressure within the sample collection tube to greater than 1 psi, 2 psi, 3 psi, 4 psi, 5 psi or pressure values therebetween. Once in the second stable state, when the breakable seal is broken, the break-away tab is broken or the actuable valve is actuated, there is fluidic communication between the sample collection tube, and the pressure previously created by the pressurizing component drives fluid out of the first chamber or first sub-container into the sample inlet of the test cartridge. This results in depressurization of the first chamber or the first sub-container.

In some embodiments, the reaction chambers in the test cartridge are contemplated as blunt end channels. The test cartridge has a sample inlet through which the sample flows from the sample collection tube, the first chamber or the first sub-container. The sample inlet branches into separate conduits which each fluidically connect to a reaction chamber. One end of the reaction chamber comprises a selective venting element 3505. In some embodiments, a selective venting element 3505 is a material having passively tunable porosity such that one more gases can pass therethrough but liquids cannot pass therethrough.

In some embodiments, the selective venting elements is configured to proceed, upon contact with a liquid, from a first conformation, in which one or more gases can pass therethrough, to a second conformation that reduces the permeability of fluid therethrough or renders the selective venting element impermeable to fluid, wherein the first conformation allows flow from the sample collection tube, first chamber or first sub-container to the sample inlet and into the one or more reaction chambers but impedes or significantly reduces fluid flow through the selective venting element.

Where there is a sample collection tube-base unit assay assembly, in some embodiments, the sample collection tube is configured to allow the one or more gases to flow from the one or more reaction chambers into second sub-container 3503. In some embodiments, where the one or more gases flow from the one or more reaction chambers into the second sub-container 3503 and the rubber element is configured to seal first sub-container prior to sealing the second sub-container 3503, the one or more gases are allowed to escape to the atmosphere before the operative coupling of the cap to the sample collection tube 3501 is complete and the second sub-container seals.

As shown in FIG. 35B, in some embodiments, the sample collection tube further comprises a skirt chamber 3506 (referred to as “skirt”), which is a sealed cavity separate from the first chamber, first sub-container 3502 and second sub-container 3503 and proximal to the test cartridge 3504. The selective venting elements 3505 allow one or more gases to vent into the skirt 3506. Even after the test cartridge and the first chamber or first sub-container are in the second stable state, the pressure within the sealed cavity is lower than that in the first chamber or first sub-container. This is to ensure that there is no back-flow of reaction mixture from the test cartridge into the first chamber or first sub-container. To that end, in some embodiments, the volume of the skirt is at least or greater than the total volume of all the one or more reaction chambers in the test cartridge.

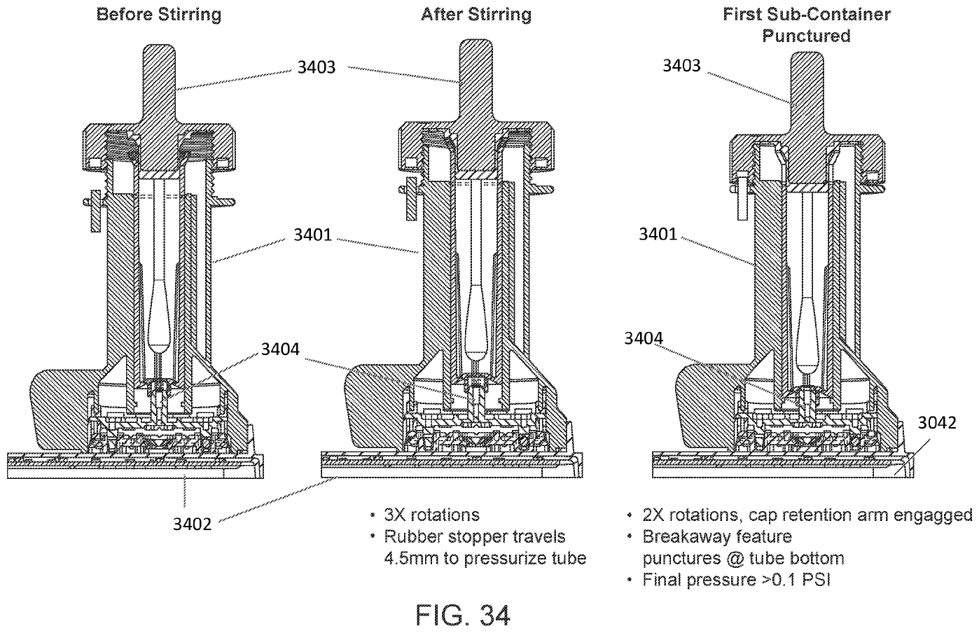

Various types of rubber sealing elements are contemplated inside the cap. For example FIG. 36 shows (1) an overmolded conformal rubber sealing element, (2) an o-ring rubber sealing element, and (3) rubber plug cap. Other types of rubber sealing elements are known to those of ordinary skill in the art.

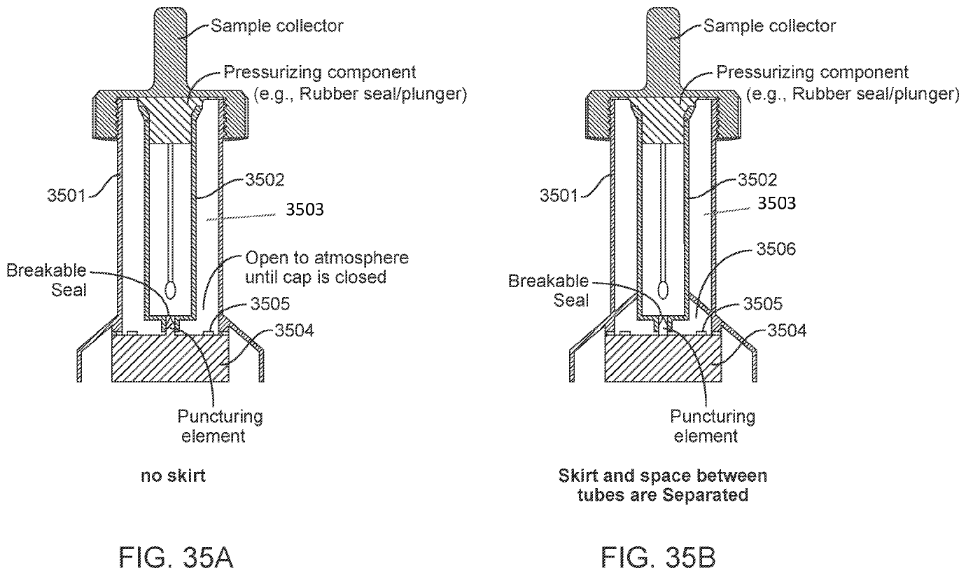

In some embodiments, during coupling of the cap to the sample collection tube, if the cap is configured for twisting (rotations), the overmolded conformal rubber sealing element and the o-ring can result in friction, between the fluid chamber or first sub-container and the rubber. To eliminate the friction, in some embodiments, the rubber plug cap is spinnable independent of the cap. For example, the interface between the cap and the rubber plug cap has threading on both the cap and the rubber side, allowing the cap and the rubber plug cap to remain stationery as the cap is rotating. This reduces the time and effort required to complete the operative coupling of the cap to the sample collection tube, thereby reducing the test time and further streamlining the assay. In alternative embodiments, the friction can be eliminated by having threading on the outer surface of the rubber sealing element and reciprocating threading on the inside the first chamber or first sub-container. See, for example, FIG. 37.

II.G. Agitator Features

The inventors of the present disclosure have demonstrated significant improvement in sample elution through the use of rotating sample collectors-in-tube and agitator features on the inner surface of sample collection tubes.

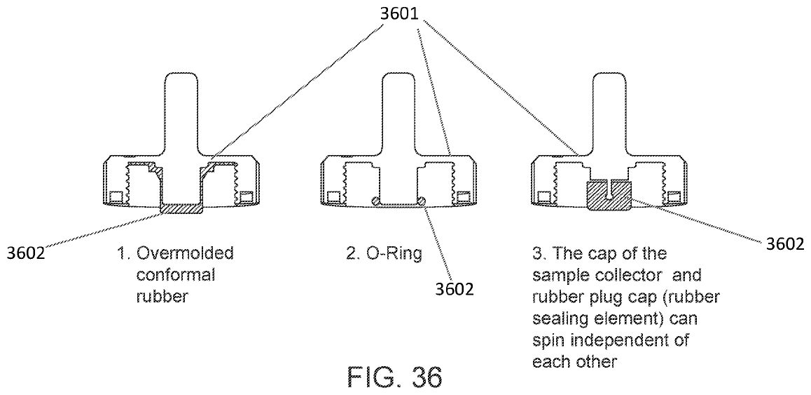

In some embodiments, the proximal end of the sample collection tube has threading and the cap of the sample collector has reciprocating threading (e.g., twist-on cap). In some embodiments, the sample collection portion of the sample collector is offset from an axis of rotation of the twist-on cap, such that, during rotation of the twist-on cap about the axis of rotation, the sample collection portion rotates off the axis of rotation of the sample handle and maximizes volume contact. In some embodiments, the handle of the sample collector is offset from the center of the twist-on cap (e.g. FIG. 29), such that the sample collection portion rotates outside of the center axis of the twist-on cap and makes contact with the inner walls of the first chamber or the first sub-container. See, for example, FIG. 38A.

The elution efficiency of the sample on the sample collection portion in the liquid contents of the first chamber and first sub-container can be improved by increasing the number of complete rotations of the cap on the sample collection tube during operative coupling. In some embodiments, the sample collection tube is configured to slidably receive at least 3 complete rotations of the threading of the twist-on cap to reach the at least one second state such that the twist-on cap is operatively coupled to the sample collection tube. In some embodiments, the sample collection tube is configured to slidably receive at least 3 complete rotations of the threading of the twist-on cap to reach the at least one second state such that the twist-on cap is operatively coupled to the sample collection tube. In some embodiments, the sample collection tube is configured to slidably receive at least 3, 4, 5, 6, 7, 8, 9, or 10 complete rotations of the threading of the twist-on cap to reach the at least one second state such that the twist-on cap is operatively coupled to the sample collection tube. In some embodiments, the sample collection tube is configured to slidably receive between 2 to 10, 3 to 10, 4 to 10, 5 to 10, 6 to 10, 7 to 10, 8 to 10, 9 to 10, 2 to 9, 3 to 9, 4 to 9, 5 to 9, 6 to 9, 7 to 9, 8 to 9, 2 to 8, 3 to 8, 4 to 8, 5 to 8, 6 to 8, 7 to 8, 2 to 7, 3 to 7, 4 to 7, 5 to 7, 6 to 7, 2 to 6, 3 to 6, 4 to 6, 5 to 6, 2 to 5, 3 to 5, 4 to 5, 2 to 4, 3 to 4, or 2 to 3 complete rotations of the threading of the twist-on cap to reach the at least one second state such that the twist-on cap is operatively coupled to the sample collection tube.

The elution efficiency of the sample on the sample collection portion in the liquid contents of the first chamber and first sub-container can be improved by the presence and increased number of agitator features. FIG. 38A shows a first chamber without any agitator features. The sample collection portion is shown in contact with the inner walls of the first chamber. In some embodiments, the sample collection tube 3801, the first sub-container of the first chamber comprises an agitator feature. FIG. 38B shows a first chamber having 4 agitator features 3802 (rib agitator features shown). In some embodiments, the sample collection tube 3801, the first sub-container of the first chamber comprises a plurality of agitator features. In some embodiments, the total number of agitator features is 2, 3, 4, 5, 6, 7, or 8. In some embodiments, the total number of agitator features is at least 2, 3, 4, 5, 6, 7, or 8. In some embodiments, the total number of agitator features is between 2 to 10, 3 to 10, 4 to 10, 5 to 10, 6 to 10, 7 to 10, 8 to 10, 9 to 10, 2 to 9, 3 to 9, 4 to 9, 5 to 9, 6 to 9, 7 to 9, 8 to 9, 2 to 8, 3 to 8, 4 to 8, 5 to 8, 6 to 8, 7 to 8, 2 to 7, 3 to 7, 4 to 7, 5 to 7, 6 to 7, 2 to 6, 3 to 6, 4 to 6, 5 to 6, 2 to 5, 3 to 5, 4 to 5, 2 to 4, 3 to 4, or 2 to 3.

In some embodiments, these agitator features can be at the base of the first chamber or first sub-container. In some embodiments, these agitator features are position on the inner circumference of the first chamber or first sub-container. The position of the agitator features is contemplated anywhere that the sample collection portion can make contact with the agitator features as the cap (and thereby sample collection portion) is being rotated during operative coupling of the cap and the first chamber of first sub-container.

In some embodiments, the length and presence of agitator features create a concave agitator tube. This is wherein the number of agitator features and the degree of projection of the agitator features towards the center of the tube (e.g., length projecting towards center of tube) is sufficient for the sample collection portion to directly interface with at least two agitator features at a time.

In some embodiments, the total number of agitator features is 3, 4 or 5. In some embodiments, elution efficiency increases with the number of agitators. In some embodiments, having a total number of 4 agitator features improves elution efficiency. In some embodiments, having a total number of agitator features between 3 and 6 improves elution efficiency relative to having more than 6 agitator features because, without being bound by theory or mechanism, the number of agitator features allow the sample collection portion to “spring” from one agitator feature to another. As used herein, “spring” refers to the action of the sample collection portion contacting an agitator feature, as the sample holder continues to rotate, there is resistance on the sample collection portion created by the contacting agitator feature until the sample collection portion is forced past the agitator feature and accelerates in the direction of rotation. In some embodiments, the number of agitator features to create this “spring” and improve elution efficiency can depend on the diameter of the first chamber or first sub-container or the degree of projection of agitator features towards the center of the tube.

### III. Sample Collector Cap

The subject disclosure provides assays having a sample collector cap 701 (e.g., a cap 701 with a sample collector 703 affixed to it). In various embodiments, an assembly comprises a sample collection tube 702 with a first chamber, a breakable seal 707, a test cartridge 707 comprising a second chamber and a puncturing element 708. In some embodiments, these assays do not include a bi-stable locking mechanism. The sample collection tube 702 is operatively coupleable with the test cartridge 704 and the sample collector cap 701 is operatively coupleable with the sample collection tube 702. Responsive to the cap 701 not being operatively coupled to the sample collection tube 702, the sample collection tube 702 and the test cartridge 704 are operatively coupled in a first stable state such that the puncturing element 708 of the test cartridge 704 does not pierce the breakable seal 707 of the sample collection tube 702. Responsive to the cap 701 being operatively coupled to the sample collection tube 702, the sample collection portion of the sample collector is positioned within the first chamber of the sample collection tube 702 and the sample collection tube 702 and the test cartridge 704 are operatively coupled in a second stable state such that the puncturing element 708 of the test cartridge 704 pierces the breakable seal of the sample collection tube, thereby placing the first chamber of the sample collection tube 702 in fluidic communication with the second chamber of the test cartridge 704.

In some embodiments, the cap of the sample collector cap is a twist-on cap 701. Responsive to the user twisting the cap onto the sample collection tube, the sample collection tube 702 and the test cartridge 704 are operatively coupled in a second stable state and the puncturing element 708 of the test cartridge 704 pierces the breakable seal 707 (FIG. 7G). In some embodiments, the sample collection tube 702 is configured to slidably receive ½-10 complete rotations of the threading of the twist-on cap 701 to transition to the second stable state.

In alternative embodiments, the cap of the sample collector engages with the sample collection tube by other means, e.g., snapping on, pushing, sliding, and bayonet fitting.

### IV. Additional Coupling Mechanisms

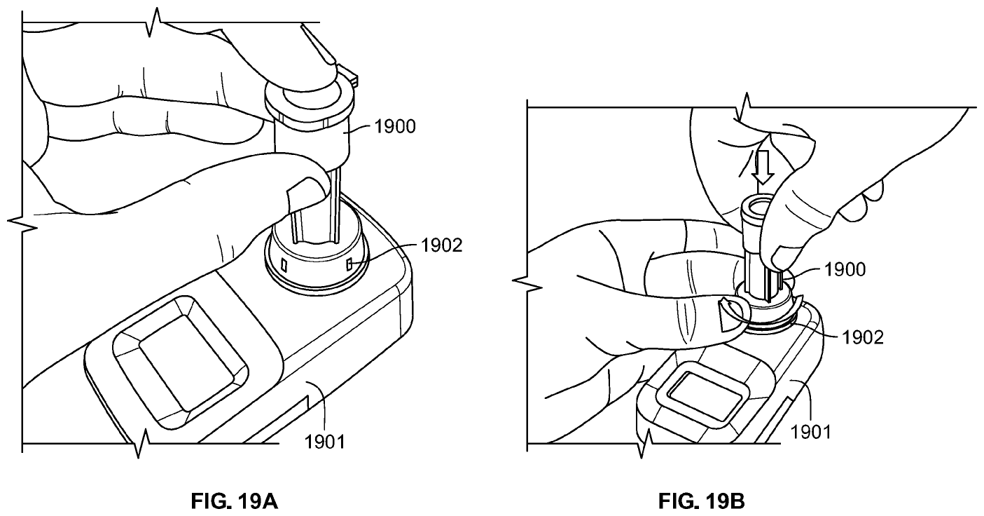

As shown in FIGS. 19A and 19B, in certain embodiments, the sample collection tube holder 1902 can be rotated to transition the sample collection tube 1900 and test cartridge 1901 from the first stable state (wherein the first chamber of the sample collection tube 1900 is not in fluidic communication with the second chamber of the test cartridge 1901) to the second stable state, (wherein the first chamber of the sample collection tube 1900 is in fluidic communication with the second chamber of the test cartridge 1901). For example, after the sample collection tube 1900 is placed in the sample collection tube holder 1902 in a first stable state, the user can rotate (or twist) the sample collection tube holder 1902 or a collar thereon, which allows the sample collection tube 1900 to transition in the direction of (e.g., move downward to) the puncturing element, to place the first chamber of the sample collection tube 1900 in fluidic communication with the second chamber of the test cartridge 1901. In certain embodiments, the rotation of the sample collection tube holder 1902 is sufficient to align the alignment features on the sample collection tube 1900 with, for example, rotational alignment features in the sample collection tube holder, as described herein.

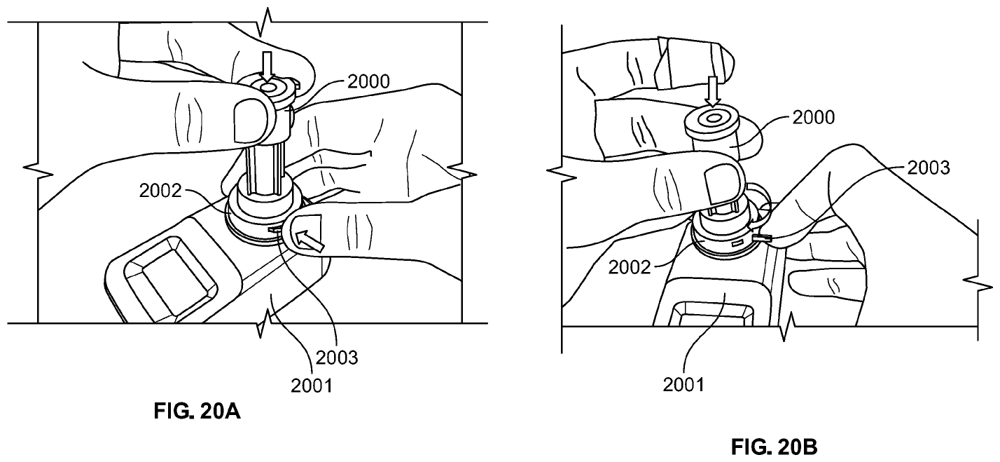

In certain embodiments, the inside of the sample collection tube holder comprises a lockout mechanism that prevents (e.g., by obstruction) the sample collection tube from transitioning from the first stable state to the second stable state on initial placement within the sample collection tube holder, and that lockout mechanism is actuated by a release feature on the outside of the sample collection tube holder. For example, in certain embodiments, the release feature 2003 is a button that the user pushes to allow the sample collection tube 2000 to transition from the first stable state to the second stable state, as shown in FIG. 20A. In certain embodiments, the release feature 2003 is a pullout feature (e.g., pullout pin) within the body of the test cartridge 2001 or in the sample collection tube holder 2002 that the user pulls to allow the sample collection tube 2000 to transition from the first stable state to the second stable state. In certain embodiments, the release feature 2003 is a lever on the outside of the sample collection tube holder 2002 that the user actuates (e.g., by pulling, pushing, etc.) to allow the sample collection tube 2000 to transition from the first stable state to the second stable state, as shown in FIG. 20B. It is also contemplated that these release features are located elsewhere on the test cartridge 2001 (other than on the outside of the sample collection tube holder 2002).

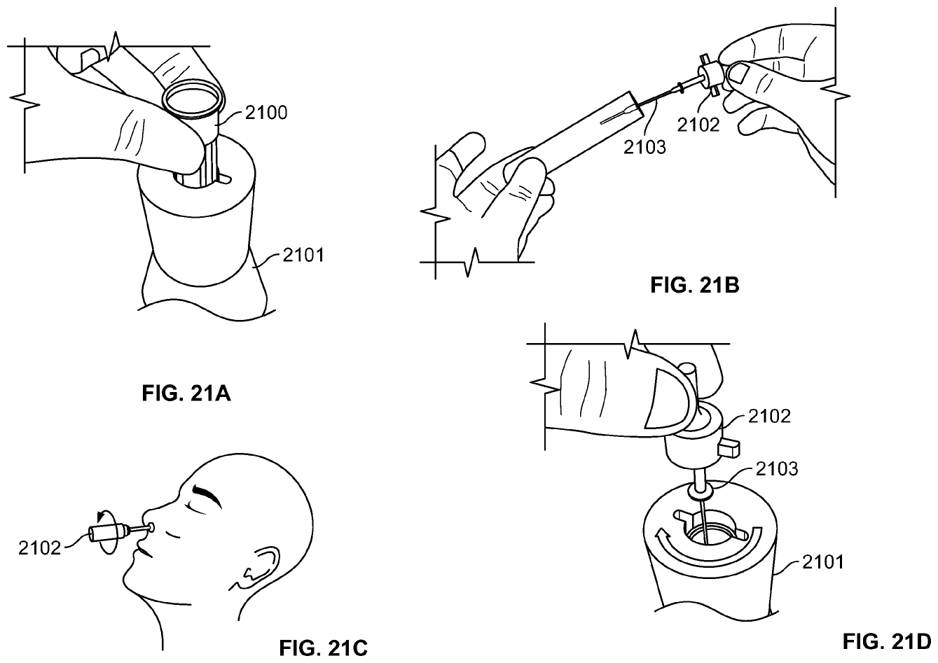

In certain embodiments, the sample collection tube holder and the test cartridge base 2105 form two opposably rotatable subunits (2104 & 2105), as shown in FIGS. 21A-21F. As used, the term “test cartridge base” refers to a part (subunit) of the test cartridge 2101 that can be rotated separately from the sample collection tube holder or remains stationary as the sample collection tube holder is rotated. In such embodiments, the sample collection tube 2100 is inserted into the sample collection tube holder in a first stable state, wherein the first chamber of the sample collection tube is not in fluidic communication with the second chamber of the test cartridge 2101 (FIG. 21A). Using a sample collector cap 2102, as described herein, a user collects a sample (e.g., a nasal sample; FIG. 21C) and inserts the sample collector 2103 of the sample collector cap 2102 on top of the sample collection tube 2100 in the sample collection tube holder (FIG. 21E). In some embodiments, the user mixes the sample collector 2103 (e.g., swab) in the reagents within the sample collection tube 2100 (FIG. 21D). In certain embodiments, the opening of the subunit with the sample collection tube holder 2104 is configured to allow entrance of the sample collector cap 2102 when it is in a specific orientation, e.g., the sample collector holder (and/or subunit with the sample collector holder 2104) has a keyed recess, and the user pushes the sample collector cap 2102 through the keyed recess on top of the sample collection tube 2100 in the subunit with the sample collection tube holder 2104 (FIG. 21E). After placement of the sample collector cap 2102 onto the sample collection tube 2100, the user can rotate the subunit with the sample collection tube holder 2104 in the opposite direction of the test cartridge base 2105, thereby sealing the sample collection tube 2100 with the sample collector cap 2102 and allowing the sample collection tube 2100 to transition to the second stable state (FIG. 21F). In alternate embodiments, the user can rotate the subunit with the sample collection tube holder 2104 while the test cartridge base 2105 remains stationary, thereby sealing the sample collection tube 2100 with the sample collector cap 2102 and allowing the sample collection tube 2100 to transition to the second stable state (FIG. 21F).

### V. Bubble-Free Puncturing Mechanism

Fluidic chambers for biological and chemical assay systems that utilize puncturing elements are particularly susceptible to bubble formation within channels. This, in part, can be attributed to the difficulty in forming a liquid seal when a puncturing element punctures a breakable seal. Also contemplated in the subject disclosure are assay assemblies that utilize a bubble-free puncturing mechanism. As used, the term “bubble-free puncturing” refers to a mechanism that reduces (minimizes) the size and/or number of bubbles or prevents bubble formation entirely when the puncturing of, for example, the sample collection tube, occurs. The bubble-free free puncturing mechanism(s) described herein minimize or prevent the introduction of bubbles into the chamber (e.g., sample collection tube) that is being punctured. In certain embodiments, the puncturing element provides for minimal deformation of the breakable seal and/or puncturing element when the puncturing element pierces the breakable seal. In the bubble-free puncture mechanism the breaking of the breakable seal allows for a clear puncture of the breakable seal with repeatable geometry, thereby minimizing the size and/or number of bubbles or preventing bubble formation entirely.

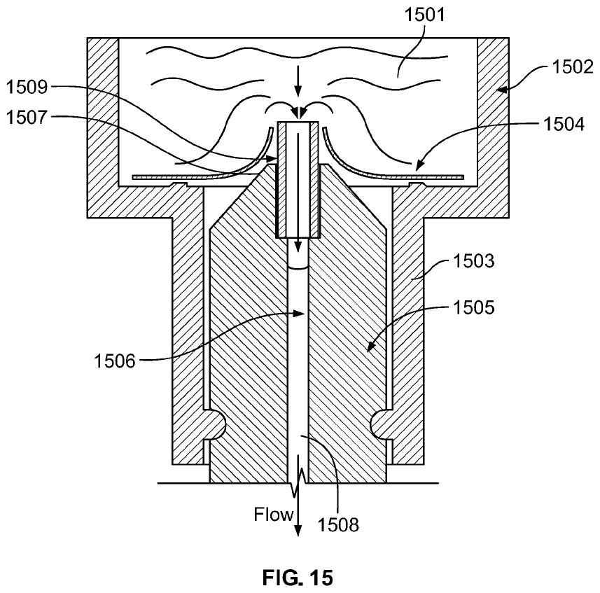

FIG. 15 is a cross-section of an assembly 1500 to prevent bubble formation when withdrawing liquid from the main chamber 1501 of a sample collection tube 1502. In such embodiments, the sample collection tube 1502 comprises a main chamber 1501 and an outlet port 1503, and the contents of the main chamber 1501 are separated from the outlet port 1503 by a breakable seal 1504. This assembly 1500 has a fluid transfer mechanism that is operatively couplable with the sample collection tube 1502, and the fluid transfer mechanism comprises an interface 1505. The outlet port 1503 of the sample collection tube 1502 is configured to receive the interface 1505. A channel 1506 transects the interface 1505, as shown in FIG. 15. That channel comprises a first end with an inlet 1507 proximal to the main chamber 1501 and a second end with an outlet 1508 leading to another chamber (e.g., collection vial, testing chamber, etc.).

In the assembly, a puncturing element 1509 comprising a hollow cylinder is embedded within at least a portion of the channel and is proximal to the main chamber 1501. The inner diameter of the puncturing element 1509 and the remaining channel form a single effective diameter along the length of the channel, the single effective diameter equivalent to the inner diameter of the hollow cylinder of the puncturing element 1509. In some embodiments, the inner diameter of the hollow cylinder of the puncturing element 1509 is within about 1%, about 2%, about 3%, about 4%, about 5%, about 6%, about 7%, about 8%, about 9%, about 10%, about 11%, about 12%, about 13%, about 14% or about 15% of the single effective diameter of the channel length. In some embodiments, the inner diameter of the hollow cylinder of the puncturing element is equivalent to the single effective diameter along the length of the channel within manufacturing tolerance levels.

In some embodiments, a second segment of the puncturing element 1509 extends beyond the inlet 1507 of the channel 1506, as shown in FIG. 15. As shown, the interface 1505 tapers towards the inlet 1507 of the channel 1506, in certain embodiments.

The operatively coupling of the sample collection tube 1502 and the fluid transfer mechanism comprises the outlet port 1503 receiving the interface 1505 of the fluid transfer mechanism such that at least one portion of the interface 1503 has a diameter that is equivalent to a diameter of at least one portion of the outlet port 1504 and such that the at least one portion of the interface 1505 is located within the at least one portion of the outlet port 1508, thereby fluidically sealing the outlet port 1508 with the interface 1505 and puncturing the breakable seal 1504 of the sample collection tube 1502 with the second segment of the puncturing element 1509 of the fluid transfer mechanism, thereby placing the main chamber 1501 of the sample collection tube 1502 in fluidic communication with the channel 1506 of the fluid transfer mechanism. In certain embodiments, during operative coupling of the sample collection tube 1502 and the fluid transfer mechanism, the interface 1505 forms an interference fit with the outlet port 1503, preventing any fluid from leaking between the interface 1505 and the interior walls the outlet port 1503. In some embodiments, the outlet port 1503 is comprised of deformable material, which aids with the seal and/or interference fit.

Upon operative coupling of the sample collection tube 1502 and the fluid transfer mechanism, air is trapped between the non-punctured surfaces of the breakable seal 1504 and the interface 1505, as shown in FIG. 15. This further prevents bubble formation within the channel. Breaking the breakable seal 1504 of the sample collection tube 1502 with the second segment of the puncturing element 1509 forms a narrow gap between the puncturing element 1509 and the breakable seal 1504, such that gas trapped between the interface 1505 and the breakable seal 1504 cannot overcome surface tension of liquid contained within the first chamber 1501 of the sample collection tube 1502 to travel through the narrow gap, past the breakable seal 1504, and into the liquid contained within the first chamber 1501 of the sample collection tube 1502, thereby preventing gas bubbles from forming within liquid contained within the first chamber 1501 of the sample collection tube 1502.

The sample collection tube and the interface are oriented with respect to gravity such that the outlet is located in the direction of the force of gravity. This allows for a gravity-driven discharge of fluid from the sample collection tube. In certain embodiments, there is gravity-driven discharge of fluid and therefore no pressurization, pumping, or aspiration required to move the fluid through the channel.

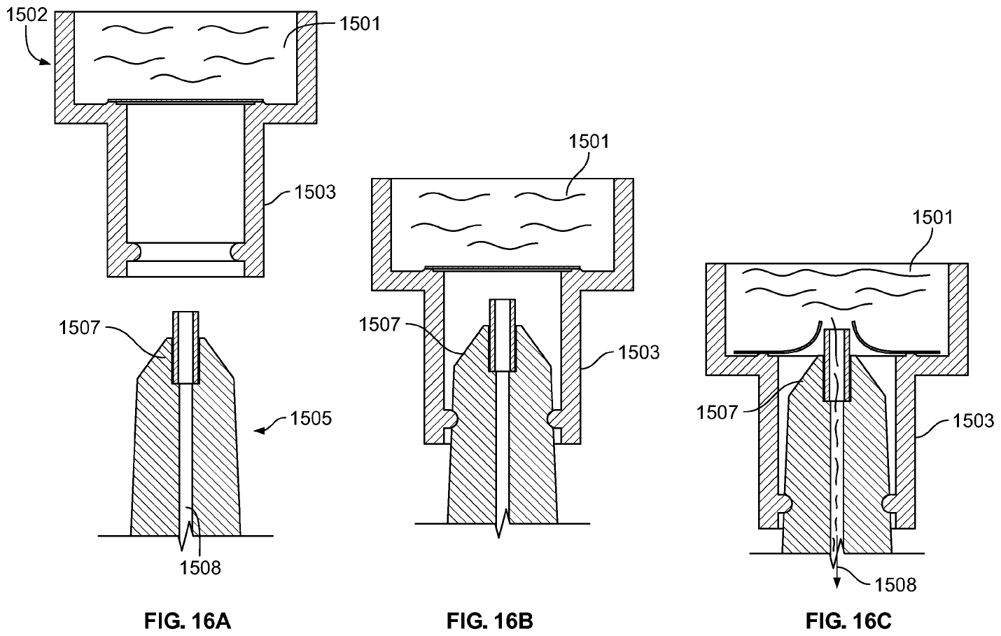

In certain embodiments, the bubble-free puncture mechanism utilizes a seal-before-puncture mechanism (e.g., sealing feature), wherein a seal is formed between the interface and, e.g., the outlet port, prior to puncturing. For example, in certain embodiments, the outlet port is made of deformable material, and optionally, the interface is non-deformable. The interface moves within the outlet port (e.g., slides into, snaps into, translates into, etc.). thereby forming a seal between outlet port and the interface. In certain embodiments, as shown in FIGS. 16A-16C, the interface tapers towards the end with the puncturing element, such that an outer diameter along the length of the interface (sealing outer diameter) is equivalent to an inner diameter of the sample outlet (sealing inner diameter) and a seal is formed as the interface moves within the outlet port (e.g., slides into, snaps into, translates into, etc.). In certain embodiments, the bubble-free mechanism disclosed herein utilizes a Luer-like taper fit for the interface. The use of the Luer-like design for the interface and outlet port allow for a leak-free connection between a male taper fitting (the interface) and the female part (outlet port). This Luer-like design also offers a robust and cheap method for forming bubble-free fluidic seals. In certain embodiments, the Luer-like fit of the interface does not require deformation, but allows for increased area contact by ensuring parallel surfaces engage over longer linear distances than in other fluidic devices. In certain embodiments, two surfaces, one attached to the interface and the other attached to the outlet port contact normally to form a sufficient seal.

In certain embodiments, the bubble-free puncturing mechanism allows for air to vent out of the outlet port as the interface moves within the outlet port (e.g., slides into, snaps into, translates into, etc.). This minimizes air outside of the breakable seal following sealing of the interface with the outlet port.

The interface can be made of suitable material, such as glass, ceramics, metals, paper, pressed cardboard, or polymers, but preferably comprises a plastic. In some embodiments, the interface and the outlet port are comprised of plastic material.

In some embodiments, the interface and/or the outlet port are comprised of deformable material. In some embodiments either or both of the interface and outlet port are comprised of non-deformable material.

Using plastic components (e.g., in the interface) is a cost-effective manufacturing approach. However, plastics tend to be hydrophobic, which makes it difficult to ensure bubble-free filling. In some embodiments, the breakable seal comprises a metallic material. In some embodiments, the puncturing element comprises a plastic material and/or metallic material. In some embodiments, the puncturing element is hydrophilic. The hydrophilicity of the puncturing element counters the hydrophobicity of the plastic component and can aid in the reduction of bubbles.

The puncturing element is made of a material having, at least, adequate hardness to puncture the breakable seal. For example, the puncturing element can be made from a material having 2× the hardness of the breakable seal. In some embodiments, the hardness of the puncturing element relative to the breakable seal is at least at least about 1×, about 2×, about 3×, about 4×, about 5×, about 6×, about 7×, about 8×, about 9×, about 10×, about 11×, about 12×, about 13×, about 14×, about 15× or about 20× times the hardness of the material comprising the breakable seal. The discretion in hardness between the breakable seal and the puncturing element allows for a clear puncture of the breakable seal with repeatable geometry. In certain embodiments, the puncturing element provides for minimal deformation of the puncturing element (or no deformation of the puncturing element). Both of these minimize the possibility of bubble formation in the channel. As used, “clear puncture” refers to an instantaneous puncturing or breaking of the membrane of the entire surface of the puncturing element in contact with the breakable membrane.

Puncturing elements having a blunt tip, tapered tip or sharp tip are contemplated. As used, the term “blunt tip” refers to a non-pointed or non-tapered end of the puncturing element. Sharp tips and/or narrow blunt tips provide for a clear puncture in the breakable seal with minimal deformation of the breakable seal. That minimizes bubble formation in the channel. Without being bound by mechanism or theory, the narrower the puncturing element, the more effective it is at preventing bubble formation. In preferred embodiments, the surface area of an end of the second segment of the puncturing element that is configured to contact the breakable seal is less than 25% of the surface area of the breakable seal, thereby limiting the size and/or number of gas bubbles formed during deformation of the breakable seal and/or that can be introduced through the broken seal. In some embodiments, the surface area of an end of the second segment of the puncturing element that is configured to contact the breakable seal is less than 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25% of the surface area of the breakable seal.

Additionally, a narrow channel increases the likelihood of having the fluid wick through the entire width of the channel and that also minimizes bubble formation in the channel. In some embodiments, the inner diameter of the hollow cylinder of the puncturing element is less than a radius of a meniscus of fluid entering the hollow cylinder. This also facilitates wicking of the fluid through the entire width of the channel. Failure of the fluid to wick through the entire width of the channel (e.g., the fluid only flows down one side) can result in formation of a bubble within the channel.

### VI. Bubble-Free Puncturing Mechanism in Streamlined Testing Assays

The bubble-free puncturing mechanism described herein is also contemplated in the context of all the assays with bi-stable locking mechanisms described in the subject disclosure. For example, in certain embodiments, these sample collection tubes of such assays further comprises an outlet port, the outlet port sealed from the first chamber by the breakable seal. The test cartridges further comprises a fluid transfer mechanism comprising an interface, such that the outlet port is configured to receive the interface of the fluid transfer mechanism.

A channel transects the interface, as shown in FIG. 15. That channel comprises a first end with an inlet proximal to the main chamber and a second end with an outlet leading to a chamber in the test cartridge. The sample collection tube and the interface are oriented with respect to gravity such that the outlet is located in the direction of the force of gravity.

The operative coupling of the sample collection tube and the test cartridge in the second stable state comprises the outlet port receiving the interface of the fluid transfer mechanism such that at least one portion of the interface has a diameter that is equivalent to a diameter of at least one portion of the outlet port and such that the at least one portion of the interface is located within the at least one portion of the outlet port, thereby fluidically sealing the outlet port with the interface and breaking the breakable seal of the sample collection tube with the second segment of the puncturing element, thereby placing the first chamber of the sample collection tube in fluidic communication with the channel of the fluid transfer mechanism and thus with the second chamber of the test cartridge. In certain embodiments, during operative coupling of the sample collection tube and the test cartridge, the interface forms an interference fit with the outlet port, preventing any fluid from leaking between the interface and the interior walls the outlet port.

### VII. Methods

The present disclosure includes methods of determining one or more characteristics of a sample or an aspect thereof, such as a nucleic acid amplification sample, based on a modified property, e.g., a modified optical property, of the sample. The present disclosure includes method of testing a sample for the presence of a pathogen or for indicators of a disease or condition. In some versions, the methods include applying the subject devices or assay assemblies to perform one or more steps of an assay as described herein.

The method of the present disclosure also provide various methods of engagement (e.g., coupling or operative coupling) between the sample collector and sample collection tube, the sample collection tube and base unit, the first chamber or first sub-container and the test cartridge, and the like.

### VIII. Kits

The embodiments disclosed herein also include kits including the subject devices and which can be used according to the subject methods. The subject kits can include two or more, e.g., a plurality, three or less, four or less, five or less, ten or less, or fifteen or less, or fifteen or more, of the devices or device components assay assembly components disclosed herein, according to any of the embodiments described herein, or any combinations thereof.

The kits can include one or more compositions and/or reagents, such as any of those described herein, e.g., optical property modifying reagents, amplification compositions, preparation solutions and/or buffers, which can be stored in the kits in containers separate from the devices. In addition, the kits can include any device or other element which can facilitate the operation of any aspect of the kits. For example, a kit can comprise the sample collection tube and instructions for use. In some embodiments, a kit can comprise the sample collector and instructions for use. In some embodiments, a kit can comprise the base unit and instructions for use. In some embodiments, any combination of the preceding. In some embodiments, a kit can comprise a sample collector coupled to a sample collection tube.

In certain embodiments, the kits which are disclosed herein include instructions, such as instructions for using devices. The instructions for using devices are, in some aspects, recorded on a suitable recording medium. For example, the instructions can be printed on a substrate, such as paper or plastic, etc. As such, the instructions can be present in the kits as a package insert, in the labeling of the container of the kit or components thereof (i.e., associated with the packaging or subpackaging etc.). In other embodiments, the instructions are present as an electronic storage data file present on a suitable computer readable storage medium, e.g., Portable Flash drive, CD-ROM, diskette, on the cloud, etc. The instructions can be storable and/or reproducible within one or more programs, such as computer applications. The instructions can take any form, including complete instructions for how to use the devices or as a website address with which instructions posted on the world wide web can be accessed.

### IX. Additional Considerations

All references, issued patents and patent applications cited within the body of the specification are hereby incorporated by reference in their entirety, for all purposes.

The foregoing description of the embodiments of the invention has been presented for the purpose of illustration—it is not intended to be exhaustive or to limit the invention to the precise forms disclosed. Persons skilled in the relevant art can appreciate that many modifications and variations are possible in light of the above disclosure.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention.

### EXAMPLES

Below are examples of specific embodiments for carrying out the present invention. The examples are offered for illustrative purposes only, and are not intended to limit the scope of the present invention in any way. Efforts have been made to ensure accuracy with respect to numbers used (e.g., amounts, temperatures, etc.), but some experimental error and deviation should, of course, be allowed for.

The practice of the present invention will employ, unless otherwise indicated, conventional methods of protein chemistry, biochemistry, recombinant DNA techniques and pharmacology, within the skill of the art. Such techniques are explained fully in the literature. See, e.g., T. E. Creighton, Proteins: Structures and Molecular Properties (W.H. Freeman and Company, 1993); A. L. Lehninger, Biochemistry (Worth Publishers, Inc., current addition); Sambrook, et al., Molecular Cloning: A Laboratory Manual (2nd Edition, 1989); Methods In Enzymology (S. Colowick and N. Kaplan eds., Academic Press, Inc.); Remington's Pharmaceutical Sciences, 18th Edition (Easton, Pennsylvania: Mack Publishing Company, 1990); Carey and Sundberg Advanced Organic Chemistry 3^{rd} Ed. (Plenum Press) Vols A and B(1992).

### Example 1: Effect of Agitator Features on Elution Efficiency

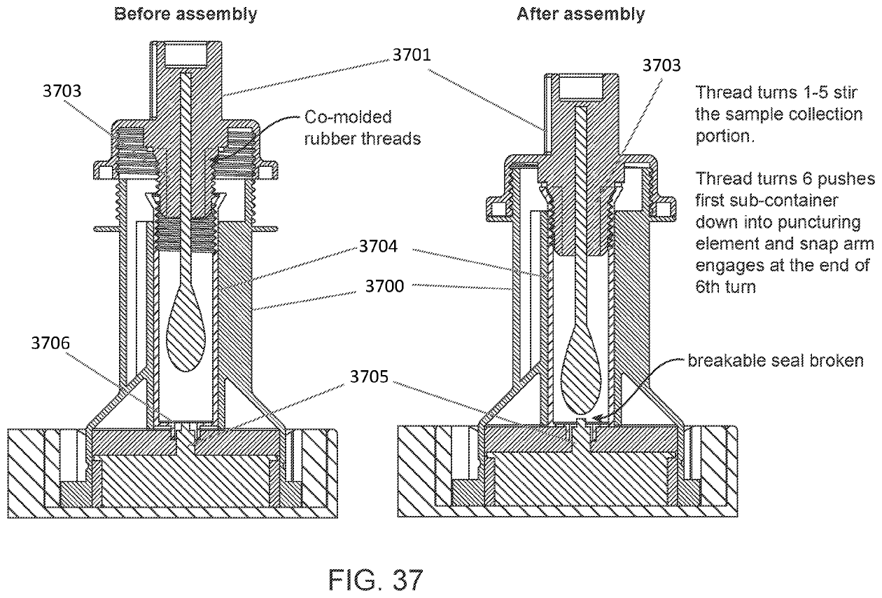

An experiment was conducted to determine the effect of number of agitator features on sample elution. Briefly, groups A-E were set up as indicated in Table 1. In each of group, ribs on the inner circumference of the sample collection tube would serve as the agitator features, if any. Each group had a sample collector (e.g. wherein the sample collection portion is a swab). The swab was dipped in 35 μL PN Dyed Mucin Solution, which was inserted into a sample collection tube comprising 2.5 mL of clear buffer. Group A had a sample collection tube with no agitator feature and the swab was not stirred. Group B had a sample collection tube with an agitator feature and the swab was stirred inside the clear buffer. Groups C and E both had 4 agitator features in their sample collection tubes, only the agitator features in group E extended farther towards the center of the sample collection tube. All five groups had the caps complete 3 complete rotations, resulting in three complete revolutions of the swab within the sample collection tube, for elution, before a sample (300 μL) of the solution was taken and absorbance of the mucin dye was obtained as a measure for sample elution. The absorbance was obtained at a wavelength of 590 nm. FIG. 39 shows the swabs from each group in the buffer of their sample collection tubes following elution. The positive control group was a “well-mixed” solution having 35 μL PN Dyed Mucin Solution and 2.465 mL clear buffer.

TABLE 1
Experimental setup and results from agitator experiment

| | Stir | | Average | | % Difference |
|---|---|---|---|---|---|
| | Type | Tube Type | Absorbance | Std Dev | from Control |
| Control | N/A | N/A | 0.019 | 0.002 | |
| Group | | | | | |
| Group A | No Stir | No Rib | −0.005 | N/A | |
| Group B | Stir | No Rib | −0.001 | 0.002 | |
| Group C | Stir | 4 Rib | 0.016 | 0.003 | 12.0% |
| Group D | Stir | 8 Rib | 0.018 | 0.006 | 1.2% |
| Group E | Stir | Long 4 Rib | 0.015 | 0.005 | 19.2% |

The results showed that elution efficiency increased with the number of agitators.

### Example 2: Effect of Rotations and Agitator Features on Elution Efficiency

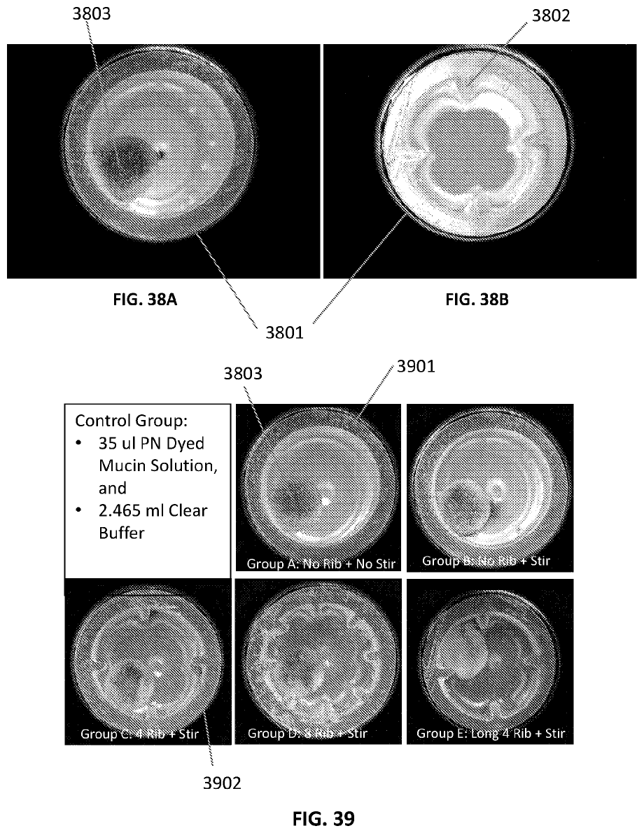

An experiment was conducted to determine the effect of number of agitator features on sample elution in combination with the number of complete rotations of the swab. Briefly, the experimental set up is shown in Table 2. Three groups (A-C) had a sample collection tube that only allowed for 1 complete rotation of the swab (see thread type). Groups D-F allowed for 3 complete rotations of the swab, while groups G-I allowed for 5 complete rotations of the swab. For each of the rotation groups, agitator number was tested (4 vs. 8 agitators) and the impact of a concave rib tube (a type of concave agitator tube as defined supra). FIG. 40 shows a swab in a concave rib tube. Once again, had a sample collector (e.g. wherein the sample collection portion is a swab). The swab was dipped in 35 μL PN Dyed Mucin Solution, which was inserted into a sample collection tube comprising 2.5 mL of clear buffer. The total number of complete revolutions of the swab within the sample collection tube was determined by the thread type (e.g., 1 thread=1 complete rotation of the cap=1 complete revolution of the swab within the sample collection tube). The swab revolutions were for the indicated number of complete rotations (see thread type column in Table 1B). After the indicated number of revolutions (the elution), a sample (300 μL) of the solution was taken from the top half and a sample (300 μL) of the solution was taken from the bottom half of the sample collection tube. Absorbance of each of the samples was measured at a wavelength of 590 nm, as a measure of sample elution. The positive control group was a “well-mixed” solution having 35 μL PN Dyed Mucin Solution and 2.465 mL clear buffer. The absorbance of the control was 0.263 and the standard deviation (Std. Dev.) was 0.004.

TABLE 2
Experimental setup from agitator, tube type and number-of-rotations experiment

| | | | Bottom Sample | | | Top Sample | | |
|---|---|---|---|---|---|---|---|---|
| | | | | | % | | | % |
| | | | | | Difference | | | Difference |
| | Thread | Tube | Average | | from | | | from |
| Group | Type | Type | Absorbance | Std Dev | Control | Average | Std Dev | Control |
| A | 1 | 4 Rib | 0.043 | 0.025 | 83.7% | 0.097 | 0.030 | 63.2% |
| B | 1 | 8 Rib | 0.021 | 0.032 | 91.9% | 0.113 | 0.019 | 57.0% |
| C | 1 | Concave Rib | 0.047 | #DIV/0! | 82.1% | 0.137 | #DIV/0! | 47.9% |
| D | 3 | 4 Rib | 0.166 | 0.045 | 36.8% | 0.164 | 0.011 | 37.5% |
| E | 3 | 8 Rib | 0.079 | 0.041 | 69.8% | 0.207 | 0.091 | 21.2% |
| F | 3 | Concave Rib | 0.109 | 0.089 | 58.6% | 0.155 | 0.067 | 41.1% |
| G | 5 | 4 Rib | 0.086 | 0.035 | 67.4% | 0.229 | 0.032 | 13.1% |
| H | 5 | 8 Rib | 0.034 | 0.006 | 87.2% | 0.221 | 0.041 | 16.0% |
| I | 5 | Concave Rib | 0.176 | 0.013 | 33.2% | 0.235 | 0.019 | 10.6% |

The results indicated that increasing complete rotations improve elution efficiency. The results also indicated improved elution efficiency when using a concave agitator tube. For many groups, tube types having 4 agitator features had greater elution than those having 8 ribs. A potential explanation for this may be that the springing of the swab from one agitator feature to the next agitator feature in the 4-rib tube contributed to greater elution.

What is claimed is:

1. An assay assembly, the assembly comprising:
a. a sample collection tube comprising:
a first chamber;
a breakable seal or valve; and
a test cartridge comprising a sample inlet and one or more reaction chambers;
b. a base unit comprising:
a heating element; and
a power supply; and
c. a sample collector comprising:
a handle comprising a cap that is operatively coupleable with the sample collection tube; and
a sample collection portion.

2. The assay assembly of claim 1, further comprising:
a. a bi-stable locking mechanism having at least one first state and at least one second state;
wherein the first state of the bi-stable locking mechanism comprises the first chamber and the test cartridge coupled in the first stable state, and wherein the at least one second state of the bistable locking mechanism is responsive to the sample collector being operatively coupled with the sample collection tube and wherein the at least one second state of the bistable locking mechanism comprises the first chamber being operatively coupled to the test cartridge in the second stable state; and
b. a fluidic coupling mechanism, wherein responsive to the sample collector operatively coupling the first chamber and the test cartridge in the second stable state, the fluidic coupling mechanism is configured to place the first chamber of the sample collection tube in fluidic communication with the test cartridge.

3. The assay assembly of claim 2, wherein the sample collection tube further comprises a sample collection tube holder, wherein the sample collection tube holder is configured to operatively couple the first chamber and the test cartridge in a first stable state and in a second stable state.

4. The assay assembly of claim 3, wherein the sample collection tube comprises the breakable seal.

5. The assay assembly of claim 3, wherein the sample collection tube comprises the valve.

6. The assay assembly of any one of claims 1-3, wherein the first chamber of the sample collection tube comprises a first sub-container and a second sub-container, wherein the first sub-container and the test cartridge are sealed from one another by a breakable seal,
wherein when the sample collector is operatively coupled to the sample collection tube in the second stable state, the sample collection portion of the sample collector is located within the first sub-container and breaks the breakable seal, thereby placing the first sub-container in fluidic communication with the test cartridge of the sample collection tube.

7. The assay assembly of any one of claims 1-3, wherein the first chamber of the sample collection tube comprises a first sub-container and a second sub-container, wherein the first sub-container and the test cartridge are sealed from one another by a breakable seal, wherein the test cartridge comprises a puncturing element,
wherein when the sample collector is operatively coupled to the sample collection tube in the second stable state, the puncturing element breaks the breakable seal thereby placing the first sub-container in fluidic communication with the test cartridge of the sample collection tube.

8. The assay assembly of any one of claims 2-7, wherein:
a. the cap of the sample collector is a snap-on cap that is operatively coupleable with the sample collection tube,
b. the fluidic coupling mechanism comprises (i) a breakable seal of the sample collection tube and a puncturing element of the test cartridge or (ii) an actuable valve of the sample collection tube,
c. the at least one first state of the bistable locking mechanism comprises the snap-on cap not being operatively coupled to the sample collection tube,
d. the at least one second state of the bistable locking mechanism comprises the snap-on cap being operatively coupled to the sample collection tube,
e. the coupling of the sample collection tube and the test cartridge in the first stable state comprises: (i) the puncturing element of the test cartridge not breaking the breakable seal of the sample collection tube or (ii) not actuating the actuable valve, and
f. the operative coupling of the sample collection tube and the test cartridge in the second stable state comprises: (i) the puncturing element of the test cartridge breaking the breakable seal of the sample collection tube or (ii) actuating the actuable valve, thereby placing the first chamber of the sample collection tube in fluidic communication with the test cartridge.

9. The assay assembly of any one of claims 2-7, wherein:
a. the test cartridge comprises a twist feature,
b. the fluidic coupling mechanism comprises: (i) a breakable seal of the first chamber and a puncturing element of the test cartridge or (ii) an actuable valve of the first chamber,
c. the at least one first state of the bistable locking mechanism comprises the twist feature not being twisted,
d. the at least one second state of the bistable locking mechanism comprises the twist feature being twisted,
e. the operative coupling of the first chamber or the first sub-container and the test cartridge in the first stable state comprises: (i) the puncturing element of the test cartridge not breaking the breakable seal of first chamber or (ii) not actuating the actuable valve, and
f. the operative coupling of the first chamber or the first sub-container and the test cartridge in the second stable state comprises: (i) the puncturing element of the test cartridge breaking the breakable seal of the first chamber or (ii) actuating the actuable valve, thereby placing the first chamber of the sample collection tube in fluidic communication with the test cartridge.

10. The assay assembly of any one of claims 2-7, wherein:
a. the cap of the sample collector is a twist-on cap that is operatively coupleable with the sample collection tube,
b. the fluidic coupling mechanism comprises: (i) a breakable seal of the first chamber or the first sub-container and a puncturing element of the test cartridge or (ii) an actuable valve,
c. the at least one first state of the bistable locking mechanism comprises the twist-on cap not being operatively coupled to the sample collection tube,
d. the at least one second state of the bistable locking mechanism comprises the twist-on cap being operatively coupled to the first chamber or the first sub-container,
e. the operative coupling of the first chamber or the first sub-container and the test cartridge in the first stable state comprises: (i) the puncturing element of the test cartridge not breaking the breakable seal of the first chamber or the first sub-container or (ii) not actuating the actuable valve, and
f. the operative coupling of the first chamber or the first sub-container and the test cartridge in the second stable state comprises: (i) the puncturing element of the test cartridge breaking the breakable seal of the first chamber or the first sub-container or (ii) actuating the actuable valve, thereby placing the first chamber of the sample collection tube in fluidic communication with the test cartridge.

11. The assay assembly of claim 10, wherein responsive to the bistable locking mechanism being in the at least one second state such that the twist-on cap is operatively coupled to the sample collection tube, the twist-on cap seals the sample collection tube.

12. The assay assembly of claim 10 or 11, wherein responsive to the bistable locking mechanism being in the at least one second state such that the twist-on cap is operatively coupled to the sample collection tube and the sample collection portion of the sample collector is located within the first chamber of the sample collection tube, the sample collection portion of the sample collector breaks the breakable seal of the sample collection tube, thereby placing the first chamber of the sample collection tube in fluidic communication with the test cartridge.

13. The assay assembly of any one of claims 2-7, wherein:
a. the bi-stable locking mechanism comprises a key feature of the first chamber or the first sub-container and a threaded feature of the test cartridge, the key feature and the threaded feature operatively couplable with one another,
b. the fluidic coupling mechanism comprises: (i) a breakable seal of the first chamber or the first sub-container and a puncturing element of the test cartridge or (ii) an actuable valve,
c. the at least one first state comprises the key feature of the first chamber or the first sub-container not being operatively coupled to the threaded feature of the test cartridge,
d. the at least one second state comprises the key feature of the first chamber or the first sub-container being operatively coupled to the threaded feature of the test cartridge,
e. the operative coupling of the sample collection tube and the test cartridge in the first stable state comprises: (i) the puncturing element of the test cartridge not breaking the breakable seal of the first chamber or the first sub-container or (ii) not actuating the actuable valve, and
f. the operative coupling of the sample collection tube and the test cartridge in the second stable state comprises: (i) the puncturing element of the test cartridge breaking the breakable seal of the first chamber or the first sub-container or (ii) actuating the actuable valve, thereby placing the first chamber of the sample collection tube in fluidic communication with the test cartridge.

14. An assay assembly, the assembly comprising:
a. a sample collection tube comprising:
a first chamber;
a breakable seal or valve; and
a test cartridge comprising a sample inlet and one or more reaction chambers;
b. a base unit comprising:
a heating element; and
a power supply;
c. a cap; and
d. a bi-stable locking mechanism having at least one first state and at least one second state;
wherein the first state of the bi-stable locking mechanism comprises the first chamber and the test cartridge coupled in the first stable state, and wherein the second state of the bistable locking mechanism is responsive to the cap being operatively coupled with the sample collection tube and wherein the second state of the bistable locking mechanism comprises the first chamber being operatively coupled to the test cartridge in the second stable state; and
b. a fluidic coupling mechanism, wherein responsive to the sample collector operatively coupling the first chamber and the test cartridge in the second stable state, the fluidic coupling mechanism is configured to place the first chamber of the sample collection tube in fluidic communication with the test cartridge.

15. The assay assembly of any one of claims 2-7 and 14, wherein:
a. the bi-stable locking mechanism comprises a twist feature of the first chamber or the first sub-container,
b. the fluidic coupling mechanism comprises (i) a breakable seal of the first chamber or the first sub-container and a puncturing element of the test cartridge or (ii) an actuable valve,
c. the at least one first state comprises the twist feature not being twisted,
d. the at least one second state comprises the twist feature being twisted,
e. the operative coupling of the first chamber or the first sub-container and the test cartridge in the first stable state comprises: (i) the puncturing element of the test cartridge not breaking the breakable seal of the first chamber or the first sub-container or (ii) not actuating the actuable valve, and
f. the operative coupling of the first chamber or the first sub-container and the test cartridge in the second stable state comprises: (i) the puncturing element of the test cartridge breaking the breakable seal of the first chamber or the first sub-container or (ii) actuating the actuable valve, thereby placing the first chamber of the sample collection tube in fluidic communication with the test cartridge.

16. The assay assembly of claim 15, wherein responsive to the bistable locking mechanism being in the second state, the twist feature of the sample collection tube is capable of being twisted, thereby operatively coupling the sample collection tube and the test cartridge in the second stable state, thereby breaking the breakable seal of the sample collection tube with the puncturing element of the test cartridge, and thereby placing the first chamber of the sample collection tube in fluidic communication with the test cartridge.

17. The assay assembly of claim 15 or 16, further comprising a sample collector comprising a breakable sample collection portion, and wherein:
a. the sample collection tube and the cap each comprise an opening sized to fit the sample collection portion of the sample collector,
b. wherein in the at least one first state in which the cap is not operatively coupled to the sample collection tube and the at least one second state in which the cap is operatively coupled to the sample collection tube, the opening of the sample collection tube and the opening of the cap are aligned to receive the sample collection portion of the sample collector within the first chamber of the sample collection tube,
c. an interior portion of the cap comprises a blade, and
d. responsive to the at least one second state in which the cap is operatively coupled to the sample collection tube, the blade is configured to dislocate the sample collection portion from the sample collector and into the first chamber of the sample collection tube.

18. The assay assembly of any one of claims 1-15, wherein the first chamber of the sample collection tube comprises an agitator feature.

19. The assay assembly of any one of claims 6-15, wherein the first sub-container of the first chamber comprises an agitator feature.

20. The assay assembly of claim 18 or 19, wherein the agitator feature is one or more selected from the following group: ribs, fins, tabs, ridges, wipers, brushes, and beads.

21. The assay assembly of claim 20, where the agitator feature is a rib.

22. The assay assembly of any one of claims 18 and 20-21, wherein the first chamber of the sample collection tube comprises a plurality of agitator features.

23. The assay assembly of any one of claims 18, 19 and 21, wherein the first sub-container of the first chamber comprises a plurality of agitator features.

24. The assay assembly of claim 22 or 23, wherein the plurality of agitator features is at least 4 agitator features.

25. The assay assembly of claim 24, wherein the total number of agitator features in the first chamber or the first sub-container is 4.

26. The assay assembly of claim 24, wherein the total number of agitator features in the first chamber or the first sub-container is between 4 and 8.

27. The assay assembly of any one of claims 22-24, wherein the plurality of agitator features is at least 8 agitator features.

28. The assay assembly of claim 27, wherein the total number of agitator features in the first chamber or the first sub-container is 8.

29. The assay assembly of any one of claims 18-27, wherein the mixing efficiency increases with the number of agitator features in the first chamber or the first sub-container.

30. The assay assembly of any one of claims 18-27, wherein the mixing efficiency increases with the number of agitator features in the first chamber or in the first sub-container.

31. The assay assembly of any one of claims 18-27, wherein the mixing efficiency is increased when the total number of agitator features in the first chamber or in the first sub-container is between 1 and 8 relative to a first chamber or first sub-container having no agitator features.

32. The assay assembly of any one of claims 10-12 and 18-31, wherein the sample collection portion of the sample collector is offset from an axis of rotation of the twist-on cap, such that, during rotation of the twist-on cap about the axis of rotation, the sample collection portion rotates off the axis of rotation of the sample handle and maximizes volume contact.

33. The assay assembly of any one of claims 10-12 and 18-31, wherein the handle of the sample collector is offset from the center of the twist-on cap, such that the sample collection portion rotates outside of the center axis of the twist-on cap.

34. The assay assembly of claim 33, wherein the sample collection portion rotates in contact with the inner walls of the first chamber or the first sub-container.

35. The assay assembly of any one of claims 18-31, wherein the handle of the sample collector is offset from the center of the twist-on cap, such that the sample collection portion rotates outside of the center axis of the twist-on cap, and wherein the sample collection portion rotates and maintains in contact with at least one of the agitator features of the first chamber or the first sub-container.

36. The assay assembly of any one of claims 18-35, wherein the agitator features form a concave agitator tube.

37. The assay assembly of any one of the preceding claims, wherein the base unit further comprises one or more selected from the following: a camera, a printed circuit board, an electronic display, one or more sensors, one or more light pipes, a light source, and a control unit.

38. The assay assembly of any one of the preceding claims, wherein the base unit comprises a base unit engagement holder, wherein the base unit engagement holder is configured to operatively couple the sample collection tube and base unit in a third stable state.

39. The assay assembly of claim 38, wherein the operative coupling of the sample collection tube and the base unit in the third stable state is reversible.

40. The assay assembly of claim 38 or 39, wherein:
a. an exterior surface of the sample collection tube comprises alignment features,
b. the base unit engagement holder comprises a shelf having gaps configured to align with and sized to fit the alignment features of the sample collection tube, and
c. responsive to the alignment features of the sample collection tube aligning with the gaps in the shelf of the base unit engagement holder, the base unit engagement holder operatively couples the sample collection tube and the base unit in the third stable state.

41. The assay assembly of any one of claims 38-40, wherein:
a. the exterior surface of the sample collection tube comprises notches, and
b. the base unit engagement holder comprises hooks positioned, optionally below a shelf having gaps in the base unit engagement holder, wherein the hooks are configured to interlock with the notches of the sample collection tube, and
c. responsive to the notches of the sample collection tube aligning with the hooks of the base unit engagement holder, the base unit engagement holder operatively couples the sample collection tube and the base unit in the third stable state.

42. The assay assembly of claim 38 or 39, wherein:
a. the base unit engagement holder comprises one or more snap features,
b. the exterior surface of the sample collection tube has a mating feature configured to couple with the one or more snap features, and
c. responsive to the snap features of the base unit engagement holder tube aligning with the mating feature of the sample collection tube, the base unit engagement holder operatively couples the sample collection tube and the test cartridge in the third stable state.

43. The assay assembly of claim 42, wherein the one or more snap features is one or more cantilever snap features.

44. The assay assembly of claim 42, wherein the one or more snap features is one or more annular snap features.

45. The assay assembly of claim 42, wherein the one or more snap features is one or more torsion snap features.

46. The assay assembly of claim 38 or 39, wherein: the base unit engagement holder comprises a detent configured to operatively couple the sample collection tube and the base unit engagement holder in the third stable state.

47. The assay assembly of claim 38 or 39, wherein:
a. an exterior surface of the sample collection tube comprises an alignment feature,
b. the base unit engagement holder comprises a shelf configured to align with and sized to fit the alignment features of the sample collection tube and allow sliding of the alignment feature of the sample collection tube under the shelf of the base unit engagement holder,
c. the base unit engagement holder or the exterior surface of the sample collection tube has a sliding lock, and
d. responsive to the alignment feature of the sample collection tube sliding under the shelf of the base unit engagement holder, the base unit engagement holder operatively couples the sample collection tube and the base unit in the third stable state.

48. The assay assembly of claim 38 or 39, wherein:
a. the base unit engagement holder comprises a push lock,
b. the exterior surface of the sample collection tube comprises a mating feature configured to align with and sized to engage with the push lock, and
c. responsive to the mating feature of the sample collection tube sliding operatively connecting to the push lock of the base unit engagement holder, the base unit engagement holder operatively couples the sample collection tube and the base unit in the third stable state.

49. An assay assembly, the assembly comprising:
a. a sample collection tube comprising a first chamber;
b. a test cartridge comprising:
a sample inlet,
one or more reaction chambers, and
a sample collection tube holder, wherein the sample collection tube holder is configured to operatively couple the sample collection tube and the test cartridge in a first stable state and in a second stable state;
c. a bi-stable locking mechanism having at least one first state and at least one second state,
wherein the first state of the bi-stable locking mechanism comprises the sample collection tube holder operatively coupling the sample collection tube and the test cartridge in the first stable state, and the second state of the bistable locking mechanism comprises the sample collection tube holder operatively coupling the sample collection tube and the test cartridge in the second stable state; and
d. a fluidic coupling mechanism, wherein responsive to the sample collection tube holder operatively coupling the sample collection tube and the test cartridge in the second stable state, the fluidic coupling mechanism is configured to place the first chamber of the sample collection tube in fluidic communication with the sample inlet of the test cartridge.

50. The assay assembly of claim 49, wherein:
a. the bi-stable locking mechanism comprises a snap-on cap that is operatively coupleable with the sample collection tube,
b. the fluidic coupling mechanism comprises (i) a breakable seal of the sample collection tube and a puncturing element of the test cartridge or (ii) an actuable valve of the sample collection tube,
c. the at least one first state of the snap-on cap comprises the snap-on cap not being operatively coupled to the sample collection tube,
d. the at least one second state of the snap-on cap comprises the snap-on cap being operatively coupled to the sample collection tube,
e. the operative coupling of the sample collection tube and the test cartridge in the first stable state comprises: (i) the puncturing element of the test cartridge not breaking the breakable seal of the sample collection tube or (ii) not actuating the actuable valve, and
f. the operative coupling of the sample collection tube and the test cartridge in the second stable state comprises: (i) the puncturing element of the test cartridge breaking the breakable seal of the sample collection tube or (ii) actuating the actuable valve, thereby placing the first chamber of the sample collection tube in fluidic communication with the sample inlet of the test cartridge.

51. The assay assembly of claim 49, wherein:
a. the bi-stable locking mechanism comprises a twist feature of the test cartridge,
b. the fluidic coupling mechanism comprises: (i) a breakable seal of the sample collection tube and a puncturing element of the test cartridge or (ii) an actuable valve of the sample collection tube,
c. the at least one first state of the twist feature comprises the twist feature not being twisted,
d. the at least one second state of the twist feature comprises the twist feature being twisted,
e. the operative coupling of the sample collection tube and the test cartridge in the first stable state comprises: (i) the puncturing element of the test cartridge not breaking the breakable seal of the sample collection tube or (ii) not actuating the actuable valve, and
f. the operative coupling of the sample collection tube and the test cartridge in the second stable state comprises: (i) the puncturing element of the test cartridge breaking the breakable seal of the sample collection tube or (ii) actuating the actuable valve, thereby placing the first chamber of the sample collection tube in fluidic communication with the sample inlet of the test cartridge.

52. The assay assembly of claim 49, wherein:
a. the bi-stable locking mechanism comprises a twist-on cap that is operatively coupleable with the sample collection tube,
b. the fluidic coupling mechanism comprises: (i) a breakable seal of the sample collection tube and a puncturing element of the test cartridge or (ii) an actuable valve,
c. the at least one first state of the twist-on cap comprises the twist-on cap not being operatively coupled to the sample collection tube,
d. the at least one second state of the twist-on cap comprises the twist-on cap being operatively coupled to the sample collection tube,
e. the operative coupling of the sample collection tube and the test cartridge in the first stable state comprises: (i) the puncturing element of the test cartridge not breaking the breakable seal of the sample collection tube or (ii) not actuating the actuable valve, and
f. the operative coupling of the sample collection tube and the test cartridge in the second stable state comprises: (i) the puncturing element of the test cartridge breaking the breakable seal of the sample collection tube or (ii) actuating the actuable valve, thereby placing the first chamber of the sample collection tube in fluidic communication with the sample inlet of the test cartridge.

53. The assay assembly of claim 52, wherein:
the twist-on cap comprises a handle of a sample collector, the sample collector comprises the handle and a sample collection portion, and responsive to the twist-on cap being in the at least one second state such that the twist-on cap is operatively coupled to the sample collection tube, the sample collection portion of the sample collector is located within the first chamber of the sample collection tube.

54. The assay assembly of any one of claims 10-12, 18-48, 5253, wherein the twist-on cap includes a first attachment element and the sample collection tube includes a second attachment element that is operatively coupleable with the first attachment element.

55. The assay assembly of claim 54, wherein the first attachment element comprises threading and the second attachment element comprises reciprocating threading configured to slidably receive the threading.

56. The assay assembly of claim 55, wherein the reciprocating threading of the sample collection tube is configured to slidably receive ½ to 10 complete rotations of the threading of the twist-on cap.

57. The assay assembly of claim 55, wherein the reciprocating threading of the sample collection tube is configured to slidably receive at least 3 complete rotations of the threading of the twist-on cap to reach the at least one second state such that the twist-on cap is operatively coupled to the sample collection tube.

58. The assay assembly of claim 55, wherein the reciprocating threading of the sample collection tube is configured to slidably receive at least 5 complete rotations of the threading of the twist-on cap to reach the at least one second state such that the twist-on cap is operatively coupled to the sample collection tube.

59. The assay assembly of claim 55, wherein the reciprocating threading of the sample collection tube is configured to slidably receive 3 to 5 complete rotations of the threading of the twist-on cap to reach the at least one second state such that the twist-on cap is operatively coupled to the sample collection tube.

60. The assay assembly of any one of claims 57-59, wherein the number of complete rotations of the threading of the twist-on cap increases the elution efficiency relative to an sample collection tube configured to receive fewer complete rotations to reach the at least one second state.

61. The assay assembly of any one of claims 52-56, wherein responsive to the twist-on cap being in the at least one second state such that the twist-on cap is operatively coupled to the sample collection tube, the twist-on cap seals the sample collection tube.

62. The assay assembly of any one of claims 53-61, wherein responsive to the twist-on cap being in the at least one second state such that the twist-on cap is operatively coupled to the sample collection tube and the sample collection portion of the sample collector is located within the first chamber of the sample collection tube, the sample collection portion of the sample collector breaks the breakable seal of the sample collection tube, thereby placing the first chamber of the sample collection tube in fluidic communication with the sample inlet of the test cartridge.

63. The assay assembly of claim 62, wherein the breakable seal is proximal to an outlet of the sample collection tube such that, responsive to the sample collection portion of the sample collector breaking the breakable seal, the sample collection portion is proximal to the outlet of the sample collection tube, thereby maximizing sample content from the sample collection portion proximal to the outlet of the sample collection tube.

64. The assay assembly of any one of claims 53-63, wherein the first chamber of the sample collection tube comprises a first sub-container and a second sub-container, the first sub-container and the second sub-container sealed from one another by a second breakable seal on the first sub-container, and wherein responsive to the twist-on cap being in the at least one second state such that the twist-on cap is operatively coupled to the sample collection tube and the sample collection portion of the sample collector is located within the first chamber of the sample collection tube, the sample collection portion of the sample collector breaks the second breakable seal of the sample collection tube, thereby placing the first sub-container of the sample collection tube in fluidic communication with the second sub-container of the sample collection tube.

65. The assay assembly of any one of claims 53-64, wherein the sample collection portion of the sample collector is offset from an axis of rotation of the twist-on cap, such that, during rotation of the twist-on cap about the axis of rotation, the sample collection portion rotates off the axis of rotation of the sample handle and maximizes volume contact.

66. The assay assembly of any one of claims 1-65, wherein the first chamber of the sample collection tube contains agitator features.

67. The assay assembly of claim 66, wherein the agitator features are any one or more of ribs, fins, tabs, ridges, wipers, brushes, and beads.

68. The assay assembly of claim 49, wherein:
a. the bi-stable locking mechanism comprises a key feature of the sample collection tube and a threaded feature of the test cartridge, the key feature and the threaded feature operatively couplable with one another,
b. the fluidic coupling mechanism comprises: (i) a breakable seal of the sample collection tube and a puncturing element of the test cartridge or (ii) an actuable valve,
c. the at least one first state comprises the key feature of the sample collection tube not being operatively coupled to the threaded feature of the test cartridge,
d. the at least one second state comprises the key feature of the sample collection tube being operatively coupled to the threaded feature of the test cartridge,
e. the operative coupling of the sample collection tube and the test cartridge in the first stable state comprises: (i) the puncturing element of the test cartridge not breaking the breakable seal of the sample collection tube or (ii) not actuating the actuable valve, and
f. the operative coupling of the sample collection tube and the test cartridge in the second stable state comprises: (i) the puncturing element of the test cartridge breaking the breakable seal of the sample collection tube or (ii) actuating the actuable valve, thereby placing the first chamber of the sample collection tube in fluidic communication with the sample inlet of the test cartridge.

69. The assay assembly of claim 13 or 68, wherein the sample collection tube is configured to be inverted for operative coupling to the test cartridge, such that the cap operatively coupled to the sample collection tube and forming the key feature operatively couples to the test cartridge.

70. The assay assembly of claim 69, wherein the cap at least in part comprises the breakable seal.

71. The assay assembly of any one of claims 13 and 68-70, wherein an end of the sample collection tube opposite the cap operatively coupled to the sample collection tube comprises a knob configured to enable twisting of the sample collection tube operatively coupled to the test cartridge.

72. The assay assembly of claim 49, wherein:
a. the bi-stable locking mechanism comprises a twist feature of the sample collection tube,
b. the fluidic coupling mechanism comprises a breakable seal of the sample collection tube and a puncturing element of the test cartridge,
c. the at least one first state of the twist feature comprises the twist feature not being twisted,
d. the at least one second state of the twist feature comprises the twist feature being twisted,
e. the operative coupling of the sample collection tube and the test cartridge in the first stable state comprises the puncturing element of the test cartridge not breaking the breakable seal of the sample collection tube, and
f. the operative coupling of the sample collection tube and the test cartridge in the second stable state comprises the puncturing element of the test cartridge breaking the breakable seal of the sample collection tube, thereby placing the first chamber of the sample collection tube in fluidic communication with the sample inlet of the test cartridge.

73. The assay assembly of claim 72, wherein:
a. the bi-stable locking mechanism further comprises a cap that is operatively coupleable with the sample collection tube,
b. the at least one first state of the cap comprises the cap not being operatively coupled to the sample collection tube, and
c. the at least one second state of the cap comprises the cap being operatively coupled to the sample collection tube.

74. The assay assembly of claim 73, wherein responsive to the cap being in the at least one second state such that the cap is operatively coupled to the sample collection tube, the twist feature of the sample collection tube is capable of being twisted, thereby placing the twist feature in the at least one second state, thereby operatively coupling the sample collection tube and the test cartridge in the second stable state, thereby breaking the breakable seal of the sample collection tube with the puncturing element of the test cartridge, and thereby placing the first chamber of the sample collection tube in fluidic communication with the sample inlet of the test cartridge.

75. The assay assembly of any one of claims 1-74, wherein the cap comprises a lockout release arm configured to prevent the cap from transitioning from the at least one second state in which the cap is operatively coupled to the sample collection tube to the at least one first state in which the cap is not operatively coupled to the sample collection tube.

76. The assay assembly of any one of claims 1-10, 12-16, and 73-75, wherein in the at least one second state, the cap is operatively coupled to the sample collection tube, and the cap seals the sample collection tube.

77. The assay assembly of any one of claims 73-76, further comprising a sample collector comprising at least a breakable sample collection portion, and wherein:
a. the sample collection tube and the cap each comprise an opening sized to fit the sample collection portion of the sample collector,
b. responsive to the cap being positioned between the at least one first state in which the cap is not operatively coupled to the sample collection tube and the at least one second state in which the cap is operatively coupled to the sample collection tube, the opening of the sample collection tube and the opening of the cap are aligned to receive the sample collection portion of the sample collector within the first chamber of the sample collection tube,
c. an interior portion of the cap comprises a blade, and
d. responsive to the cap being in the at least one second state in which the cap is operatively coupled to the sample collection tube, the blade is configured to dislocate the sample collection portion from the sample collector and into the first chamber of the sample collection tube.

78. The assay assembly of any one of claims 1-72, wherein the first chamber of the sample collection tube comprises a flared volume.

79. The assay assembly of claim 78, further comprising a cap that is operatively coupleable with the sample collection tube, and wherein:
a. the cap comprises a portion of a sample collector,
b. the sample collector comprises a handle and a sample collection portion, and
c. responsive to the cap being operatively coupled to the sample collection tube, the sample collection portion of the sample collector is located within the first chamber of the sample collection tube.

80. The assay assembly of claim 79, wherein the portion of the sample collector comprising the cap is one of the handle of the sample collector and a flange of the sample collector.

81. The assay assembly of claim 79 or 80, wherein responsive to the cap being operatively coupled to the sample collection tube, the cap seals the sample collection tube.

82. The assay assembly of any one of claims 79-81, wherein the sample collector is flexible such that the sample collector can bend within the flared volume of the first chamber.

83. The assay assembly of any one of claims 1-72, further comprising a housing having a flared volume, and wherein the housing comprises a space sized to receive the sample collection tube.

84. The assay assembly of claim 83, wherein the housing further comprises one or more spaces sized to receive one or more power sources.

85. The assay assembly of any one of claims 50-84, wherein:
a. the sample collection tube further comprises:
an outlet port, the outlet port sealed from the first chamber by the breakable seal,
b. the test cartridge further comprises a fluid transfer mechanism comprising:
an interface, wherein the outlet port of the sample collection tube is configured to receive the interface of the fluid transfer mechanism; and
a channel formed in the interface, the channel comprising a first end and a second end, the channel having a length and at least one diameter, the first end comprising an inlet, and the second end comprising an outlet in fluidic communication with the second chamber of the test cartridge,
c. the puncturing element comprises a hollow cylinder having an inner diameter, an outer diameter, and a length,
d. a first segment of the puncturing element includes a first portion of the length of the hollow cylinder,
e. a second segment of the puncturing element includes a second portion of the length of the hollow cylinder,
f. the outer diameter of the hollow cylinder is equivalent to the at least one diameter of the channel in the interface,
g. the first segment of the puncturing element is embedded within at least a portion of the length of the channel, thereby forming a single effective diameter of the channel along the length of the channel, the single effective diameter equivalent to the inner diameter of the hollow cylinder of the puncturing element,
h. the second segment of the puncturing element extends beyond the inlet of the channel, and
i. operatively coupling the sample collection tube and the test cartridge in the second stable state comprises the outlet port receiving the interface of the fluid transfer mechanism such that at least one portion of the interface has a diameter that is equivalent to a diameter of at least one portion of the outlet port and such that the at least one portion of the interface is located within the at least one portion of the outlet port, thereby fluidically sealing the outlet port with the interface and breaking the breakable seal of the sample collection tube with the second segment of the puncturing element, thereby placing the first chamber of the sample collection tube in fluidic communication with the channel of the fluid transfer mechanism and thus with the second chamber of the test cartridge.

86. The assembly of claim 85, wherein the at least one portion of the interface of the fluid transfer mechanism having the diameter that is equivalent to the diameter of the outlet port comprises more than one portion.

87. The assembly of claims 85 or 86, wherein:
a. the diameter of the interface of the fluid transfer mechanism increases along the length of the channel from the first end to the second end, and
b. the at least one portion of the interface of the fluid transfer mechanism that has the diameter that is equivalent to the diameter of the outlet port comprises a portion of the interface of the fluid transfer mechanism that is proximal to the second end of the channel.

88. The assembly of any one of claims 85-87, wherein at least one of the interface of the fluid transfer mechanism and the outlet port comprises a deformable material.

89. The assembly of any one of claims 85-88, wherein the at least one portion of the interface having the diameter that is equivalent to the diameter of the outlet port is positioned such that the interface fluidically seals the outlet port prior to the puncturing element breaking the breakable seal of the sample collection tube.

90. The assembly of any one of claims 85-89, wherein:
a. the least one diameter of the channel formed in the interface comprises more than one diameter,
b. the portion of the length of the channel in which the first segment of the puncturing element is embedded has a first diameter that is equivalent to the outer diameter of the hollow cylinder comprising the puncturing element, and
c. additional portions of the length of the channel have a second diameter that is equivalent to the inner diameter of the hollow cylinder comprising the puncturing element, thereby forming the single effective diameter of the channel along the length of the channel, the single effective diameter equivalent to the inner diameter to the hollow cylinder of the puncturing element.

91. The assembly of any one of claims 85-90, wherein the interface comprises a hydrophobic material.

92. The assembly of any one of claims 85-91, wherein the puncturing element comprises a hydrophilic material.

93. The assembly of any one of claims 85-92, wherein the outlet port comprises a hydrophobic material.

94. The assembly of any one of claims 85-93, wherein the breakable seal comprises a hydrophilic material.

95. The assembly of any one of claims 85-94, wherein the interface comprises a plastic material.

96. The assembly of any one of claims 85-95, wherein the puncturing element comprises a metallic material.

97. The assembly of any one of claims 85-96, wherein the outlet port comprises a plastic material.

98. The assembly of any one of claims 85-97, wherein the breakable seal comprises a metallic material.

99. The assembly of any one of claims 85-98, wherein the puncturing element comprises a material having a hardness that is at least 2× times a hardness of a material comprising the breakable seal, such that the puncturing element provides for a clear puncture of the breakable seal with repeatable geometry and without deformation of the puncturing element.

100. The assembly of any one of claim 85-99, wherein an end of the second portion of the puncturing element that is configured to contact the breakable seal comprises a blunt tip, such that a surface area of the end of the second portion is orthogonal to the length of the puncturing element.

101. The assembly of any one of claim 85-99, wherein an end of the second portion of the puncturing element that is configured to contact the breakable seal comprises a sharp tip.

102. The assembly of any one of claims 85-100, wherein the inner diameter of the hollow cylinder of the puncturing element is less than a radius of a meniscus of fluid entering the hollow cylinder.

103. The assembly of any one of claims 85-102, wherein the puncturing element is interference-fit within the at least a portion of the length of the channel formed in the interface.

104. The assembly of any one of claims 85-103, wherein a surface area of an end of the second portion of the puncturing element that is configured to contact the breakable seal is less than 25% of the surface area of the breakable seal, thereby limiting a size and/or number of gas bubbles formed during deformation of the breakable seal and/or that can be introduced through the broken seal.

105. The assay assembly of any one of claims 1-66 and 72-104, wherein the sample collection tube is operatively coupled or has been operatively coupled to the test cartridge in the first stable state at the first point in time.

106. The assay assembly of any one of claims 1-52, 68-71, 72-76, 78, and 83-105, further comprising a sample collector comprising a handle and a sample collection portion, the sample collection tube configured to receive the sample collection portion of the sample collector.

107. The assay assembly of claim 106, wherein the sample collection portion of the sample collector is breakable such that the sample collection portion is configured to dislocate from the sample collector.

108. The assay assembly of any one of claims 1-107, wherein the handle of the sample collector is 1″ to 5″ between the cap and the sample collection portion.

109. The assay assembly of any one of claims 1-108, wherein the cap comprises a grip handle for a user to handle the sample collector.

110. The assay assembly of claim 109, wherein the grip handle comprises knurlings and/or one or more finger-grip indentations.

111. The assay assembly of any one of claims 6-108, wherein the first and second sub-containers are concentric.

112. The assay assembly of any one of claims 1-111, wherein the outer surface of the sample collection tube and/or the test cartridge comprises alignment features to prevent rotation of the sample collection tube and/or test cartridge.

113. The assay assembly of claim 112, wherein the alignment features are linear alignment features.

114. The assay assembly of any one of claims 1-107, wherein the bi-stable locking mechanism is irreversible such that the bi-stable locking mechanism cannot transition from the at least one second state in which (i) the sample collection tube, the first chamber or the first sub-container and (ii) the test cartridge are operatively coupled in the second stable state to the at least one first state in which the sample collection tube and the test cartridge are operatively coupled in the first stable state.

115. The assay assembly of claim 114, wherein the sample collection tube, the first chamber, the first sub-container and/or the test cartridge comprises one more of the following to prevent transition from the at least one second state to the at least one first state: locking detents, cantilever snap features, lock-out release arm, ratchet features, sawtooth ratchets, ratchet and pawl features.

116. The assay assembly of any one of claims 1-115, wherein:
a. an exterior surface of the sample collection tube comprises alignment features,
b. the sample collection tube holder comprises a shelf having gaps configured to align with and sized to fit the alignment features of the sample collection tube, and
c. responsive to the sample collection tube holder operatively coupling the sample collection tube and the test cartridge in the first stable state, responsive to the alignment features of the sample collection tube aligning with the gaps in the shelf of the collection tube holder, and responsive to the bi-stable locking mechanism transitioning to the at least one second state, the sample collection tube holder operatively couples the sample collection tube and the test cartridge in the second stable state.

117. The assay assembly of claim 116, wherein:
a. the exterior surface of the sample collection tube comprises notches, and
b. the sample collection tube holder comprises hooks positioned below the shelf and configured to interlock with the notches of the sample collection tube responsive to the alignment features of the sample collection tube aligning with the gaps in the shelf of the collection tube holder and responsive to the sample collection tube holder operatively coupling the sample collection tube and the test cartridge in the second stable state, such that the sample collection tube is prevented from transitioning from operative coupling with the test cartridge in the second stable state to operative coupling with the test cartridge in the first stable state.

118. The assay assembly of claim 116 or 117, wherein:
a. the shelf of the sample collection tube holder comprises one or more cantilever snap features,
b. responsive to the bi-stable locking mechanism being in the at least one first state, the one or more cantilever snap features are positioned in a first position, thereby causing the sample collection tube holder to operatively couple the sample collection tube and the test cartridge in the first stable state, and
c. responsive to the bi-stable locking mechanism being in the at least one second state, the one or more cantilever snap features are positioned in a second position, the second position proximal to the test cartridge relative to the first position, thereby causing the sample collection tube holder to operatively couple the sample collection tube and the test cartridge in the second stable state.

119. The assay assembly of claim 116 or 117, wherein:
a. the sample collection tube holder comprises one or more cantilever snap features,
b. responsive to the bi-stable locking mechanism being in the at least one first state, the one or more cantilever snap features are positioned above the shelf of the sample collection tube, thereby causing the sample collection tube holder to operatively couple the sample collection tube and the test cartridge in the first stable state, and
c. responsive to the bi-stable locking mechanism being in the at least one second state, the one or more cantilever snap features are positioned below the shelf of the sample collection tube, thereby causing the sample collection tube holder to operatively couple the sample collection tube and the test cartridge in the second stable state.

120. The assay assembly of any one of claims 1-119, wherein the cap comprises a pressurizing component.

121. The assay assembly of claim 120, wherein the pressurizing component is a rubber sealing element on the surface of the cap proximal to the first chamber.

122. The assay assembly of claim 120 or 121, wherein in the at least one second state, the pressurizing component pressurizes contents of the first chamber.

123. The assay assembly of claim 120 or 121, wherein in the at least one second state, the pressurizing component pressurizes contents of the first sub-container.

124. The assay assembly of any one of claims 120-123, wherein in the at least one second state the pressurizing component, displaces air in the first chamber or in the first sub-container.

125. The assay assembly of claim 124, wherein the volume of air displaced by the pressurizing component when the cap operatively couples with the sample collection tube in the at least one second state is 0.05 mL to 5 mL.

126. The assay assembly of claim 124, wherein the volume of air displaced by the pressurizing component when the cap operatively couples with the sample collection tube in the at least one second state is the total volume of air in the one or more reaction chambers in the test cartridge.

127. The assay assembly of any one of claims 1-119, wherein the first chamber of the sample collection tube comprises at least a liquid reagent.

128. The assay assembly of any one of claims 1-127, wherein the assay assembly weighs less than one pound.

129. The assay assembly of any one of claims 1-128, wherein the assay assembly is a hand-held device.

130. The assay assembly of any one of claims 1-128, wherein all linear dimensions of the assay assembly are less than 5 inches in length.

131. The assay assembly of any one of claims 1-129, wherein the one or more reaction chambers are each microfluidic reaction chambers.

132. The assay assembly of any one of claims 1-131, wherein the assay assembly comprises lyophilized reagents and has a shelf life of at least 12 months at room temperature.

133. The assay assembly of any one of claims 1-132, wherein the assay assembly comprises batteries and is battery-powered.

134. The assay assembly of any one of claims 1-132, wherein the power supply comprises batteries and is battery-powered.

135. An assay assembly, the assembly comprising:
a. a sample collection tube comprising:
a first chamber; and
a breakable seal or valve;
b. a test cartridge comprising:
a sample inlet;
one or more reaction chambers; and
a puncturing element,
wherein the sample collection tube is operatively coupleable with the test cartridge; and
c. a sample collector comprising:
a handle comprising a cap that is operatively coupleable with the sample collection tube; and
a sample collection portion,
wherein responsive to the cap not being operatively coupled to the sample collection tube, the sample collection tube and the test cartridge are operatively coupled in a first stable state such that the puncturing element of the test cartridge does not break the breakable seal of the sample collection tube or such that the valve is not actuated, and wherein responsive to the cap being operatively coupled to the sample collection tube, the sample collection portion of the sample collector is located within the first chamber of the sample collection tube and the sample collection tube and the test cartridge are operatively coupled in a second stable state such that the puncturing element of the test cartridge breaks the breakable seal of the sample collection tube or the valve is actuated, thereby placing the first chamber of the sample collection tube in fluidic communication with the sample inlet of the test cartridge.

136. The assay assembly of claim 135, wherein the cap includes a first attachment element and the sample collection tube includes a second attachment element that is operatively coupleable with the first attachment element.

137. The assay assembly of claim 136, wherein the cap comprises a twist-on cap and wherein the first attachment element comprises threading and the second attachment element comprises reciprocating threading configured to slidably receive the threading.

138. The assay assembly of claim 137, wherein the reciprocating threading of the sample collection tube is configured to slidably receive ½-10 complete rotations of the threading of the twist-on cap.

139. The assay assembly of any one of claims 137-138, wherein the sample collection portion of the sample collector is offset from an axis of rotation of the twist-on cap, such that, during rotation of the twist-on cap about the axis of rotation, the sample collection portion rotates off the axis of rotation of the sample handle and maximizes volume contact.

140. The assay assembly of any one of claims 135-139, wherein responsive to the cap being operatively coupled to the sample collection tube, the cap seals the sample collection tube.

141. The assay assembly of any one of claims 135-140, wherein the breakable seal is proximal to an outlet of the sample collection tube and wherein responsive to the cap being operatively coupled to the sample collection tube, the sample collection portion of the sample collector is located within the first chamber of the sample collection tube proximal to the breakable seal such that, responsive to the puncturing element of the test cartridge breaking the breakable seal of the sample collection tube, the sample collection portion is proximal to the outlet of the sample collection tube, thereby maximizing sample content from the sample collection portion proximal to the outlet of the sample collection tube.

142. The assay assembly of any one of claims 135-141, wherein the first chamber of the sample collection tube comprises a first sub-container and a second sub-container, the first sub-container and the second sub-container sealed from one another by a second breakable seal, and wherein responsive to the cap being operatively coupled to the sample collection tube and the sample collection portion of the sample collector being located within the first chamber of the sample collection tube, the sample collection portion of the sample collector breaks the second breakable seal of the sample collection tube, thereby placing the first sub-container of the sample collection tube in fluidic communication with the second sub-container of the sample collection tube.

143. The assay assembly of any one of claims 135-142, wherein the first chamber of the sample collection tube contains agitator features.

144. The assay assembly of any one of claims 135-143, wherein the sample collection tube is operative coupled or has been operatively coupled to the test cartridge.

145. The assay assembly of any one of claims 135-144, wherein the operative coupling of the cap to the sample collection tube is irreversible such that the cap cannot transition from being operatively coupled to the sample collection tube to not being operatively coupled to the sample collection tube.

146. The assay assembly of claim 145, wherein the cap comprises one more of the following to prevent transition from the at least one second state to the at least one first state: locking detents, cantilever snap features, a lock-out release arm, ratchet features, sawtooth ratchets, ratchet and pawl features.

147. The assay assembly of any one of claims 135-145, wherein:
a. the test cartridge further comprises a sample collection tube holder,
b. the sample collection tube holder is configured to operatively couple the sample collection tube and the test cartridge in the first stable state and in the second stable state, and
c. the sample collection tube holder is operatively coupled with the cap of the sample collector such that responsive to the cap not being operatively coupled to the sample collection tube, the sample collection tube holder operatively couples the sample collection tube and the test cartridge in the first stable state, and responsive to the cap being operatively coupled to the sample collection tube, the sample collection tube holder operatively couples the sample collection tube and the test cartridge in the second stable state.

148. The assay assembly of claim 147, wherein:
a. an exterior surface of the sample collection tube comprises alignment features,
b. the sample collection tube holder comprises a shelf having gaps configured to align with and sized to fit the alignment features of the sample collection tube, and
c. responsive to the sample collection tube holder operatively coupling the sample collection tube and the test cartridge in the first stable state, responsive to the alignment features of the sample collection tube aligning with the gaps in the shelf of the collection tube holder, and responsive to the cap operatively coupling with the sample collection tube, the sample collection tube holder operatively couples the sample collection tube and the test cartridge in the second stable state.

149. The assay assembly of claim 148, wherein:
a. the exterior surface of the sample collection tube comprises notches, and
b. the sample collection tube holder comprises hooks positioned below the shelf and configured to interlock with the notches of the sample collection tube responsive to the alignment features of the sample collection tube aligning with the gaps in the shelf of the collection tube holder and responsive to the sample collection tube holder operatively coupling the sample collection tube and the test cartridge in the second stable state, such that the sample collection tube is prevented from transitioning from operative coupling with the test cartridge in the second stable state to operative coupling with the test cartridge in the first stable state.

150. The assay assembly of claim 148 or 149 wherein:
a. the shelf of the sample collection tube holder comprises one or more cantilever snap features,
b. responsive to the cap not being operatively coupled to the sample collection tube, the one or more cantilever snap features are positioned in a first position, thereby causing the sample collection tube holder to operatively couple the sample collection tube and the test cartridge in the first stable state, and
c. responsive to the cap being operatively coupled to the sample collection tube, the one or more cantilever snap features are positioned in a second position, the second position proximal to the test cartridge relative to the first position, thereby causing the sample collection tube holder to operatively couple the sample collection tube and the test cartridge in the second stable state.

151. The assay assembly of claim 148 or 149 wherein:
a. the sample collection tube holder comprises one or more cantilever snap features,
b. responsive to the cap not being operatively coupled to the sample collection tube, the one or more cantilever snap features are positioned above the shelf of the sample collection tube, thereby causing the sample collection tube holder to operatively couple the sample collection tube and the test cartridge in the first stable state, and
c. responsive to the cap being operatively coupled to the sample collection tube, the one or more cantilever snap features are positioned below the shelf of the sample collection tube, thereby causing the sample collection tube holder to operatively couple the sample collection tube and the test cartridge in the second stable state.

152. The assay assembly of any one of claims 135-151, wherein:
a. the sample collection tube further comprises:
an outlet port, the outlet port sealed from the first chamber by the breakable seal,
b. the test cartridge further comprises a fluid transfer mechanism comprising:
an interface, wherein the outlet port of the sample collection tube is configured to receive the interface of the fluid transfer mechanism; and
a channel formed in the interface, the channel comprising a first end and a second end, the channel having a length and at least one diameter, the first end comprising an inlet, and the second end comprising an outlet in fluidic communication with the second chamber of the test cartridge,
c. the puncturing element comprises a hollow cylinder having an inner diameter, an outer diameter, and a length,
d. a first segment of the puncturing element includes a first portion of the length of the hollow cylinder,
e. a second segment of the puncturing element includes a second portion of the length of the hollow cylinder,
f. the outer diameter of the hollow cylinder is equivalent to the at least one diameter of the channel in the interface,
g. the first segment of the puncturing element is embedded within at least a portion of the length of the channel, thereby forming a single effective diameter of the channel along the length of the channel, the single effective diameter equivalent to the inner diameter of the hollow cylinder of the puncturing element,
h. the second segment of the puncturing element extends beyond the inlet of the channel, and
i. operatively coupling the sample collection tube and the test cartridge in the second stable state comprises the outlet port receiving the interface of the fluid transfer mechanism such that at least one portion of the interface has a diameter that is equivalent to a diameter of at least one portion of the outlet port and such that the at least one portion of the interface is located within the at least one portion of the outlet port, thereby fluidically sealing the outlet port with the interface and breaking the breakable seal of the sample collection tube with the second segment of the puncturing element, thereby placing the first chamber of the sample collection tube in fluidic communication with the channel of the fluid transfer mechanism and thus with the second chamber of the test cartridge.

153. The assembly of claim 152, wherein the at least one portion of the interface of the fluid transfer mechanism having the diameter that is equivalent to the diameter of the outlet port comprises more than one portion.

154. The assembly of any one of claims 152-153, wherein:
a. the diameter of the interface of the fluid transfer mechanism increases along the length of the channel from the first end to the second end, and
b. the at least one portion of the interface of the fluid transfer mechanism that has the diameter that is equivalent to the diameter of the outlet port comprises a portion of the interface of the fluid transfer mechanism that is proximal to the second end of the channel.

155. The assembly of any one of claims 152-154, wherein at least one of the interface of the fluid transfer mechanism and the outlet port comprises a deformable material.

156. The assembly of any one of claims 152-155, wherein the at least one portion of the interface having the diameter that is equivalent to the diameter of the outlet port is positioned such that the interface fluidically seals the outlet port prior to the puncturing element breaking the breakable seal of the sample collection tube.

157. The assembly of any one of claims 152-156, wherein:
a. the least one diameter of the channel formed in the interface comprises more than one diameter,
b. the portion of the length of the channel in which the first segment of the puncturing element is embedded has a first diameter that is equivalent to the outer diameter of the hollow cylinder comprising the puncturing element, and
c. additional portions of the length of the channel have a second diameter that is equivalent to the inner diameter of the hollow cylinder comprising the puncturing element, thereby forming the single effective diameter of the channel along the length of the channel, the single effective diameter equivalent to the inner diameter to the hollow cylinder of the puncturing element.

158. The assembly of any one of claims 152-157, wherein the interface comprises a hydrophobic material.

159. The assembly of any one of claims 152-158, wherein the puncturing element comprises a hydrophilic material.

160. The assembly of any one of claims 152-159, wherein the outlet port comprises a hydrophobic material.

161. The assembly of any one of claims 152-160, wherein the breakable seal comprises a hydrophilic material.

162. The assembly of any one of claims 152-161, wherein the interface comprises a plastic material.

163. The assembly of any one of claims 152-162, wherein the puncturing element comprises a metallic material.

164. The assembly of any one of claims 152-163, wherein the outlet port comprises a plastic material.

165. The assembly of any one of claims 152-164, wherein the breakable seal comprises a metallic material.

166. The assembly of any one of claims 152-165, wherein the puncturing element comprises a material having a hardness that is at least 2× times a hardness of a material comprising the breakable seal, such that the puncturing element provides for a clear puncture of the breakable seal with repeatable geometry and without deformation of the puncturing element.

167. The assembly of any one of claim 152-166, wherein an end of the second portion of the puncturing element that is configured to contact the breakable seal comprises a blunt tip, such that a surface area of the end of the second portion is orthogonal to the length of the puncturing element.

168. The assembly of any one of claims 152-167, wherein the inner diameter of the hollow cylinder of the puncturing element is less than a radius of a meniscus of fluid entering the hollow cylinder.

169. The assembly of any one of claims 152-168, wherein the puncturing element is interference-fit within the at least a portion of the length of the channel formed in the interface.

170. The assembly of any one of claims 152-169, wherein a surface area of an end of the second portion of the puncturing element that is configured to contact the breakable seal is less than 25% of the surface area of the breakable seal, thereby limiting a size and/or number of gas bubbles formed during deformation of the breakable seal and/or that can be introduced through the broken seal.

171. The assay assembly of any one of claims 135-170, wherein the first chamber of the sample collection tube comprises at least a liquid reagent.

172. The assay assembly of any one of claims 135-171, wherein the assay assembly weighs less than one pound.

173. The assay assembly of any one of claims 135-172, wherein all linear dimensions of the assay assembly are less than 5 inches in length.

174. The assay assembly of any one of claims 135-173, wherein the assay assembly comprises lyophilized reagents and has a shelf life of at least 12 months at room temperature.

175. The assay assembly of any one of claims 135-174, wherein the assay assembly comprises batteries and is battery-powered.

176. The assay assembly of any one of the preceding claims, wherein the test cartridge further comprises a conduit fluidically connecting the sample inlet to one of the one or more reaction chambers.

177. The assay assembly of claim 176, wherein the test cartridge comprises a plurality of conduits and each of the conduits fluidically connects the sample inlet to one of the one or more reaction chambers.

178. The assay assembly of any one of the preceding claims, wherein each of the one or more reaction chambers comprises a selective venting element that allows one or more gases to pass therethrough.

179. The assay assembly of claim 178, wherein the selective venting elements is configured to proceed, upon contact with a liquid, from a first conformation, in which one or more gases can pass therethrough, to a second conformation that reduces the permeability of fluid therethrough or renders the selective venting element impermeable to fluid, wherein the first conformation allows flow from the sample collection tube to the sample inlet and into the one or more reaction chambers.

180. The assay assembly of claim 178 or 179, wherein the sample collection tube comprises a sealed cavity that is proximal to the test cartridge and into which the one or more gases vent.

181. The assay assembly of claim 180, wherein responsive to the cap operatively coupling to the sample collection tube in the at least one second state, one or more gases vent out of the one or more reaction chambers into the sealed cavity.

182. The assay assembly of claim 178 or 179, wherein the assay assembly comprises the first and second sub-containers, and wherein responsive to the cap operatively coupling to the sample collection tube in the at least one second state, one or more gases vent out of the one or more reaction chambers into the second sub-container.

183. The assay assembly of claim 182, wherein the cap comprises a pressurizing component,
wherein the assay assembly comprises the first and second sub-containers,
wherein as the cap operatively couples to the sample collection tube, a portion of the pressurizing component extends into the first sub-container, thereby sealing the first sub-container and leaving the second sub-container exposed to the atmosphere, such that one or more gases vent out of the one or more reaction chambers into the atmosphere via the second sub-container.

184. The assay assembly of any one of the preceding claims, wherein the one or more reaction chambers comprise an optical property modifying reagent or a nucleic acid amplification reagent.

185. The assay assembly of any one of the preceding claims, wherein the cap comprises (i) a reagent and (ii) a second breakable seal or second actuable valve.

186. The assay assembly of claim 185, wherein operative coupling of the cap with the sample collection tube breaks the second breakable seal or actuates the second actuable valve, thereby flowing the reagent from the cap into the sample collection tube.

187. An assembly comprising:
a. a sample collection tube comprising:
a main chamber;
an outlet port; and
a breakable seal, the breakable seal sealing the main chamber from the outlet port; and
b. a fluid transfer mechanism that is operatively couplable with the sample collection tube, the fluid transfer mechanism comprising:
an interface, wherein the outlet port of the sample collection tube is configured to receive the interface of the fluid transfer mechanism;
a channel formed in the interface, the channel comprising a first end and a second end, and having a length and at least one diameter, the first end comprising an inlet; and
a puncturing element comprising a hollow cylinder having an inner diameter, an outer diameter, and a length, and
wherein a first segment of the puncturing element includes a first portion of the length of the hollow cylinder, a second segment of the puncturing element includes a second portion of the length of the hollow cylinder, and the outer diameter of the hollow cylinder is equivalent to the at least one diameter of the channel in the interface,
wherein the first segment of the puncturing element is embedded within at least a portion of the length of the channel, thereby forming a single effective diameter of the channel along the length of the channel, the single effective diameter equivalent to the inner diameter of the hollow cylinder of the puncturing element,
wherein the second segment of the puncturing element extends beyond the inlet of the channel, and
wherein operatively coupling the sample collection tube and the fluid transfer mechanism comprises the outlet port receiving the interface of the fluid transfer mechanism such that at least one portion of the interface has a diameter that is equivalent to a diameter of at least one portion of the outlet port and such that the at least one portion of the interface is located within the at least one portion of the outlet port, thereby fluidically sealing the outlet port with the interface and puncturing the breakable seal of the sample collection tube with the second segment of the puncturing element of the fluid transfer mechanism, thereby placing the main chamber of the sample collection tube in fluidic communication with the channel of the fluid transfer mechanism.

188. The assembly of claim 187, wherein the sample collection tube is operatively coupled or has been operatively coupled to the fluid transfer mechanism.

189. The assembly of any one of claims 187-188, wherein the at least one portion of the interface of the fluid transfer mechanism having the diameter that is equivalent to the diameter of the outlet port comprises more than one portion.

190. The assembly of any one of claims 187-189, wherein:
a. the diameter of the interface of the fluid transfer mechanism increases along the length of the channel from the first end to the second end, and
b. the at least one portion of the interface of the fluid transfer mechanism that has the diameter that is equivalent to the diameter of the outlet port comprises a portion of the interface of the fluid transfer mechanism that is proximal to the second end of the channel.

191. The assembly of any one of claims 187-190, wherein at least one of the interface of the fluid transfer mechanism and the outlet port comprises a deformable material.

192. The assembly of any one of claims 187-191, wherein the at least one portion of the interface having the diameter that is equivalent to the diameter of the outlet port is positioned such that the interface fluidically seals the outlet port prior to the puncturing element breaking the breakable seal of the sample collection tube.

193. The assembly of any one of claims 187-192, wherein:
a. the least one diameter of the channel formed in the interface comprises more than one diameter,
b. the portion of the length of the channel in which the first segment of the puncturing element is embedded has a first diameter that is equivalent to the outer diameter of the hollow cylinder comprising the puncturing element, and
c. additional portions of the length of the channel have a second diameter that is equivalent to the inner diameter of the hollow cylinder comprising the puncturing element, thereby forming the single effective diameter of the channel along the length of the channel, the single effective diameter equivalent to the inner diameter to the hollow cylinder of the puncturing element.

194. The assembly of any one of claims 187-193, wherein the interface comprises a hydrophobic material.

195. The assembly of any one of claims 187-194, wherein the puncturing element comprises a hydrophilic material.

196. The assembly of any one of claims 187-195, wherein the outlet port comprises a hydrophobic material.

197. The assembly of any one of claims 187-196, wherein the breakable seal comprises a hydrophilic material.

198. The assembly of any one of claims 187-197, wherein the interface comprises a plastic material.

199. The assembly of any one of claims 187-198, wherein the puncturing element comprises a metallic material.

200. The assembly of any one of claims 187-199, wherein the outlet port comprises a plastic material.

201. The assembly of any one of claims 187-200, wherein the breakable seal comprises a metallic material.

202. The assembly of any one of claims 187-201, wherein the puncturing element comprises a material having a hardness that is at least 2× times a hardness of a material comprising the breakable seal, such that the puncturing element provides for a clear puncture of the breakable seal with repeatable geometry and without deformation of the puncturing element.

203. The assembly of any one of claim 187-202, wherein an end of the second portion of the puncturing element that is configured to contact the breakable seal comprises a blunt tip, such that a surface area of the end of the second portion is orthogonal to the length of the puncturing element.

204. The assembly of any one of claims 187-203, wherein the inner diameter of the hollow cylinder of the puncturing element is less than a radius of a meniscus of fluid entering the hollow cylinder.

205. The assembly of any one of claims 187-204, wherein the puncturing element is interference-fit within the at least a portion of the length of the channel formed in the interface.

206. The assembly of any one of claims 187-205, wherein a surface area of an end of the second portion of the puncturing element that is configured to contact the breakable seal is less than 25% of the surface area of the breakable seal, thereby limiting a size and/or number of gas bubbles formed during deformation of the breakable seal and/or that can be introduced through the broken seal.

207. The assay assembly of any one of claims 187-206, wherein the sample collection tube contains at least a liquid reagent.

208. A method comprising:
a. obtaining the assay assembly of any one of claims 2-48, 54-67, 69-71, 75-84, 108-134, and 176-186,
b. operatively coupling the base unit and the sample collection tube;
c. collecting a sample on the sample collection portion;
d. inserting the sample collection portion into the first chamber or first sub-container thereby generating a sample preparation solution;
e. operatively coupling the cap and the sample collection tube and transitioning the bi-stable locking mechanism from the first state to the second state, thereby fluidically connecting the first chamber or first sub-container with the test cartridge and transmitting at least a portion of the sample preparation solution out of the sample receiving module and into one or more reaction chambers of the test cartridge, wherein the chambers comprise an optical property modifying reagent and an amplification composition, and thereby generating a nucleic acid reaction mixture;
f. heating the reaction mixture with the heating element, wherein the heating accelerates a nucleic acid amplification reaction comprising the nucleic acid and the amplification composition, the reaction generating an amplified nucleic acid and a plurality of protons, wherein the reacting sufficiently modifies the nucleic acid reaction mixture to allow detection of the modified optical property; and
g. determining one or more characteristics of the sample based on the modified optical property.

209. The method of claim 208, the base unit comprises the electronic display and the one or more characteristics of the sample are displayed on the electronic display.

210. The method of claim 204 or 209, wherein the base unit comprises the audio device and after detection of the modified optical property, the audio device emits an alert sound.

211. The method of any one of claim 208-210, wherein determining one or more characteristics of the sample comprises obtaining the result as displayed on the electronic display with a sample analyzer.

212. The method of claim 211, wherein the sample analyzer is a mobile device.

213. The method of any one of claims 209-212, further comprising:
h. Reversing the coupling of the base unit and the sample collection tube, thereby separating the base unit and sample collection tube.

214. The method of claim 213, comprising disposing of the sample collection tube.

215. A method comprising:
a. obtaining an assay assembly, the assembly comprising:
a sample collection tube comprising a first chamber;
a test cartridge comprising:
1. a sample inlet,
2. one or more reaction chambers, and
3. a sample collection tube holder configured to operatively couple the sample collection tube and the test cartridge in a first stable state and a second stable state;
a fluidic coupling mechanism; and
a bi-stable locking mechanism, wherein the bi-stable locking mechanism is in at least one first state, thereby causing the sample collection tube holder to operatively couple the sample collection tube and the test cartridge in the first stable state; and
b. transitioning the bi-stable locking mechanism from the at least one first state to at least one second state, thereby causing the sample collection tube holder to operatively couple the sample collection tube and the test cartridge in the second stable state, and thereby causing the fluidic coupling mechanism to place the first chamber of the sample collection tube in fluidic communication with the sample inlet of the test cartridge.

216. The method of claim 215, wherein:
a. the assay assembly further comprises a snap-on cap that is operatively coupleable with the sample collection tube,
b. the fluidic coupling mechanism comprises a breakable seal of the sample collection tube and a puncturing element of the test cartridge,
c. the at least one first state of the bi-stable locking mechanism comprises the snap-on cap not being operatively coupled to the sample collection tube,
d. transitioning the bi-stable locking mechanism from the at least one first state to at least one second state comprises operatively coupling the snap-on cap to the sample collection tube,
e. causing the sample collection tube holder to operatively couple the sample collection tube and the test cartridge in the second stable state thereby causing the puncturing element of the test cartridge to break the breakable seal of the sample collection tube, and
f. causing the fluidic coupling mechanism to place the first chamber of the sample collection tube in fluidic communication with the sample inlet of the test cartridge.

217. The method of claim 215, wherein:
a. the assay assembly further comprises a twist feature of the test cartridge,
b. the fluidic coupling mechanism comprises a breakable seal of the sample collection tube and a puncturing element of the test cartridge,
c. the at least one first state of the bi-stable locking mechanism comprises the twist feature not being twisted,
d. transitioning the bi-stable locking mechanism from the at least one first state to at least one second state comprising twisting the twist feature,
e. causing the sample collection tube holder to operatively couple the sample collection tube and the test cartridge in the second stable state thereby causing the puncturing element of the test cartridge to break the breakable seal of the sample collection tube, and
f. causing the fluidic coupling mechanism to place the first chamber of the sample collection tube in fluidic communication with the sample inlet of the test cartridge.

218. The method claim 215, wherein:
a. the assay assembly further comprises a twist-on cap that is operatively coupleable with the sample collection tube,
b. the fluidic coupling mechanism comprises a breakable seal of the sample collection tube and a puncturing element of the test cartridge,
c. the at least one first state of the twist-on cap comprises the twist-on cap not being operatively coupled to the sample collection tube,
d. transitioning the bi-stable locking mechanism from the at least one first state to at least one second state comprises operatively coupling the twist-on cap to the sample collection tube,
e. causing the sample collection tube holder to operatively couple the sample collection tube and the test cartridge in the second stable state thereby causing the puncturing element of the test cartridge to break the breakable seal of the sample collection tube, and
f. causing the fluidic coupling mechanism to place the first chamber of the sample collection tube in fluidic communication with the sample inlet of the test cartridge.

219. The method of claim 218, wherein:
the twist-on cap comprises a handle of a sample collector,
the sample collector comprises the handle and a sample collection portion, and
operatively coupling the twist-on cap to the sample collection tube comprises locating the sample collection portion of the sample collector within the first chamber of the sample collection tube.

220. The method of claim 219, further comprising collecting a sample with the sample collection portion of the sample collector prior to operatively coupling the twist-on cap to the sample collection tube.

221. The method of any one of claims 218-220, wherein the twist-on cap comprises a first attachment element and the sample collection tube comprises a second attachment element, and wherein operatively coupling the twist-on cap to the sample collection tube comprises operatively coupling the first attachment element and the second attachment element.

222. The method of claim 221, wherein the first attachment element comprises threading and the second attachment element comprises reciprocating threading, and wherein operatively coupling the first attachment element and the second attachment element comprises the reciprocating threading of the second attachment element slidably receiving the threading of the first attachment element.

223. The method of claim 222, wherein the reciprocating threading of the second attachment element slidably receives ½ to 10 complete rotations of the threading of the first attachment element.

224. The method of any one of claims 218-223, wherein operatively coupling the twist-on cap to the sample collection tube comprises sealing the sample collection tube with the twist-on cap.

225. The method of any one of claims 219-224, wherein the breakable seal is proximal to an outlet of the sample collection tube, and wherein locating the sample collection portion of the sample collector within the first chamber of the sample collection tube comprises locating the sample collection portion proximal to the breakable seal, and thus proximal to the outlet of the sample collection tube, such that responsive to the puncturing element of the test cartridge breaking the breakable seal of the sample collection tube, an amount of sample from the sample collection portion that travels from the first chamber of the sample collection tube into the sample inlet of the test cartridge is maximized.

226. The method of any one of claims 219-225, wherein operatively coupling the twist-on cap to the sample collection tube comprises rotating the twist-on cap around the sample collection tube about an axis of rotation of the twist-on cap, and wherein the sample collection portion of the sample collector is offset from the axis of rotation of the twist-on cap, such that during rotation of the twist-on cap about the axis of rotation, the sample collection portion rotates off the axis of rotation of the twist-on cap, thereby maximizing volume contact of the sample collection portion within the first chamber.

227. The method of any one of claims 219-226, wherein operatively coupling the twist-on cap to the sample collection tube comprises mixing a volume of the first chamber of the sample collection tube with the sample collection portion of the sample collector, and wherein the first chamber of the sample collection tube contains agitator features, such that the volume of the first chamber of the sample collection tube is agitated by the agitator features during mixing with the sample collection portion of the sample collector.

228. The method of claim 215, wherein:
a. the assay assembly further comprises a key feature of the sample collection tube that is operatively coupleable with a threaded feature of the test cartridge,
b. the fluidic coupling mechanism comprises a breakable seal of the sample collection tube and a puncturing element of the test cartridge,
c. the at least one first state comprises the key feature of the sample collection tube not being operatively coupled to the threaded feature of the test cartridge,
d. transitioning the bi-stable locking mechanism from the at least one first state to at least one second state comprising operatively coupling the key feature of the sample collection tube to the threaded feature of the test cartridge,
e. causing the sample collection tube holder to operatively couple the sample collection tube and the test cartridge in the second stable state thereby causes the puncturing element of the test cartridge to break the breakable seal of the sample collection tube, and
f. causing the fluidic coupling mechanism to place the first chamber of the sample collection tube in fluidic communication with the sample inlet of the test cartridge.

229. The method of claim 228, wherein the assay assembly further comprises a cap that is operatively couplable to the sample collection tube, and wherein operatively coupling the key feature of the sample collection tube to the threaded feature of the test cartridge comprises:
a. operatively coupling the cap to the sample collection tube, thereby forming the key feature of the sample collection tube;
b. inverting the sample collection tube; and
c. inserting the inverted sample collection tube into the test cartridge such that the cap of the sample collection tube that forms the key feature of the sample collection tube operatively couples to the threaded feature of the test cartridge.

230. The method of claim 229, wherein the cap of the sample collection tube at least in part comprises the breakable seal, and wherein operatively coupling the key feature of the sample collection tube to the threaded feature of the test cartridge thereby causes the puncturing element of the test cartridge to break the breakable seal in the cap of the sample collection tube.

231. The method of any one of claims 229-230, wherein an end of the sample collection tube opposite the cap operatively coupled to the sample collection tube comprises a knob, and wherein operatively coupling the key feature of the sample collection tube to the threaded feature of the test cartridge further comprises:
a. following inserting the inverted sample collection tube into the test cartridge, twisting the knob of the inserted sample collection tube such that the key feature of the sample collection tube operatively couples to the threaded feature of the test cartridge.

232. The method of claim 215, wherein:
a. the assay assembly further comprises a twist feature of the sample collection tube,
b. the fluidic coupling mechanism comprises a breakable seal of the sample collection tube and a puncturing element of the test cartridge,
c. the at least one first state of the twist feature comprises the twist feature not being twisted,
d. transitioning the twist feature from the at least one first state to at least one second state comprising twisting the twist feature,
e. causing the sample collection tube holder to operatively couple the sample collection tube and the test cartridge in the second stable state thereby causes the puncturing element of the test cartridge to break the breakable seal of the sample collection tube, and
f. causing the fluidic coupling mechanism to place the first chamber of the sample collection tube in fluidic communication with the sample inlet of the test cartridge.

233. The method of claim 232, wherein:
a. the assay assembly further further comprises a cap that is operatively coupleable with the sample collection tube,
b. the at least one first state of the cap comprises the cap not being operatively coupled to the sample collection tube, and
c. transitioning the cap from the at least one first state to the at least one second state comprises operatively coupling the cap to the sample collection tube.

234. The method of claim 233, wherein transitioning the bi-stable locking mechanism from the at least one first state to the at least one second state comprises:
a. transitioning the cap from the at least one first state to the at least one second state by operatively coupling the cap to the sample collection tube; and
b. responsive to the cap being in the at least one second state such that the cap is operatively coupled to the sample collection tube, transitioning the twist feature from the at least one first state to at least one second state by twisting the twist feature.

235. The method of any one of claims 233-234, wherein the cap comprises a lockout release arm configured to prevent the cap from transitioning from the at least one second state in which the cap is operatively coupled to the sample collection tube to the at least one first state in which the cap is not operatively coupled to the sample collection tube.

236. The method of any one of claims 233-235, wherein operatively coupling the cap to the sample collection tube further comprises sealing the sample collection tube with the cap.

237. The method of any one of claims 233-236, wherein the assay assembly further comprises a sample collector comprising at least a breakable sample collection portion, wherein the sample collection tube and the cap each comprise an opening sized to fit the sample collection portion of the sample collector, wherein an interior portion of the cap comprises a blade, and wherein the method further comprises:
a. during transitioning of the cap from the at least one first state in which the cap is not operatively coupled to the sample collection tube to the at least one second state in which the cap is operatively coupled to the sample collection tube, aligning the opening of the sample collection tube and the opening of the cap;
b. inserting the sample collection portion of the sample collector through the aligned openings of the sample collection tube and the cap and into the first chamber of the sample collection tube; and
c. responsive to transitioning the cap to the at least one second state in which the cap is operatively coupled to the sample collection tube, dislocating the sample collection portion from the sample collector and into the first chamber of the sample collection tube using the blade of the cap.

238. The method of claim 232, wherein the assay assembly further comprises a cap that is operatively coupleable with the sample collection tube, wherein the cap comprises a portion of a sample collector, wherein the sample collector comprises at least a handle and a sample collection portion, and wherein the method further comprises:
a. prior to transitioning the twist feature from the at least one first state to the at least one second state by twisting the twist feature, operatively coupling the cap to the sample collection tube, thereby locating the sample collection portion of the sample collector within the first chamber of the sample collection tube.

239. The method of claim 238, wherein operatively coupling the cap to the sample collection tube further comprises sealing the sample collection tube with the cap.

240. The method of any one of claims 238-239, wherein the sample collector is flexible and wherein locating the sample collection portion of the sample collector within the first chamber of the sample collection tube further comprises bending the sample collector within the first chamber of the sample collection tube.

241. The method of any one of claims 216-240, wherein:
a. the sample collection tube further comprises:
an outlet port, the outlet port sealed from the first chamber by the breakable seal,
b. the test cartridge further comprises a fluid transfer mechanism comprising:
an interface, wherein the outlet port of the sample collection tube is configured to receive the interface; and
a channel formed in the interface, the channel comprising a first end and a second end and having a length and at least one diameter, the first end comprising an inlet, and the second end comprising an outlet in fluidic communication with the second chamber of the test cartridge,
c. the puncturing element comprises a hollow cylinder having an inner diameter, an outer diameter, and a length,
d. a first segment of the puncturing element includes a first portion of the length of the hollow cylinder,
e. a second segment of the puncturing element includes a second portion of the length of the hollow cylinder,
f. the outer diameter of the hollow cylinder is equivalent to the at least one diameter of the channel in the interface,
g. the first segment of the puncturing element is embedded within at least a portion of the length of the channel, thereby forming a single effective diameter of the channel along the length of the channel, the single effective diameter equivalent to the inner diameter of the hollow cylinder of the puncturing element, and
h. the second segment of the puncturing element extends beyond the inlet of the channel, and
wherein operatively coupling the sample collection tube and the test cartridge in the second stable state comprises:
a. the outlet port receiving the interface such that at least one portion of the interface has a diameter that is equivalent to a diameter of at least one portion of the outlet port and such that the at least one portion of the interface is located within the at least one portion of the outlet port, thereby fluidically sealing the outlet port with the interface and breaking the breakable seal of the sample collection tube with the second segment of the puncturing element, thereby placing the first chamber of the sample collection tube in fluidic communication with the channel of the fluid transfer mechanism and thus with the second chamber of the test cartridge.

242. The method of claim 241, wherein the interface fluidically seals the outlet port prior to the puncturing element breaking the breakable seal of the sample collection tube, thereby preventing thereby preventing gas bubbles from forming within liquid contained within the first chamber of the sample collection tube and preventing the liquid contained within the first chamber of the sample collection tube from leaking out of the outlet port responsive to the second segment of the puncturing element breaking the breakable seal of the sample collection tube.

243. The method of any one of claims 241-242, wherein gas vents from the outlet port of the sample collection tube prior to the interface fluidically sealing the outlet port, thereby preventing gas bubbles from forming within liquid contained within the first chamber of the sample collection tube, responsive to the second segment of the puncturing element breaking the breakable seal of the sample collection tube.

244. The method of any one of claims 241-243, wherein the single effective diameter of the channel along the length of the channel prevents gas bubbles from forming within liquid traveling through the channel.

245. The method of any one of claims 241-244, wherein the diameter of the interface increases along the length of the channel form the first end to the second end, wherein the at least one portion of the interface of the fluid transfer mechanism that has the diameter that is equivalent to the diameter of the at least one portion of the outlet port comprises a portion of the interface of the fluid transfer mechanism that is proximal to the second end of the channel, and wherein the outlet port receiving the interface comprises:
a. inserting the interface into the outlet port until the portion of the interface that is proximal to the second end of the channel is located within the at least one portion of the outlet port, thereby fluidically sealing the outlet port with the interface.

246. The method of any one of claims 241-245, wherein at least one of the interface and the outlet port comprises a deformable material, and wherein the outlet port receiving the interface comprises:
a. the at least one interface and outlet port deforming such that at least one portion of the interface has a diameter that is equivalent to a diameter of at least one portion of the outlet port and such that the at least one portion of the interface is located within the at least one portion of the outlet port.

247. The method of any one of claims 241-246, wherein the interface comprises a hydrophobic material, the puncturing element comprises a hydrophilic material, and the breakable seal comprises a hydrophilic material, and wherein breaking the breakable seal of the sample collection tube with the second segment of the puncturing element traps gas from the outlet port between the interface and the breakable seal but separate from the puncturing element, thereby preventing gas bubbles from forming within liquid contained within the first chamber of the sample collection tube.

248. The method of any one of claims 241-247, wherein breaking the breakable seal of the sample collection tube with the second segment of the puncturing element forms a narrow gap between the puncturing element and the breakable seal, such that gas trapped between the interface and the breakable seal cannot overcome surface tension of liquid contained within the first chamber of the sample collection tube to travel through the narrow gap, past the breakable seal, and into the liquid contained within the first chamber of the sample collection tube, thereby preventing gas bubbles from forming within liquid contained within the first chamber of the sample collection tube.

249. The method of any one of claims 241-248, wherein the puncturing element comprises a material having a hardness that is at least 2× a hardness of a material comprising the breakable seal, such that the puncturing element provides for a clear puncture of the breakable seal with repeatable geometry and without deformation of the puncturing element.

250. The method of any one of claims 241-249, wherein the inner diameter of the hollow cylinder of the puncturing element is less than a radius of a meniscus of liquid entering the hollow cylinder, thereby preventing gas bubbles from forming within liquid entering the hollow cylinder.

251. The method of any one of claims 241-250, wherein the puncturing element is interference-fit within the at least a portion of the length of the channel formed in the interface, thereby preventing gas bubbles from forming within liquid traveling through the channel at an interface between the puncturing element and the channel formed in the interface.

252. The method of any one of claims 241-251, wherein a surface area of an end of the second portion of the puncturing element that is configured to contact the breakable seal is less than 25% of the surface area of the breakable seal, thereby limiting deformation of the breakable seal during breaking by the second portion of the puncturing element, and thereby limiting a size and/or number of gas bubbles formed during deformation of the breakable seal and/or that can be introduced through the broken seal and into the sample collection tube.

253. The method of any one of claims 215-227 and 232-252, further comprising placing or having placed the bi-stable locking mechanism in the at least one first state, thereby causing the sample collection tube holder to operatively couple the sample collection tube and the test cartridge in the first stable state.

254. The method of any one of claims 215-218, 228-236, and 241-253, wherein the assay assembly further comprises a sample collector comprising a handle and a sample collection portion, and wherein the method further comprises inserting the sample collection portion having a sample into the sample collection tube to elute the sample into the sample collection tube prior to transitioning the bi-stable locking mechanism from the at least one first state to the at least one second state.

255. The method of any one of claims 237-240 and 254, further comprising collecting the sample with the sample collection portion of the sample collector prior to inserting the sample collection portion having the sample into the sample collection tube.

256. The method of any one of claims 254-255, wherein the sample collection portion of the sample collector is breakable, and wherein the method further comprises dislocating the sample collection portion from the sample collector and into the first chamber of the sample collection tube prior to transitioning the bi-stable locking mechanism from the at least one first state to the at least one second state.

257. The method of any one of claims 254-255, wherein the method further comprises removing the sample collector from the sample collection tube prior to transitioning the bi-stable locking mechanism from the at least one first state to the at least one second state.

258. The method of any one of claims 215-257, wherein the bi-stable locking mechanism is irreversible such that the bi-stable locking mechanism cannot transition from the at least one second state in which (i) the sample collection tube, the first chamber or the first sub-container and (ii) the test cartridge are operatively coupled in the second stable state to the at least one first state in which the sample collection tube and the test cartridge are operatively coupled in the first stable state.

259. The method of claim 258, wherein the sample collection tube, the first chamber, the first sub-container and/or the test cartridge comprises one more of the following to prevent transition from the at least one second state to the at least one first state: locking detents, cantilever snap features, lock-out release arm, ratchet features, sawtooth ratchets, ratchet and pawl features.

260. The method of any one of claims 215-114, wherein an exterior surface of the sample collection tube comprises alignment features, wherein the sample collection tube holder comprises a shelf having gaps sized to fit the alignment features of the sample collection tube, and wherein transitioning the bi-stable locking mechanism from the at least one first state to the at least one second state at least in part comprises aligning the alignment features of the sample collection tube with the gaps of in the shelf of the sample collection tube holder and moving the alignment features of the sample collection tube through the gaps of the shelf of the sample collection tube holder towards the test cartridge, thereby causing the sample collection tube holder to operatively couple the sample collection tube and the test cartridge in the second stable state.

261. The method of claim 260, wherein the exterior surface of the sample collection tube further comprises notches, wherein the sample collection tube holder comprises hooks positioned below the shelf, and the method further comprises, following operative coupling of the sample collection tube and the test cartridge in the second stable state, the hooks interlocking with the notches, thereby preventing the sample collection tube from transitioning from operative coupling with the test cartridge in the second stable state to operative coupling with the test cartridge in the first stable state.

262. The method of any one of claims 260-261, wherein the shelf of the sample collection tube holder comprises one or more cantilever snap features, wherein responsive to the bi-stable locking mechanism being in the at least one first state, the one or more cantilever snap features are positioned in a first position, thereby causing the sample collection tube holder to operatively couple the sample collection tube and the test cartridge in the first stable state, and wherein transitioning the bi-stable locking mechanism from the at least one first state to at least one second state at least in part comprises moving the one or more cantilever snap features from the first position to a second position, the second position proximal to the test cartridge relative to the first position, thereby causing the sample collection tube holder to operatively couple the sample collection tube and the test cartridge in the second stable state.

263. The method of any one of claims 260-261, wherein the sample collection tube holder further comprises one or more cantilever snap features, wherein responsive to the bi-stable locking mechanism being in the at least one first state, the one or more cantilever snap features are positioned above the shelf of the sample collection tube holder, thereby causing the sample collection tube holder to operatively couple the sample collection tube and the test cartridge in the first stable state, and wherein transitioning the bi-stable locking mechanism from the at least one first state to at least one second state at least in part comprises moving the one or more cantilever snap features below the shelf of the sample collection tube holder, thereby causing the sample collection tube holder to operatively couple the sample collection tube and the test cartridge in the second stable state.

264. The method of any one of claims 215-263, wherein the first chamber of the sample collection tube comprises a liquid reagent, and wherein placing the first chamber of the sample collection tube in fluidic communication with the sample inlet of the test cartridge comprises flowing the liquid reagent from the first chamber into the sample inlet.

265. A method comprising:
a. obtaining an assay assembly, the assembly comprising:
a sample collection tube comprising:
1. a first chamber; and
2. a breakable seal;
a test cartridge comprising:
1. a sample inlet;
2. one or more reaction chambers; and
3. a puncturing element; and
a sample collector comprising:
1. a handle comprising a cap that is operatively coupleable with the sample collection tube; and
2. a sample collection portion,
wherein the sample collection tube and the test cartridge are operatively coupled in a first stable state; and
b. operatively coupling the cap to the sample collection tube, thereby locating the sample collection portion of the sample collector within the first chamber of the sample collection tube and operatively coupling the sample collection tube and the test cartridge in a second stable state, thereby causing the puncturing element of the test cartridge to break the breakable seal of the sample collection tube, and thereby placing the first chamber of the sample collection tube in fluidic communication with the sample inlet of the test cartridge.

266. The method of claim 265, further comprising operatively coupling or having operatively coupled the sample collection tube and the test cartridge in the first stable state.

267. The method of any one of claims 265-266, further comprising collecting a sample with the collection portion of the sample collector prior to operatively coupling the cap to the sample collection tube.

268. The method of any one of claims 265-267, wherein the cap comprises a first attachment element and the sample collection tube comprises a second attachment element, and wherein operatively coupling the cap to the sample collection tube comprises operatively coupling the first attachment element and the second attachment element.

269. The method of claim 268, wherein the cap comprises a twist-on cap, wherein the first attachment element comprises threading and the second attachment element comprises reciprocating threading, and wherein operatively coupling the first attachment element and the second attachment element comprises the reciprocating threading slidably receiving the threading.

270. The method of claim 269, wherein the reciprocating threading of the second attachment element slidably receives ½ to 10 complete rotations of the threading of the first attachment element.

271. The method of any one of claims 269-270, wherein operatively coupling the twist-on cap to the sample collection tube comprises rotating the twist-on cap around the sample collection tube about an axis of rotation of the twist-on cap, and wherein the sample collection portion of the sample collector is offset from the axis of rotation of the twist-on cap, such that during rotation of the twist-on cap about the axis of rotation, the sample collection portion rotates off the axis of rotation of the twist-on cap, thereby maximizing volume contact of the sample collection portion within the first chamber.

272. The method of any one of claims 269-271, wherein operatively coupling the twist-on cap to the sample collection tube comprises mixing a volume of the first chamber of the sample collection tube with the sample collection portion of the sample collector.

273. The method of claim 272, wherein the first chamber of the sample collection tube contains agitator features such that the volume of the first chamber of the sample collection tube is agitated by the agitator features during mixing with the sample collection portion of the sample collector.

274. The method of any one of claims 265-273, wherein operatively coupling the cap to the sample collection tube comprises sealing the sample collection tube with the cap.

275. The method of any one of claims 265-274, wherein the breakable seal is proximal to an outlet of the sample collection tube, and wherein locating the sample collection portion of the sample collector within the first chamber of the sample collection tube comprises locating the sample collection portion proximal to the breakable seal, and thus proximal to the outlet of the sample collection tube, such that responsive to the puncturing element of the test cartridge breaking the breakable seal of the sample collection tube, an amount of sample from the sample collection portion that travels from the first chamber of the sample collection tube into the sample inlet of the test cartridge is maximized.

276. The method of any one of claims 265-275, wherein the operative coupling of the cap to the sample collection tube is irreversible such that the cap cannot transition from being operatively coupled to the sample collection tube to not being operatively coupled to the sample collection tube.

277. The method of claim 276, wherein the cap comprises one more of the following to prevent transition from the at least one second state to the at least one first state: locking detents, cantilever snap features, a lock-out release arm, ratchet features, sawtooth ratchets, ratchet and pawl features.

278. The method of any one of claims 265-276, wherein the operative coupling of the sample collection tube and the test cartridge in the second stable state is irreversible such that sample collection tube, the first chamber or the first sub-container cannot transition from being operatively coupled with the test cartridge in the second stable state to being operatively coupled with the test cartridge in the first stable state.

279. The method of claim 278, wherein the sample collection tube and/or the test cartridge comprises one more of the following to prevent transition from the at least one second state to the at least one first state: locking detents, cantilever snap features, lock-out release arm, ratchet features, sawtooth ratchets, ratchet and pawl features.

280. The method of any one of claims 265-278, wherein:
a. the test cartridge further comprises a sample collection tube holder,
b. the sample collection tube holder operatively couples the sample collection tube and the test cartridge in the first stable state, and
c. operatively coupling the sample collection tube and the test cartridge in the second stable state comprises the sample collection tube holder operatively coupling the sample collection tube and the test cartridge in the second stable state.

281. The method of claim 280, wherein an exterior surface of the sample collection tube comprises alignment features, wherein the sample collection tube holder comprises a shelf having gaps sized to fit the alignment features of the sample collection tube, and wherein the sample collection tube holder operatively coupling the sample collection tube and the test cartridge in the second stable state at least in part comprises aligning the alignment features of the sample collection tube with the gaps of in the shelf of the sample collection tube holder and moving the alignment features of the sample collection tube through the gaps of the shelf of the sample collection tube holder towards the test cartridge, thereby causing the sample collection tube holder to operatively couple the sample collection tube and the test cartridge in the second stable state.

282. The method of claim 281, wherein the exterior surface of the sample collection tube further comprises notches, wherein the sample collection tube holder comprises hooks positioned below the shelf, and the method further comprises, following operative coupling of the sample collection tube and the test cartridge in the second stable state, the hooks interlocking with the notches, thereby preventing the sample collection tube from transitioning from operative coupling with the test cartridge in the second stable state to operative coupling with the test cartridge in the first stable state.

283. The method of any one of claims 281-282, wherein the shelf of the sample collection tube holder comprises one or more cantilever snap features, wherein responsive to the one or more cantilever snap features being positioned in a first position, the sample collection tube holder operatively couples the sample collection tube and the test cartridge in the first stable state, and wherein the sample collection tube holder operatively coupling the sample collection tube and the test cartridge in the second stable state at least in part comprises moving the one or more cantilever snap features from the first position to a second position, the second position proximal to the test cartridge relative to the first position.

284. The method of any one of claims 281-282, wherein the sample collection tube holder further comprises one or more cantilever snap features, wherein responsive to the one or more cantilever snap features being positioned above the shelf of the sample collection tube holder, the sample collection tube holder operatively couples the sample collection tube and the test cartridge in the first stable state, and wherein the sample collection tube holder operatively coupling the sample collection tube and the test cartridge in the second stable state at least in part comprises moving the one or more cantilever snap features below the shelf of the sample collection tube holder.

285. The method of any one of claims 265-284, wherein the first chamber of the sample collection tube comprises a liquid reagent, and wherein placing the first chamber of the sample collection tube in fluidic communication with the sample inlet of the test cartridge comprises flowing the liquid reagent from the first chamber into the sample inlet.

286. The method of any one of claims 265-285, wherein:
a. the sample collection tube further comprises:
an outlet port, the outlet port sealed from the first chamber by the breakable seal,
b. the test cartridge further comprises a fluid transfer mechanism comprising:
an interface, wherein the outlet port of the sample collection tube is configured to receive the interface; and
a channel formed in the interface, the channel comprising a first end and a second end and having a length and at least one diameter, the first end comprising an inlet, and the second end comprising an outlet in fluidic communication with the second chamber of the test cartridge,
c. the puncturing element comprises a hollow cylinder having an inner diameter, an outer diameter, and a length,
d. a first segment of the puncturing element includes a first portion of the length of the hollow cylinder,
e. a second segment of the puncturing element includes a second portion of the length of the hollow cylinder,
f. the outer diameter of the hollow cylinder is equivalent to the at least one diameter of the channel in the interface,
g. the first segment of the puncturing element is embedded within at least a portion of the length of the channel, thereby forming a single effective diameter of the channel along the length of the channel, the single effective diameter equivalent to the inner diameter of the hollow cylinder of the puncturing element, and
h. the second segment of the puncturing element extends beyond the inlet of the channel, and
wherein operatively coupling the sample collection tube and the test cartridge in the second stable state comprises:
a. the outlet port receiving the interface such that at least one portion of the interface has a diameter that is equivalent to a diameter of at least one portion of the outlet port and such that the at least one portion of the interface is located within the at least one portion of the outlet port, thereby fluidically sealing the outlet port with the interface and breaking the breakable seal of the sample collection tube with the second segment of the puncturing element, thereby placing the first chamber of the sample collection tube in fluidic communication with the channel of the fluid transfer mechanism and thus with the second chamber of the test cartridge

287. The method of claim 286, wherein the interface fluidically seals the outlet port prior to the puncturing element breaking the breakable seal of the sample collection tube, thereby preventing thereby preventing gas bubbles from forming within liquid contained within the first chamber of the sample collection tube and preventing the liquid contained within the first chamber of the sample collection tube from leaking out of the outlet port responsive to the second segment of the puncturing element breaking the breakable seal of the sample collection tube.

288. The method of any one of claims 286-287, wherein gas vents from the outlet port of the sample collection tube prior to the interface fluidically sealing the outlet port, thereby preventing gas bubbles from forming within liquid contained within the first chamber of the sample collection tube, responsive to the second segment of the puncturing element breaking the breakable seal of the sample collection tube.

289. The method of any one of claims 286-288, wherein the single effective diameter of the channel along the length of the channel prevents gas bubbles from forming within liquid traveling through the channel.

290. The method of any one of claims 286-289, wherein the diameter of the interface increases along the length of the channel form the first end to the second end, wherein the at least one portion of the interface of the fluid transfer mechanism that has the diameter that is equivalent to the diameter of the at least one portion of the outlet port comprises a portion of the interface of the fluid transfer mechanism that is proximal to the second end of the channel, and wherein the outlet port receiving the interface comprises:
a. inserting the interface into the outlet port until the portion of the interface that is proximal to the second end of the channel is located within the at least one portion of the outlet port, thereby fluidically sealing the outlet port with the interface.

291. The method of any one of claims 286-290, wherein at least one of the interface and the outlet port comprises a deformable material, and wherein the outlet port receiving the interface comprises:
a. the at least one interface and outlet port deforming such that at least one portion of the interface has a diameter that is equivalent to a diameter of at least one portion of the outlet port and such that the at least one portion of the interface is located within the at least one portion of the outlet port.

292. The method of any one of claims 286-291, wherein the interface comprises a hydrophobic material, the puncturing element comprises a hydrophilic material, and the breakable seal comprises a hydrophilic material, and wherein breaking the breakable seal of the sample collection tube with the second segment of the puncturing element traps gas from the outlet port between the interface and the breakable seal but separate from the puncturing element, thereby preventing gas bubbles from forming within liquid contained within the first chamber of the sample collection tube.

293. The method of any one of claims 286-292, wherein breaking the breakable seal of the sample collection tube with the second segment of the puncturing element forms a narrow gap between the puncturing element and the breakable seal, such that gas trapped between the interface and the breakable seal cannot overcome surface tension of liquid contained within the first chamber of the sample collection tube to travel through the narrow gap, past the breakable seal, and into the liquid contained within the first chamber of the sample collection tube, thereby preventing gas bubbles from forming within liquid contained within the first chamber of the sample collection tube.

294. The method of any one of claims 286-293, wherein the puncturing element comprises a material having a hardness that is at least 2× a hardness of a material comprising the breakable seal, such that the puncturing element provides for a clear puncture of the breakable seal with repeatable geometry and without deformation of the puncturing element.

295. The method of any one of claims 286-294, wherein the inner diameter of the hollow cylinder of the puncturing element is less than a radius of a meniscus of liquid entering the hollow cylinder, thereby preventing gas bubbles from forming within liquid entering the hollow cylinder.

296. The method of any one of claims 286-295, wherein the puncturing element is interference-fit within the at least a portion of the length of the channel formed in the interface, thereby preventing gas bubbles from forming within liquid traveling through the channel at an interface between the puncturing element and the channel formed in the interface.

297. The method of any one of claims 286-296, wherein a surface area of an end of the second portion of the puncturing element that is configured to contact the breakable seal is less than 25%, thereby limiting a size and/or number of gas bubbles formed during deformation of the breakable seal and/or that can be introduced through the broken seal and into the sample collection tube.

298. A method comprising:
a. obtaining an assay assembly, the assembly comprising:
a sample collection tube comprising:
1. a main chamber;
2. an outlet port; and
3. a breakable seal, the breakable seal sealing the main chamber from the outlet port; and
a fluid transfer mechanism comprising:
1. an interface, wherein the outlet port of the sample collection tube is configured to receive the interface of the fluid transfer mechanism;
2. a channel formed in the interface, the channel comprising a first end and a second end, and having a length and at least one diameter, the first end comprising an inlet; and
3. a puncturing element comprising a hollow cylinder having an inner diameter, an outer diameter, and a length, and
wherein a first segment of the puncturing element includes a first portion of the length of the hollow cylinder, a second segment of the puncturing element includes a second portion of the length of the hollow cylinder, and the outer diameter of the hollow cylinder is equivalent to the at least one diameter of the channel in the interface,
wherein the first segment of the puncturing element is embedded within at least a portion of the length of the channel, thereby forming a single effective diameter of the channel along the length of the channel, the single effective diameter equivalent to the inner diameter of the hollow cylinder of the puncturing element, and
wherein the second segment of the puncturing element extends beyond the inlet of the channel, and
b. moving the interface of the fluid transfer mechanism into the outlet port of the sample collection tube such that at least one portion of the interface has a diameter that is equivalent to a diameter of at least one portion of the outlet port and such that the at least one portion of the interface is located within the at least one portion of the outlet port, thereby fluidically sealing the outlet port with the interface and puncturing the breakable seal of the sample collection tube with the second segment of the puncturing element of the fluid transfer mechanism, thereby placing the main chamber of the sample collection tube in fluidic communication with the channel of the fluid transfer mechanism.

299. The method of claim 298, wherein the interface fluidically seals the outlet port prior to the puncturing element breaking the breakable seal of the sample collection tube, thereby preventing thereby preventing gas bubbles from forming within liquid contained within the main chamber of the sample collection tube and preventing the liquid contained within the main chamber of the sample collection tube from leaking out of the outlet port responsive to the second segment of the puncturing element breaking the breakable seal of the sample collection tube.

300. The method of any one of claims 298-299, wherein gas vents from the outlet port of the sample collection tube prior to the interface fluidically sealing the outlet port, thereby preventing gas bubbles from forming within liquid contained within the main chamber of the sample collection tube, responsive to the second segment of the puncturing element breaking the breakable seal of the sample collection tube.

301. The method of any one of claims 298-300, wherein the single effective diameter of the channel along the length of the channel prevents gas bubbles from forming within liquid traveling through the channel.

302. The method of any one of claims 298-301, wherein the diameter of the interface increases along the length of the channel form the first end to the second end, wherein the at least one portion of the interface of the fluid transfer mechanism that has the diameter that is equivalent to the diameter of the at least one portion of the outlet port comprises a portion of the interface of the fluid transfer mechanism that is proximal to the second end of the channel, and wherein moving the interface of the fluid transfer mechanism into the outlet port of the sample collection tube comprises:
a. inserting the interface into the outlet port until the portion of the interface that is proximal to the second end of the channel is located within the at least one portion of the outlet port, thereby fluidically sealing the outlet port with the interface.

303. The method of any one of claims 298-302, wherein at least one of the interface and the outlet port comprises a deformable material, and wherein moving the interface of the fluid transfer mechanism into the outlet port of the sample collection tube comprises:
a. the at least one interface and outlet port deforming such that at least one portion of the interface has a diameter that is equivalent to a diameter of at least one portion of the outlet port and such that the at least one portion of the interface is located within the at least one portion of the outlet port.

304. The method of any one of claims 298-303, wherein the interface comprises a hydrophobic material, the puncturing element comprises a hydrophilic material, and the breakable seal comprises a hydrophilic material, and wherein breaking the breakable seal of the sample collection tube with the second segment of the puncturing element traps gas from the outlet port between the interface and the breakable seal but separate from the puncturing element, thereby preventing gas bubbles from forming within liquid contained within the main chamber of the sample collection tube.

305. The method of any one of claims 298-304, wherein breaking the breakable seal of the sample collection tube with the second segment of the puncturing element forms a narrow gap between the puncturing element and the breakable seal, such that gas trapped between the interface and the breakable seal cannot overcome surface tension of liquid contained within the main chamber of the sample collection tube to travel through the narrow gap, past the breakable seal, and into the liquid contained within the main chamber of the sample collection tube, thereby preventing gas bubbles from forming within liquid contained within the main chamber of the sample collection tube.

306. The method of any one of claims 298-305, wherein the puncturing element comprises a material having a hardness that is at least 2× a hardness of a material comprising the breakable seal, such that the puncturing element provides for a clear puncture of the breakable seal with repeatable geometry and without deformation of the puncturing element.

307. The method of any one of claims 298-306, wherein the inner diameter of the hollow cylinder of the puncturing element is less than a radius of a meniscus of liquid entering the hollow cylinder, thereby preventing gas bubbles from forming within liquid entering the hollow cylinder.

308. The method of any one of claims 298-307, wherein the puncturing element is interference-fit within the at least a portion of the length of the channel formed in the interface, thereby preventing gas bubbles from forming within liquid traveling through the channel at an interface between the puncturing element and the channel formed in the interface.

309. The method of any one of claims 298-308, wherein a surface area of an end of the second portion of the puncturing element that is configured to contact the breakable seal is less than 25%, thereby limiting a size and/or number of gas bubbles formed during deformation of the breakable seal and/or that can be introduced through the broken seal and into the sample collection tube.
